(19) United States
(12) Patent Application Publication
(10) Pub. No.: US 2003/0009485 A1
(43) Pub. Date: Jan. 9, 2003

(54) System and method for recombinant media

(76) Inventor: Jonni Turner, Liverpool (CA)

Correspondence Address: Gowling Lafleur Henderson LLP, Suite 2600, 160 Elgin Street, Ottawa, ON, K1P 1C3, CA

(21) Appl. No.: 10/178,496

(22) Filed: Jun. 25, 2002

Related U.S. Application Data
(60) Provisional application No. 60/300,089, filed on Jun. 25, 2001.

(51) Int. Cl. G06F 12/00

(52) U.S. Cl. 707/200

(57) ABSTRACT

A system for producing a customized version of a work is provided. The system comprises a collection of fragments of the work which may be combined into a version of the work., and an output unit which outputs the customized version of the work based on user preferences.

### FIELD OF THE INVENTION

The invention relates to a system and method for recombinant media content which may be configured to create customizable versions of an original work.

### BACKGROUND OF THE INVENTION

Traditional content may be considered as a “solid” product. It is manufactured in “blocks” that are designed for the schedules of, for example, movie theatres and broadcasters. This approach worked in times when people's lives were simple, their routines predictable, and the demands on their time fewer and more easily accommodated. The advances in computing and communications technologies over the past 10 or 15 years have altered the lifestyles of many people. People's lives are becoming increasingly complex, fragmented, demanding, and time-deprived. Program “blocks” may not be flexible enough to fit into the relaxation and reflection spaces in people's lives. Nor does “one size fit all.” Even members within family groups may have highly individual tastes and requirements for content. They may resent wasting time on content which is expanded to fit a conventional block of time, when the material may warrant much less.

In some ways the Internet may be seen to turn content into a liquid form. The problem is that the liquid is one giant ocean, lacking coherent narrative structures. Some coherent structures have emerged in Internet traffic flow. Although these are fractal, and can be captured as images, they are too vast to be realistically grasped by those who are part of them.

In terms of complexity theory, blocks of traditional content may be considered as gridlock territory, so tightly organized that movement among the blocks becomes difficult, (if not impossible to the time-deprived). The Internet may be considered as chaos territory, so anarchical that patterns are difficult or impossible to perceive, or are misleading because of the absence of context. Without coherent narrative structures, there is little or no meaningful context.

Without context, learning becomes difficult or impossible. Successful systems are those which maintain a balance in the border area between order and chaos; those which can recognize, and learn from recognizing, useful patterns. Humans risk losing control over their increasingly complex lives because they may no longer make sense of the events and information that inundate them from all directions.

To date, most known works of content are provided to users as single, linear pieces in versions that vary mainly in length (such as the “director's cut” of a movie, which may be longer than the commercial release). At most, users are able to move forward or backward to various points in the story, or, in the case of a device such as a VCR, they may be able to remove discrete segments such as advertising inserts from a taped television program.

Exceptions to linear content are multimedia works for use on computers, but in these works coherent narrative structure is not an issue as users navigate freely within the body of the content. “Choose-Your-Own-Adventure” novels and some non-fiction works (such as Peter Senge's “Fifth Discipline Fieldbook”) also encourage a non-linear approach to using content.

One of the difficulties with this approach in conventional books is that monochronic people like to assimilate content in a linear fashion, i.e., from beginning to end. These people may be irritated by distracting directions to other parts of the book; they may feel compelled to flip pages back and forth in response to the notes which direct them to non-linear connections, but fear losing the flow of the content and their own thoughts. Polychronic people, who approach reading in a non-linear fashion, may flip back and forth through a book anyway, without any prompting from notes on the page.

Watching TV and movies is also something most people do to relax, so it is desirable that the user's choices are made before the programs start, so that relaxation is not disturbed by the mental “work” and interruption of having to choose alternatives all the time.

One problem with linear works of content, or “block” content, is that it is easy to pirate copies of a content work which exist in only one or several forms. Another problem is economical in nature: star actors, writers and directors and many millions of dollars in production costs are not enough to guarantee success at the box office or on the small screen; nor is a writer's popularity alone enough to ensure a best seller. Shooting ratios (feet of film shot to feet of film used) may be as high as 40:1 for a documentary or 25:1 for a fiction work. The higher the budget for a movie, for example, the higher the shooting ratio is likely to be.

Most movies are created in the editing room, so a high shooting ratio gives a director many more options for the final cut. On the other hand, the higher the shooting ratio, the greater the amount of discarded footage, since conventional television programs and movies have to conform to standard, marketable lengths. The value in production costs represented by the discarded material may be greater than the value of the material which makes up the finished movie. Furthermore, a writer may discard valuable story material because of a publisher's cost limitations or marketing concerns.

In summary, the problems with traditional “block” content may include:

i) it is linear and may not fit into an individual's free time;

ii) it is easy to copy since it is only in one or several forms;

iii) it has a high ratio of available to usable material; and

iv) valuable material may never be used and thus lost.

There is a need for a method which can solve one or more of the above problems and by which content can be tailored by individual users and/or content providers without the loss of coherent narrative structures.

### SUMMARY OF THE INVENTION

It is an object of the invention to solve one or more of the aforementioned problems.

In accordance with an aspect of the invention, there is provided a system for producing a customized version of a work. The system comprises a collection of fragments of the work which may be combined into a version of the work., and an output unit which outputs the customized version of the work based on user preferences.

In accordance with another aspect of the invention, there is provided a system for producing recombinant media content. The system comprises a collection of fragments of a work, classifications of said fragments, system rules defining boundaries for possible combinations of said fragments, and an output unit which outputs customized versions of said work based on user preferences.

In accordance with another aspect of the invention, there is provided a system for producing recombinant media content having a coherent narrative structure. The system comprises a collection of fragments of one or more works, classifications of said fragments, system rules defining boundaries for possible combinations of said fragments, an output unit which outputs customized versions of said work based on user preferences, and a billing unit for charging a customer for the customized version. The collection includes at least one fractal equivalent for at least one of the fragments. The collection is stored in a database. The collection comprises one or more versions of the one or more works. The classifications of said fragments comprise at least one of plots, character, subjects, references, themes, and descriptions.

In accordance with another aspect of the invention, there is provided a method for producing recombinant media content. The method comprises steps of parsing a work into fragments, assigning classifications to said fragments, determining system rules based on the complexity of said work and the number and nature of said classifications, providing a user options to customize said work, and organizing said fragments into a customized version of said work based on preferences of said user.

In accordance with another aspect of the invention, there is provided a computer data signal embodied in a carrier wave and representing sequences of instructions which, when executed by a processor, cause the processor to perform a method for producing recombinant media content. The method comprises steps of parsing a work into fragments, assigning classifications to said fragments, determining system rules based on the complexity of said work and the number and nature of said classifications, providing a user options to customize said work, and organizing said fragments into a customized version of said work based on preferences of said user.

In accordance with another aspect of the invention, there is provided computer-readable media for storing instructions or statements for use in the execution in a computer of a method for producing recombinant media content. The method comprises steps of parsing a work into fragments, assigning classifications to said fragments, determining system rules based on the complexity of said work and the number and nature of said classifications, providing a user options to customize said work, and organizing said fragments into a customized version of said work based on preferences of said user.

In accordance with another aspect of the invention, there is provided a computer program product for use in the execution in a computer of a system for producing recombinant media content. The system comprises a collection of fragments of a work, classifications of said fragments, system rules defining boundaries for possible combinations of said fragments, and an output unit which outputs customized versions of said work based on user preferences.

Another aspect of the invention is to provide a method or process for producing recombinant digital media (RDM) content which can be reconfigured to create customizable iterations (or versions) of an original work. These iterations have coherent narrative structures which retain the narrative integrity of the original work. The process involves reducing a digitalized content work into fragments and sequences of fragments which are classified by content producers so that individual users and/or content providers can subsequently customize preferred iterations of the original work.

The invention pertains generally to works of content which have a coherent narrative structure. This structure may be factual, fictional, or a combination of fact and fiction. Each complete work typically has a recognizable beginning and end, with a middle that represents a logical progression between the two. Each RDM iteration will also typically have a recognizable beginning and end, with a middle that represents a logical progression between the two. Although the beginning and/or the end in the iteration may differ from the original work of content, narrative integrity will be maintained. Individual chapters or segments of these works demonstrate similar coherent narrative structures. The invention also relates to works of content which are in a digital format or have been digitalized from other formats and can thus be manipulated within computer systems.

One embodiment of the invention will be described by way of a pro forma demonstration (PFD).

### BRIEF DESCRIPTIONS OF THE DRAWINGS

Embodiments of the invention will now be described with reference to the accompanying drawings, in which:

FIG. 1 is a diagram showing a recombinant media content system;

FIG. 2 is a flow diagram showing the process of producing recombinant media content;

FIG. 3 is a diagram showing recombinant digital media (RDM) apparatus.

FIG. 4 is a diagram showing fragments of RDM.

FIG. 5 is a diagram showing fragment lines of RDM.

FIG. 6 is a diagram showing the fragment assembly of RDM.

FIG. 7 is a diagram showing the conceptual structure of RDM.

FIG. 8 is a flow diagram showing the process of fragging a movie into RDM.

FIG. 9 is a flow diagram showing the process of fragging a pro forma demonstration (PFD) RDM movie.

FIGS. 10A to 10C are a chart showing the fragment classifications of segment 1 of the PFD.

FIGS. 11A to 11B are a spreadsheet showing the fragment name breakdowns of segment 1 of the PFD.

FIG. 12 is a chart showing the fragment classifications of segment 2 of the PFD.

FIGS. 13A to 13B are a spreadsheet showing the fragment name breakdowns of segment 2 of the PFD.

FIGS. 14A to 14B are a chart showing the fragment classifications of segment 3 of the PFD.

FIGS. 15A to 15B are a spreadsheet showing the fragment name breakdowns of segment 3 of the PFD.

FIGS. 16A to 16B are a chart showing the fragment classifications of segment 4 of the PFD.

FIGS. 17A to 17B are a spreadsheet showing the fragment name breakdowns of segment 4 of the PFD.

FIGS. 18A to 18B are a chart showing the fragment classifications of segment 5 of the PFD.

FIGS. 19A to 19B are a spreadsheet showing the fragment name breakdowns of segment 5 of the PFD.

FIGS. 20A to 20B are a chart showing the fragment classifications of segment 6 of the PFD.

FIGS. 21A to 21B are a spreadsheet showing the fragment name breakdowns of segment 6 of the PFD.

FIGS. 22A to 22C are a chart showing the fragment classifications of segment 7 of the PFD.

FIGS. 23A to 23B are a spreadsheet showing the fragment name breakdowns of segment 7 of the PFD.

FIGS. 24A to 24B are a chart showing the fragment classifications of segment 8 of the PFD.

FIGS. 25A to 25B are a spreadsheet showing the fragment name breakdowns of segment 8 of the PFD.

FIGS. 26A to 26C are a chart showing the fragment classifications of segment 9 and transitions of the PFD.

FIGS. 27A to 27B are a spreadsheet showing the fragment name breakdowns of segment 9 and transitions of the PFD.

FIGS. 28A to 28D are a spreadsheet showing the total PFD fragments and fractal equivalents.

FIG. 29 is a listing of an RDM graphical user interface questions and answers for the PFD—Example 1.

FIG. 30 is a flowchart showing the PFD—Example 1 algorithm.

FIGS. 31A to 31D are a spreadsheet showing the effects on the PFD fragments for Example 1 if the answer to question 1 is “a”.

FIGS. 32A to 32D are a spreadsheet showing the effects on the PFD fragments for Example 1 if the answer to question 2 is “a”.

FIGS. 33A to 33D are a spreadsheet showing the effects on the PFD fragments for Example 1 if the answer to question 3 is “a”.

FIGS. 34A to 34D are a spreadsheet showing the effects on the PFD fragments for Example 1 if the answer to question 4 is “b”.

FIGS. 35A to 35D are a spreadsheet showing the genome of the RDM customization for Example 1.

FIGS. 36A to 36C are a chart showing the text and respective fragment classifications for segment 1 of the PFD—Example 1.

FIG. 37 is a chart showing the text and respective fragment classifications for segment 2 of the PFD—Example 1.

FIGS. 38A to 38B are a chart showing the text and respective fragment classifications for segment 3 of the PFD—Example 1.

FIGS. 39A to 39B are a chart showing the text and respective fragment classifications for segment 4 of the PFD—Example 1.

FIGS. 40A to 40B are a chart showing the text and respective fragment classifications for segment 5 of the PFD—Example 1.

FIGS. 41A to 41B are a chart showing the text and respective fragment classifications for segment 6 of the PFD—Example 1.

FIGS. 42A to 42C are a chart showing the text and respective fragment classifications for segment 7 of the PFD—Example 1.

FIGS. 43A to 43B are a chart showing the text and respective fragment classifications for segment 8 of the PFD—Example 1.

FIGS. 44A to 44C are a chart showing the text and respective fragment classifications for segment 9 and transitions of the PFD—Example 1.

FIG. 45 is a listing of an RDM graphical user interface questions and answers for the PFD—Example 2.

FIG. 46 is a flowchart showing the PFD—Example 2 RDM algorithm.

FIGS. 47A to 47D are a spreadsheet showing the effects on the PFD fragments for Example 2 if the answer to question 1 is “b”.

FIGS. 48A to 48D are a spreadsheet showing the effects on the PFD fragments for Example 2 if the answer to question 2 is “a”.

FIGS. 49A to 49D are a spreadsheet showing the effects on the PFD fragments for Example 2 if the answer to question 3 is “b”.

FIGS. 50A to 50D are a spreadsheet showing the effects on the PFD fragments for Example 2 if the answer to question 4 is “c”.

FIGS. 51A to 51D are a spreadsheet showing the genome of the RDM customization for Example 2.

FIGS. 52A to 52C are a chart showing the text and respective fragment classifications for segment 1 of the PFD—Example 2.

FIG. 53 is a chart showing the text and respective fragment classifications for segment 2 of the PFD—Example 2.

FIGS. 54A to 54B are a chart showing the text and respective fragment classifications for segment 3 of the PFD—Example 2.

FIGS. 55A to 55B are a chart showing the text and respective fragment classifications for segment 4 of the PFD—Example 2.

FIGS. 56A to 56B are a chart showing the text and respective fragment classifications for segment 5 of the PFD—Example 2.

FIGS. 57A to 57B are a chart showing the text and respective fragment classifications for segment 6 of the PFD—Example 2.

FIGS. 58A to 58C are a chart showing the text and respective fragment classifications for segment 7 of the PFD—Example 2.

FIGS. 59A to 59B are a chart showing the text and respective fragment classifications for segment 8 of the PFD—Example 2.

FIGS. 60A to 60C are a chart showing the text and respective fragment classifications for segment 9 and transitions of the PFD—Example 2.

### DETAILED DESCRIPTION OF EMBODIMENTS OF THE INVENTION

Recombinant media content comprises a collection of component parts of a work. The work may be an original work which is newly created or the work may be an existing work. The collection of component parts of the work may be stored on a digital versatile disc (DVD), in a computer file on a storage device, or any other suitable device which may hold the component parts of the work.

The collection of component parts of the work comprise fragments of the work. Some fragments may have fractal equivalents. These fractal equivalents comprise a variation from an original fragment. These fragments (including the fractal equivalents) may be combined into different combinations which provide variations of the work. The collection may also comprise fragments of multiple works.

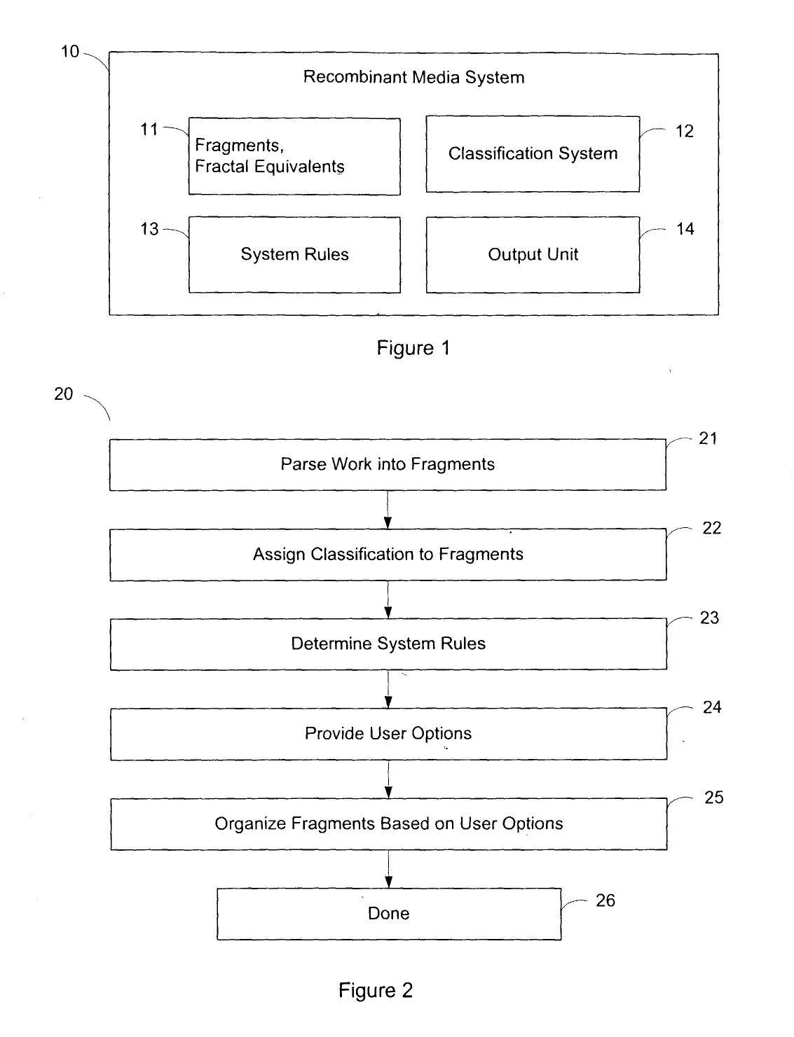

FIG. 1 shows an example of a recombinant media system 10, in accordance with an embodiment of the present invention, comprising a collection of fragments 11, a classification system 12, system rules 13, and an output unit 14. The system may also comprise a billing unit (not shown).

The variations of the work may be selected based on user preferences. The user preferences may be input into one or more algorithms to produce a customized version of the work. Such algorithms may be created based on system rules 13 designed to limit the combinations of fragments 11 such that customized versions of the work that are produced by the system 10 have a coherent structure. The fragments 11 may be classified to assist in creating system rules.

The customised versions of the work may be provided to end users over the Internet, on discs including DVDs, or in any suitable presentation medium. The billing system may be used to charge a fee for the customised versions.

FIG. 2 shows a method for producing recombinant media (20). The method begins with parsing a work into fragments 11 (21). Classifications are then assigned to the fragments 11 (22). Next, system rules 13 are determined (23) based on the complexity of the work and the number and nature of the classifications. Users are then provided options (24) to customize the work. Finally, the fragments 11 are organized into a customized version of the work based on the preferences of the user (25). Once these steps are performed, the method is done (26).

The step of parsing the work into fragments 11 (21), may comprise steps of parsing the work into component parts and then dividing the component parts into fragments 11. The method (20) may further comprise the step of providing the customized version to an end user and billing the user for the customized version.

An example of an embodiment of the present invention will be explained relating to digital media.

Recombinant digital media (RDM) is made up of digitalized fragments of a content work organized into a non-linear system. The rules of the system allow it to be reconfigured in response to user preferences in such a way that the integrity of the narrative structures of the original work remains intact. Each RDM iteration will have a recognizable beginning and end, with a middle that represents a logical progression between the two. Although the beginning and/or the end in the iterations may differ from the original work of content, narrative integrity will be maintained. The number and nature of classifications assigned to the digitalized fragments are a decision of the content producer, as are the number and nature of the system rules.

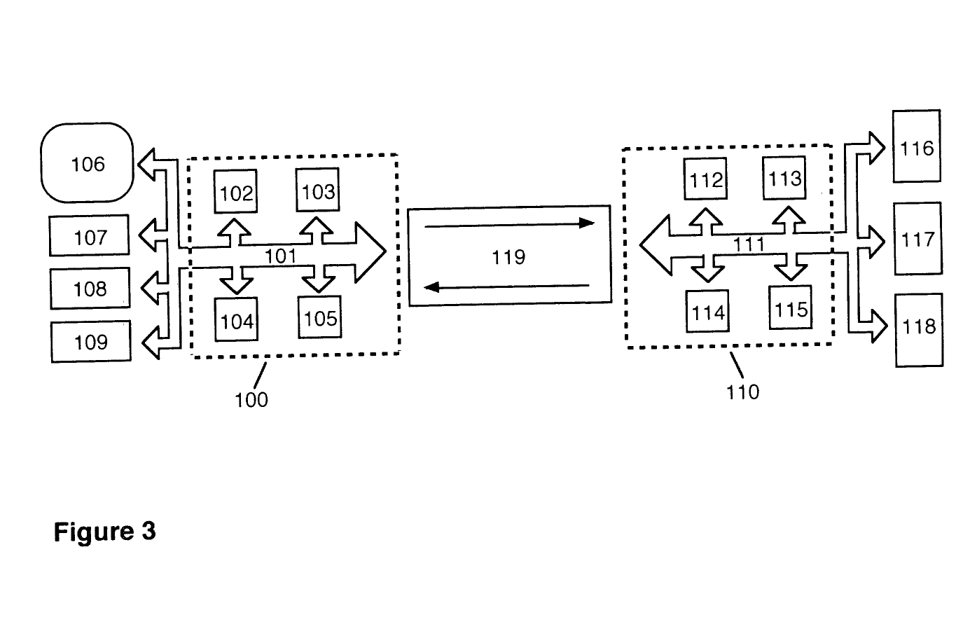

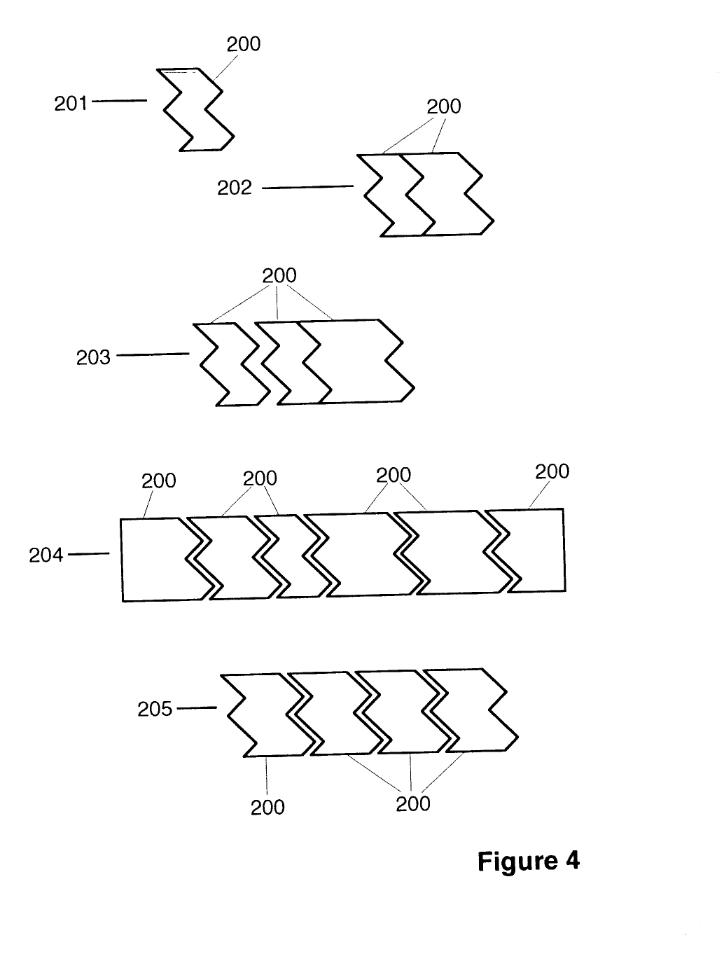

FIG. 3 shows a computer system 100 which is a customer's system, a computer system 110 which is a content provider's system, and a high bandwidth connection 119 which allows two-way communication between the two systems via the Internet.

Computer system 100 (the customer's system) includes a bus or other communication means 101 for communicating information, and a processing means 102 coupled with bus 101 for processing information. System 100 further includes a random access memory or other dynamic storage device 103 (main memory), coupled to bus 101 for storing information and instructions to be executed by processor 102. Main memory 103 also may be used for storing temporary variables or other intermediate information during execution of instructions by processor 102. Computer system 100 also includes a read only memory and/or other static storage device 104 coupled to bus 101 for storing static information and instructions for processor 102.

In addition, a data storage device 105 such as a magnetic disk or optical disk and its corresponding disk-drive may be coupled to computer system 100. Computer system 100 may also include or be coupled via bus 101 to a display device 106, such as a cathode ray tube, for displaying information to a computer user. An alphanumeric input device 107, including alphanumeric and other keys, is typically coupled to bus 101 for communicating information and command selections to processor 102. Another type of user input device is cursor control 108, such as a mouse, a trackball, or cursor direction keys for communicating direction information and command selections to processor 102 and for controlling cursor movement on display device 106. This input device typically has two degrees of freedom in two axes, a first axis (i.e., x) and a second axis (i.e., y), which allows the device to specify positions in a plane.

Alternatively, other input devices such as a stylus or pen may be used to interact with the display. A displayed object on a computer screen may be selected by using a stylus or pen to touch the displayed object, in which the computer detects the selection by implementing a touch sensitive screen. Similarly, a light pen and a light sensitive screen may be used for selecting a displayed object. Such devices may thus detect selection position and the selection as a single operation instead of the “point and click,” as in a system incorporating a mouse or trackball. Stylus and pen based input devices as well as touch and light sensitive screens are well known in the art. Such a system may not need a keyboard such as 107 wherein all interface is provided via the stylus as a writing instrument (e.g., a pen) and the written text is interpreted using optical character recognition techniques. Such a system may also use voice recognition software. Additionally, computer system 100 may include or be coupled to a device for audio playback 109 such as a speaker. Further, the device may include a speaker which is coupled to a digital to analog converter for playing back the digitized sounds.

Computer system 110 (the content provider's system) may include a bus or other communication means 111 for communicating information, and a processing means 112 coupled with bus 111 for processing information. System 110 may further include a random access memory or other dynamic storage device 113 (main memory), coupled to bus 111 for storing information and instructions to be executed by processor 112. Main memory 113 also may be used for storing temporary variables or other intermediate information during execution of instructions by processor 112. Computer system 110 may also include a read only memory and/or other static storage device 114 coupled to bus 111 for storing static information and instructions for processor 112.

In addition, a data storage device 115 such as a magnetic disk or optical disk and its corresponding disk drive may be coupled to computer system 110. Computer system 110 may be coupled via bus 111 to one or more servers 116, 117, 118 which have additional data storage.

A preferred embodiment of the present invention is related to the use of a computer system 100 to communicate a user's customization preferences to a content provider's computer system 110, via a high bandwidth connection to the Internet 119, and to receive, store and/or play back the resulting customized content.

The non-linear systems into which digitalized fragments are organized are called FRCA systems (Fragments, Rules, Classifications, Algorithms).

FIG. 4 shows different types of fragments. Fragments are the smallest components of the system. Each one is a fractional part of a media work which may contain any kind or combination of media, such as text, video, audio or still images. Each fragment has a name comprised of alphanumeric or other characters which represent a combination of a classification and sub-classifications. This fragment name is unique and may be considered as comprising the “DNA” of the fragment. Fragments cannot stand alone as useful content unless they are placed within a larger context. However, discrete works of content may be created by combining many fragments.

A simple fragment 201 is one which cannot usefully be reduced to smaller fragments. A compound fragment 202 is a combination of two simple fragments 201. A complex fragment 203 is a combination of two or more fragments, at least one of which is a compound fragment. A segment 204 is a complete complex fragment which forms part of a work of content. Each segment 204 has its own combinations of classifications and sub-classifications. In comparison to conventional digitalized movie and television content, a simple fragment 201 would represent a small part of a clip, and a compound fragment 202 would represent a larger part of a clip. A complex fragment 203 might represent a complete shorter clip, or part of a longer clip. A segment 204 might represent a complete longer clip, or part of a very long clip. In conventional movie and television content, a clip might contain all or part of a scene.

A basic fragment (or fragment) 200 is a fragment with which one or more fractal equivalents (FEs) 210 may be associated. A fractal equivalent 210 is similar but not identical to its associated basic fragment 200 in physical terms, i.e., its visual and audio content; however, despite the physical differences, it conveys the same general meaning to a user. A basic fragment 200 may be a simple fragment 201, a compound fragment 202, or a complex fragment 203.

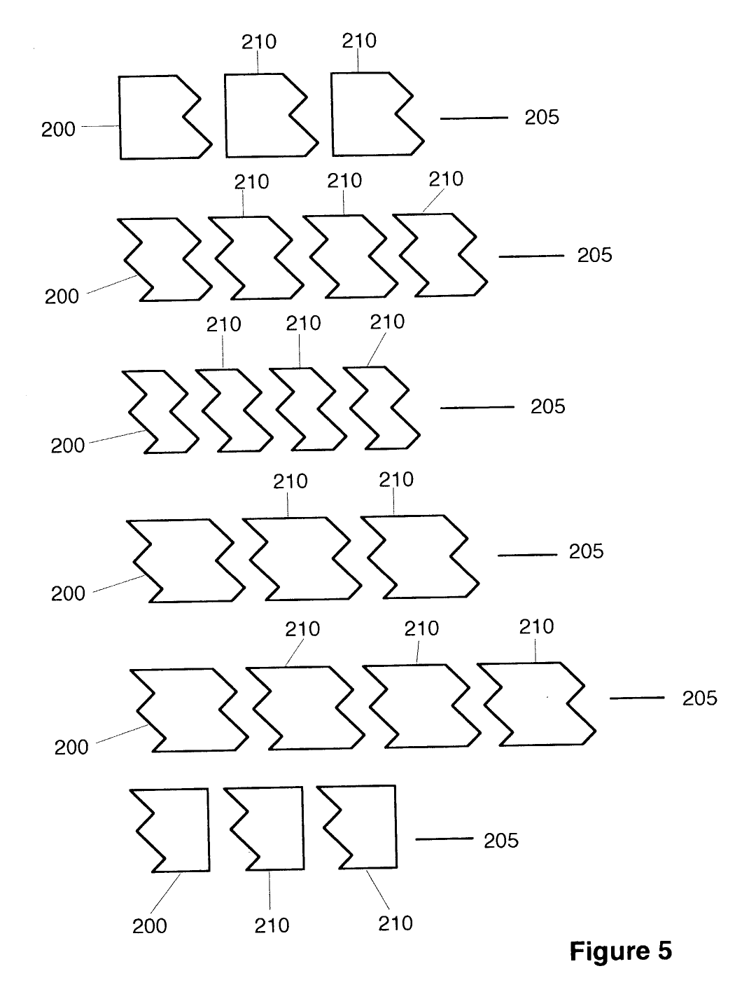

A line of fragments 205 consists of a basic fragment and its fractal equivalents. The first fragment in the line 205 is the basic fragment 200, followed by the FEs 210. The relationship of the basic fragment 200 to the FEs 210 is logical rather than physical. FIG. 5 shows 6 lines of fragments 205 in a segment 204.

Rules in a FRCA system may vary according to the complexity of the system (i.e., the number and variation of the digital fragments 200), and the requirements (or limitations) of the content producer. The rules make the system work efficiently and establish the boundaries within which the customization algorithms take place.

Classifications describe the basic categories of the fragments 200 in a FRCA system. A longer, more complex work would require more classifications. Sub-classifications define the various functions of each fragment 200 in an FRCA system. Again, the number and nature of sub-classifications may vary according to the complexity of the system and the requirements (or limitations) of the content producer. Classifications and sub-classifications may be represented by any one or more alphanumeric or other characters, so long as these are not duplicated within the system.

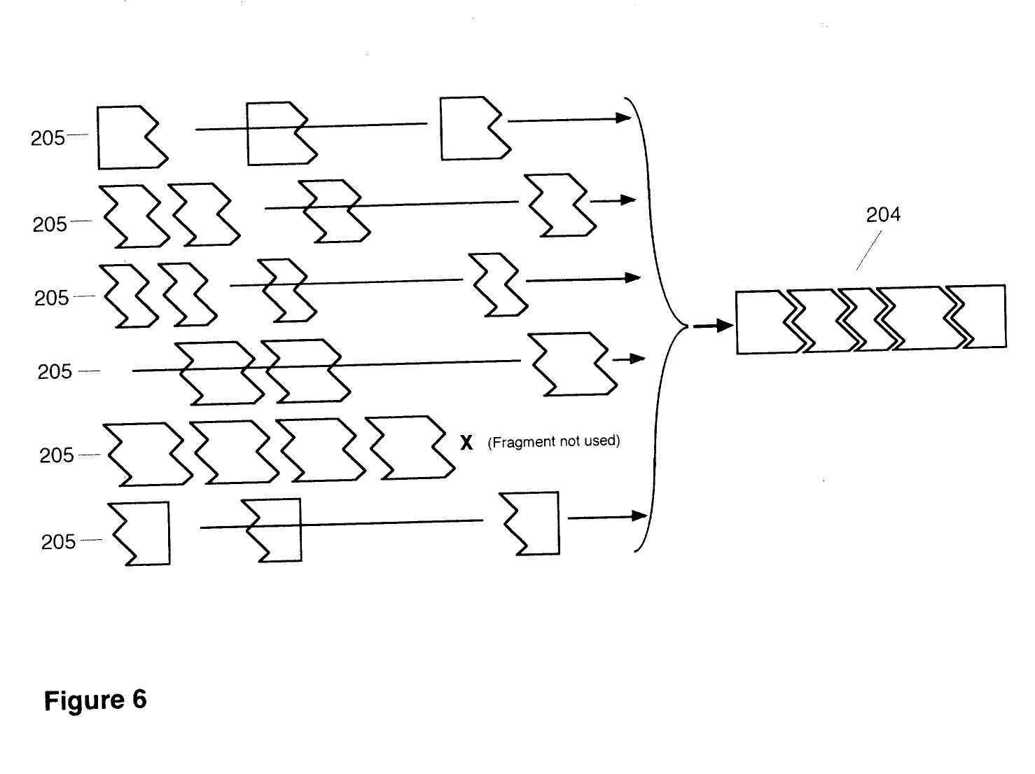

Algorithms in a FRCA system are the detailed sets of steps (mainly “if-then” rules) which “tell” computers how to combine the fragments 200 of an RDM work into content that will satisfy the customization requirements of users. FIG. 6 shows a segment 204 being assembled by an algorithm.

Example of an RDM Movie:

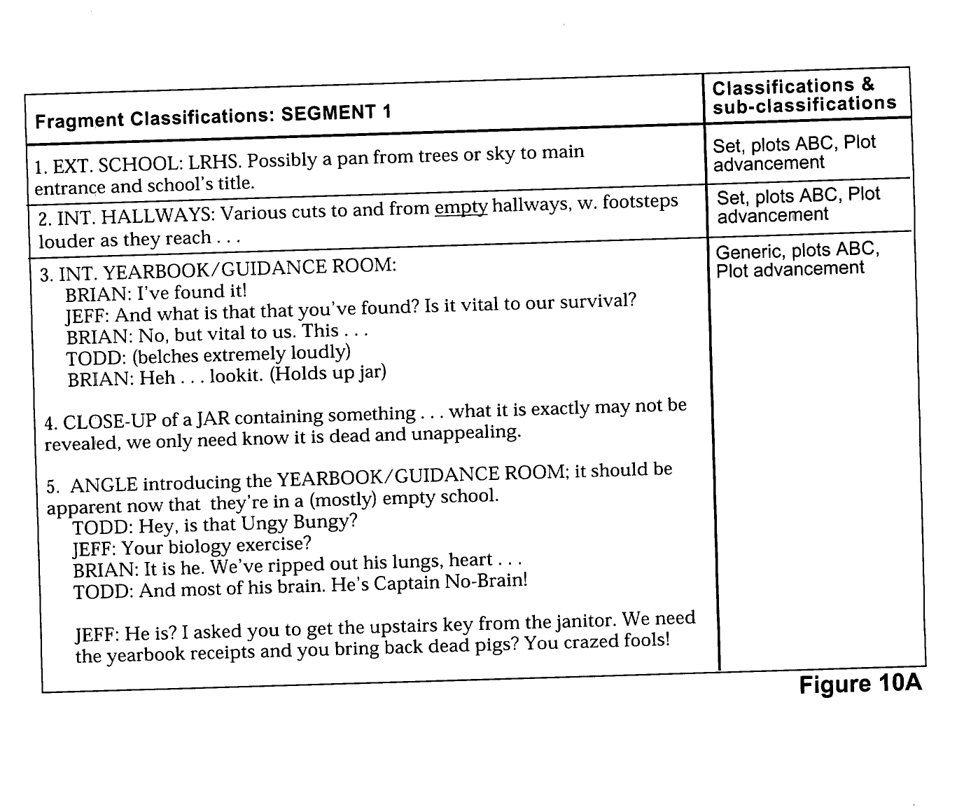

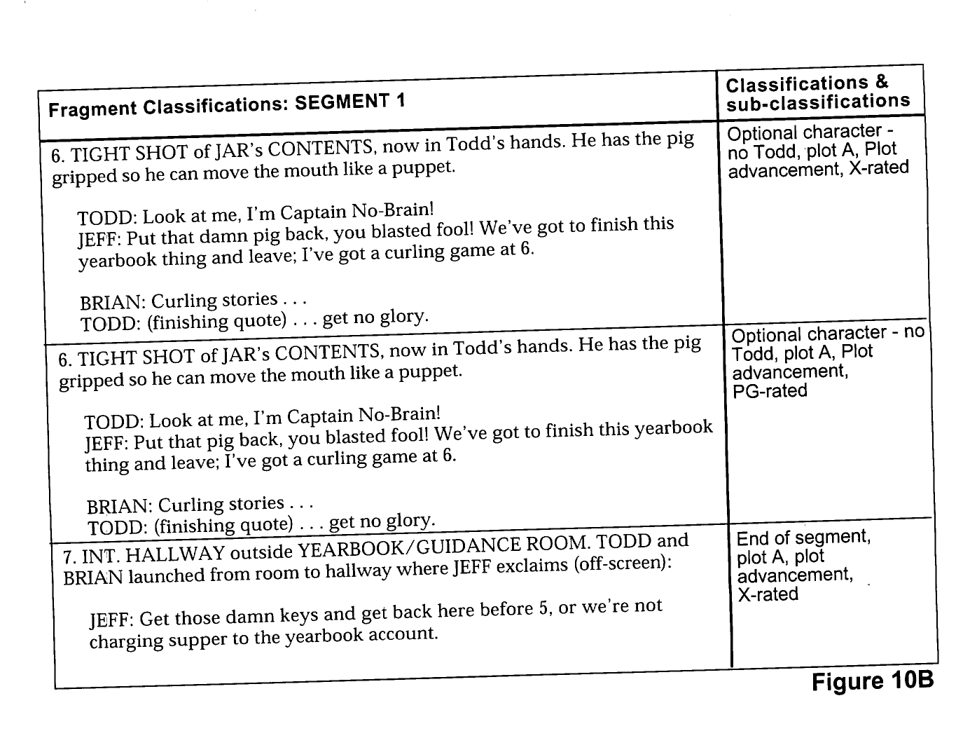

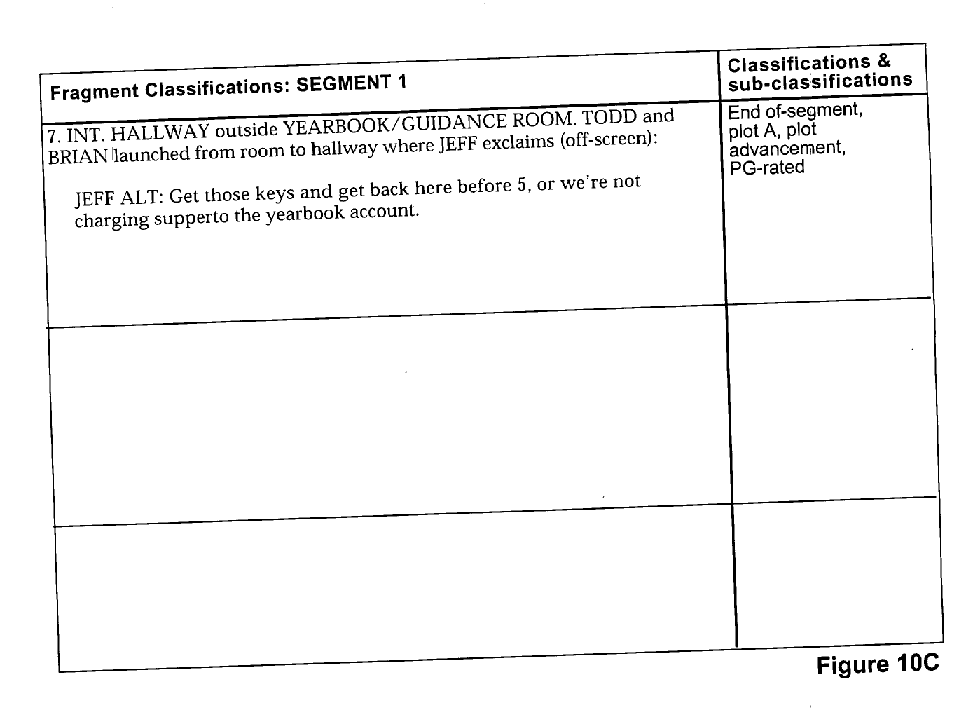

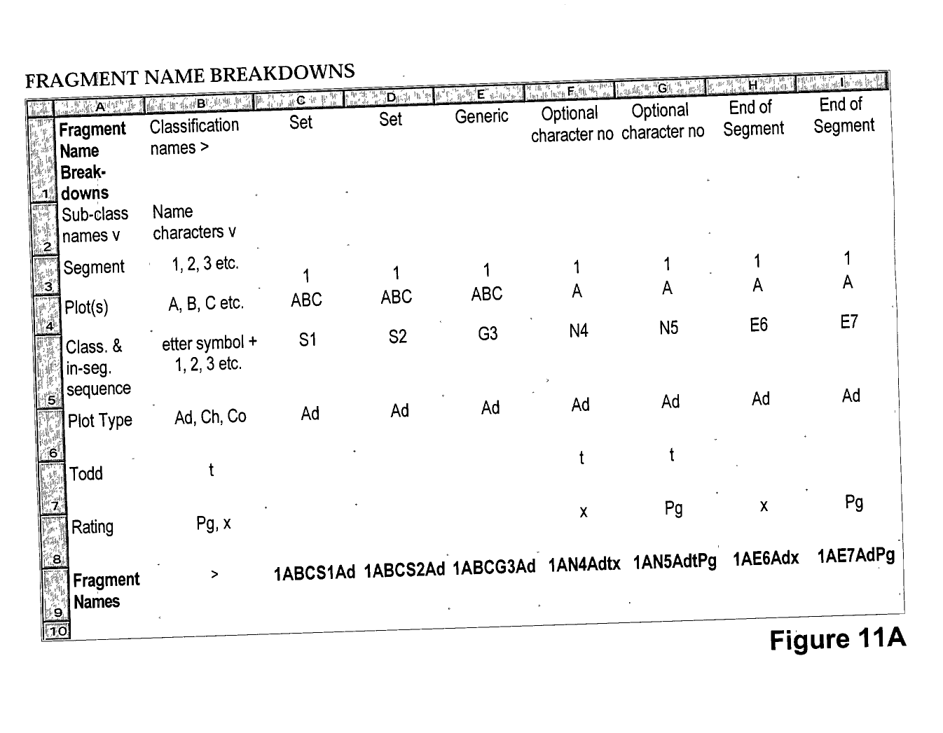

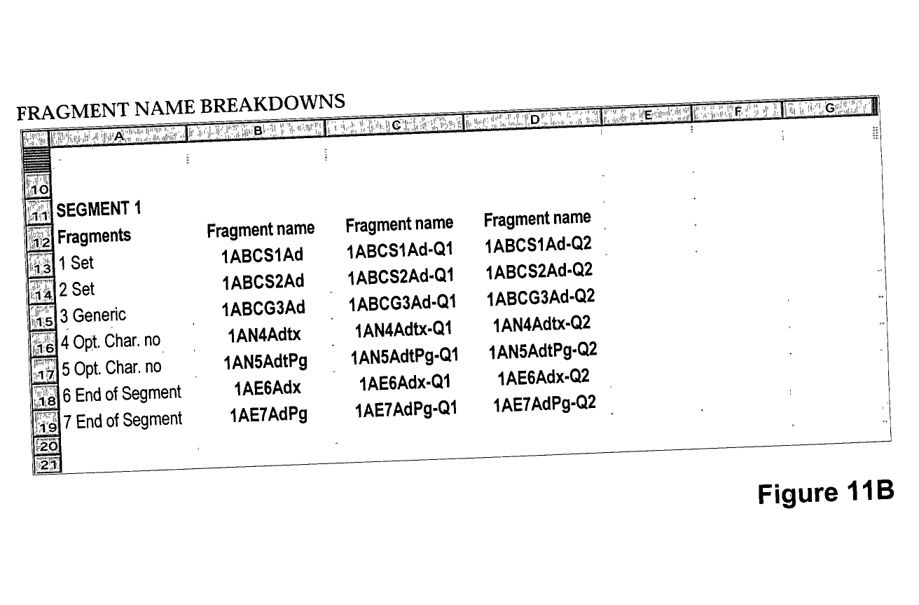

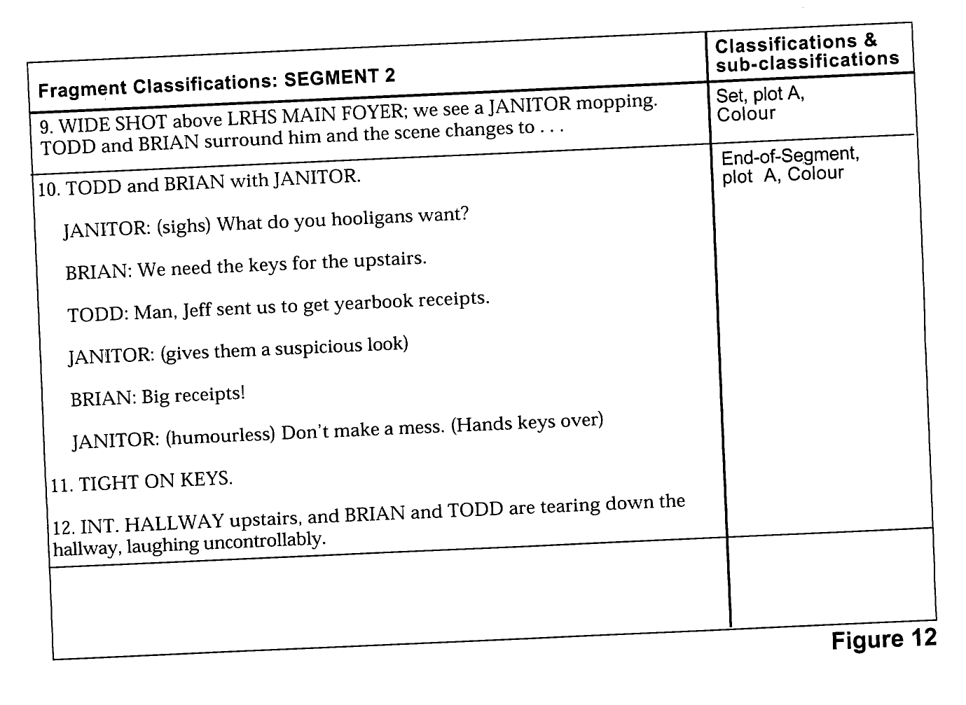

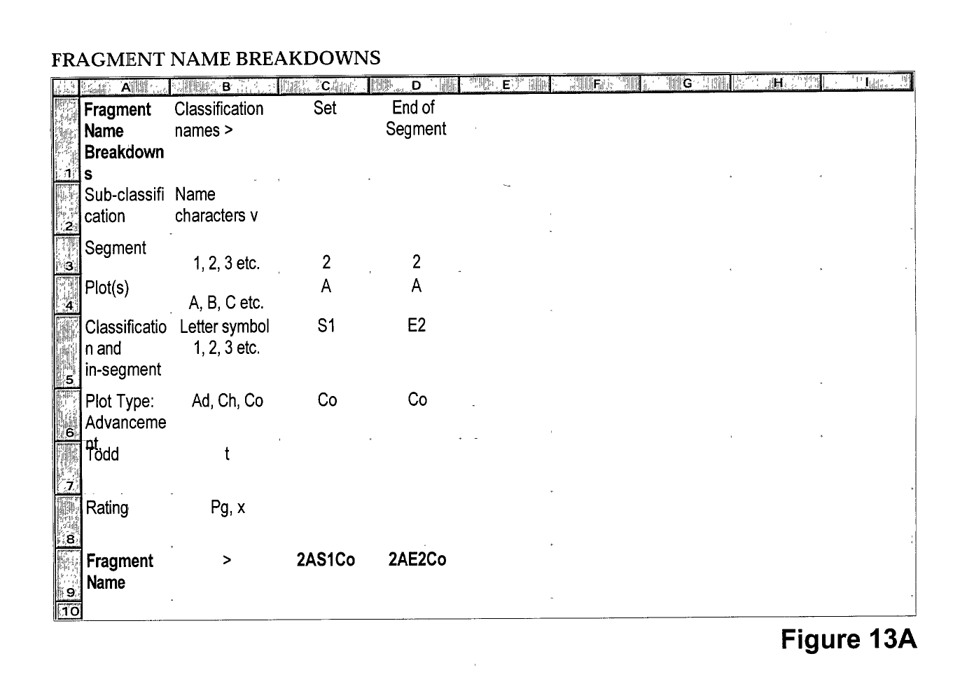

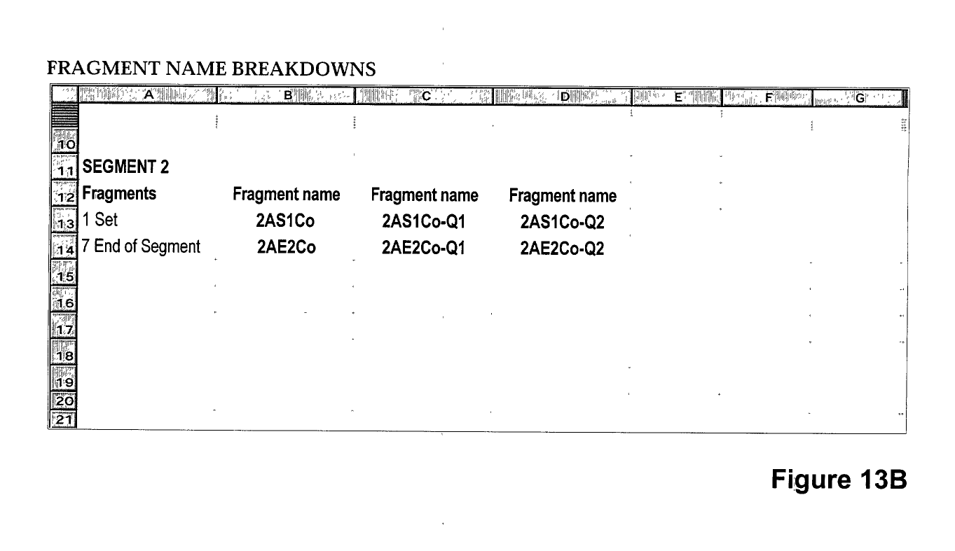

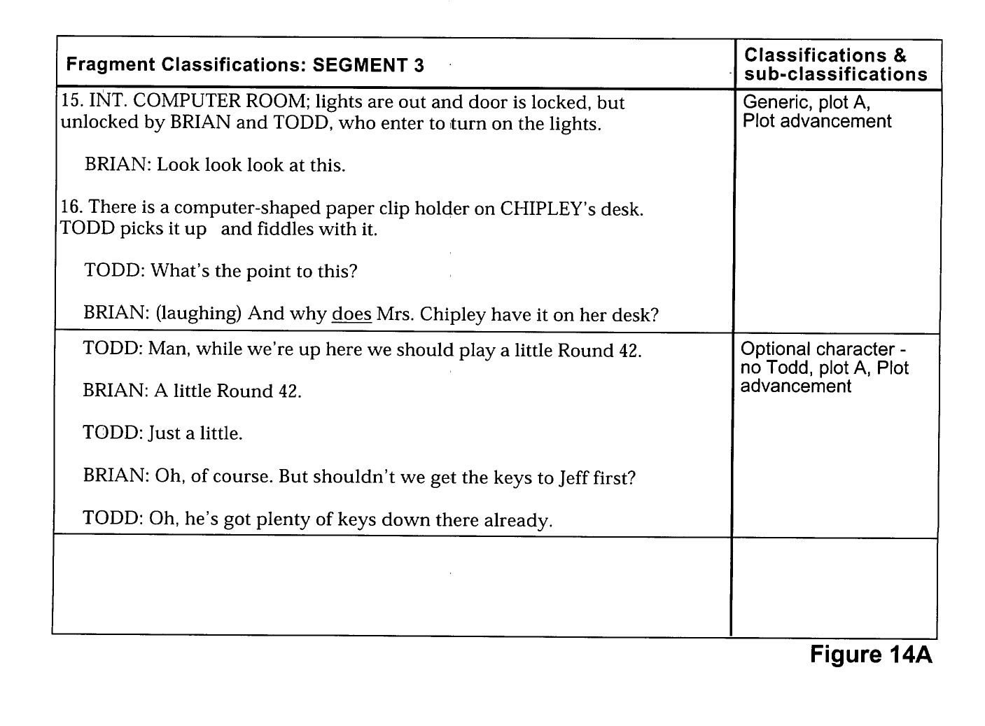

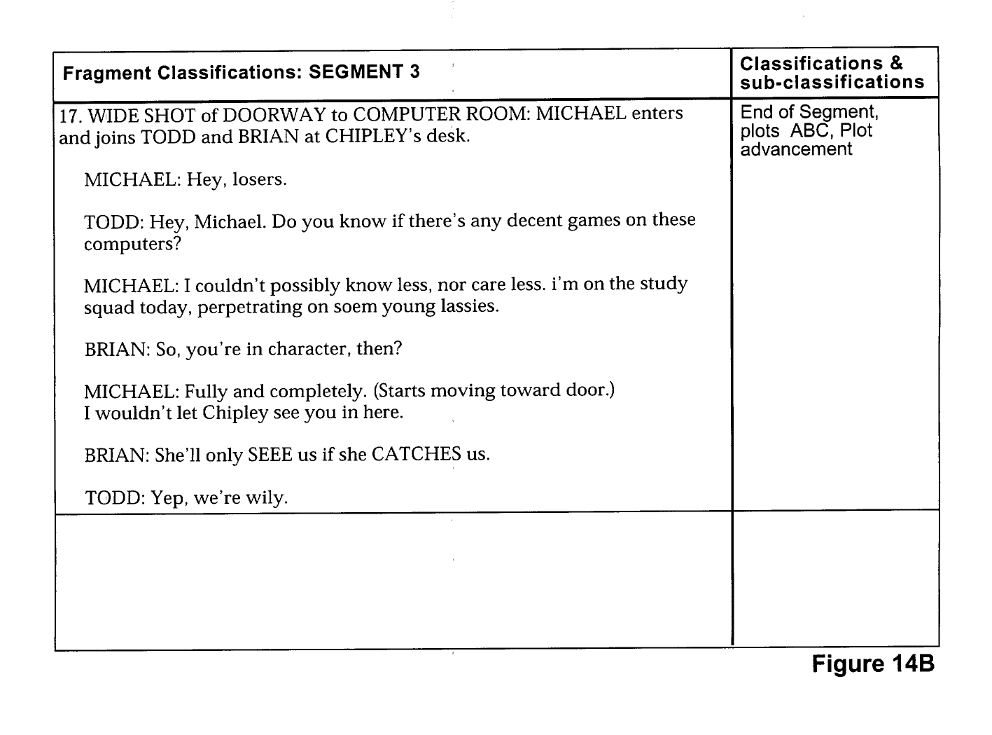

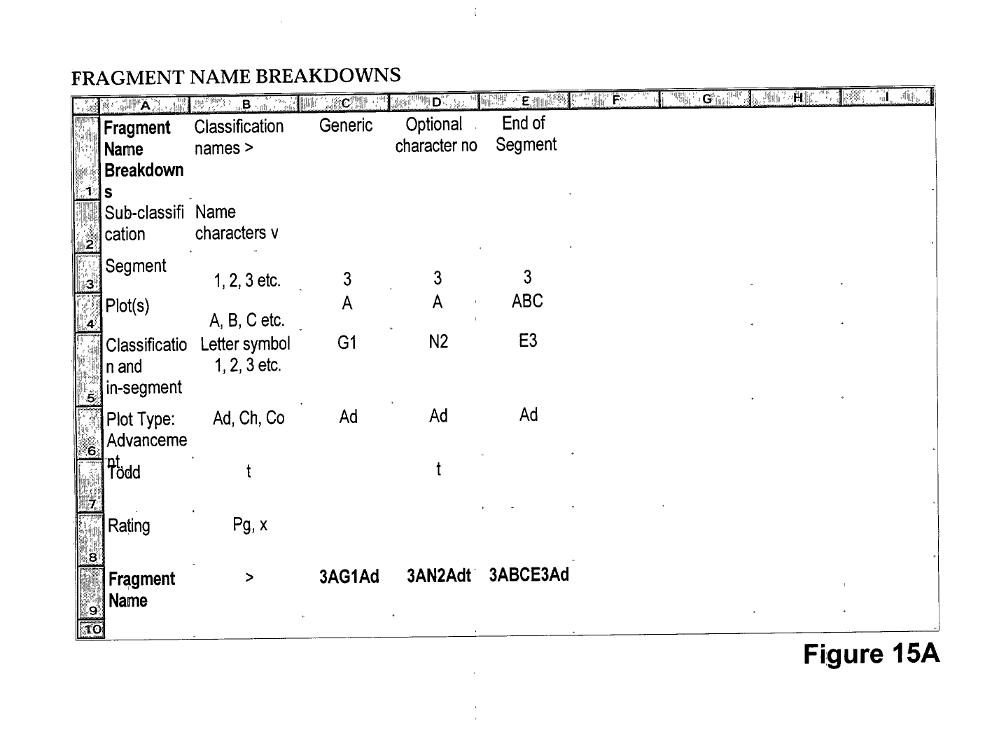

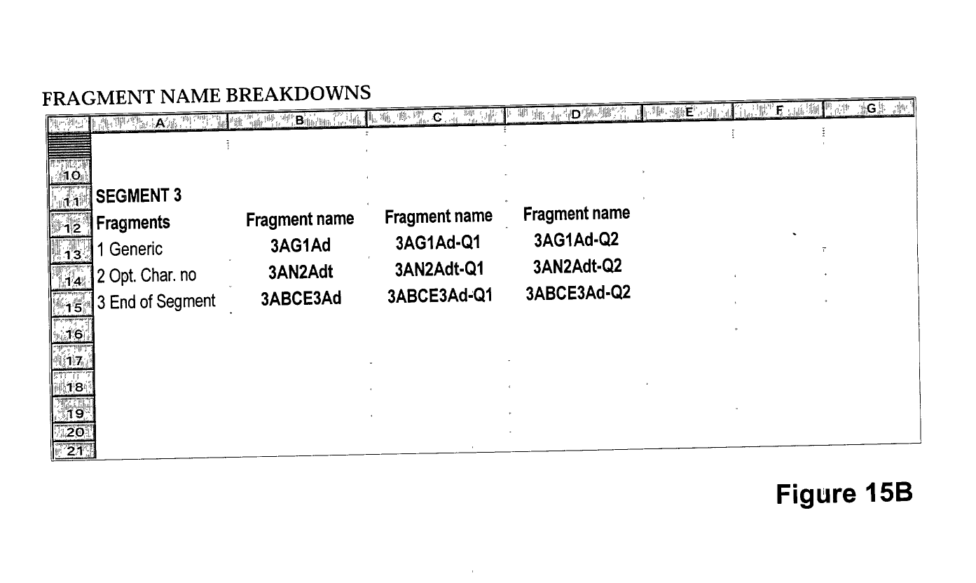

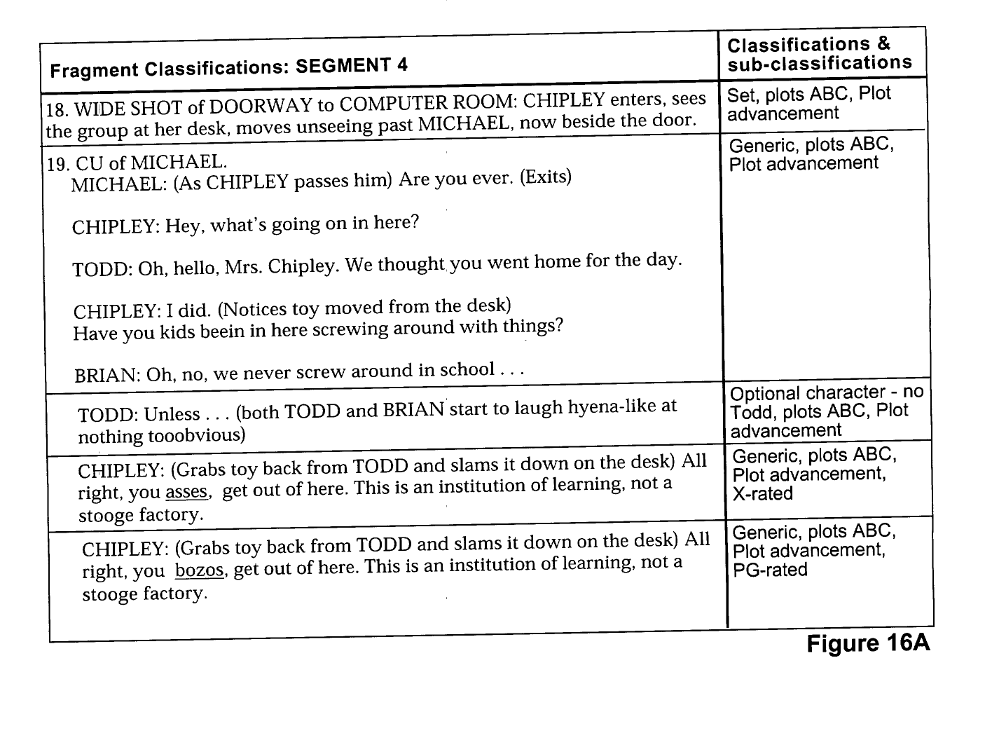

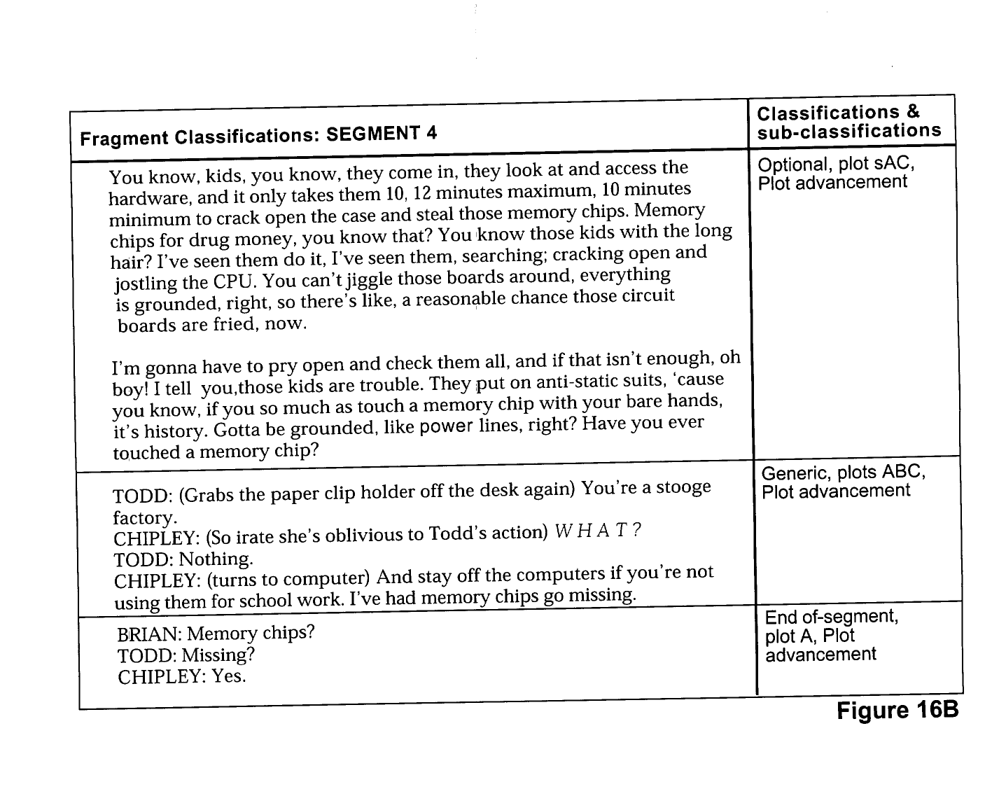

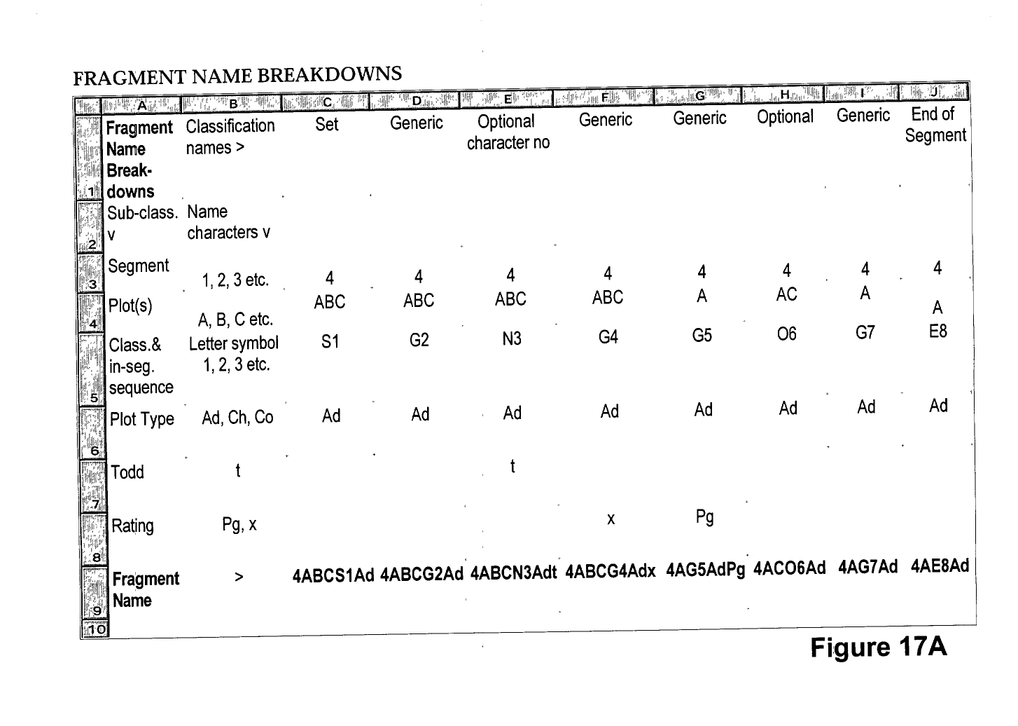

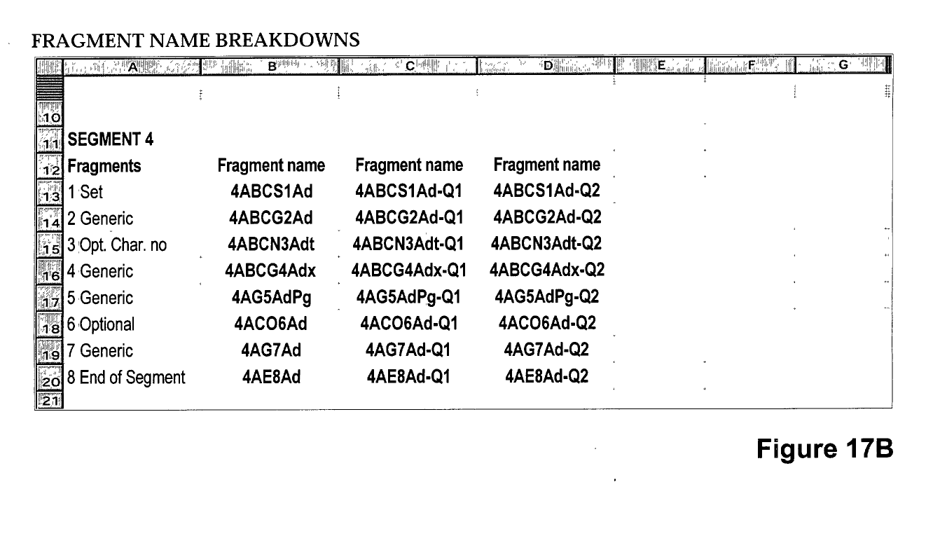

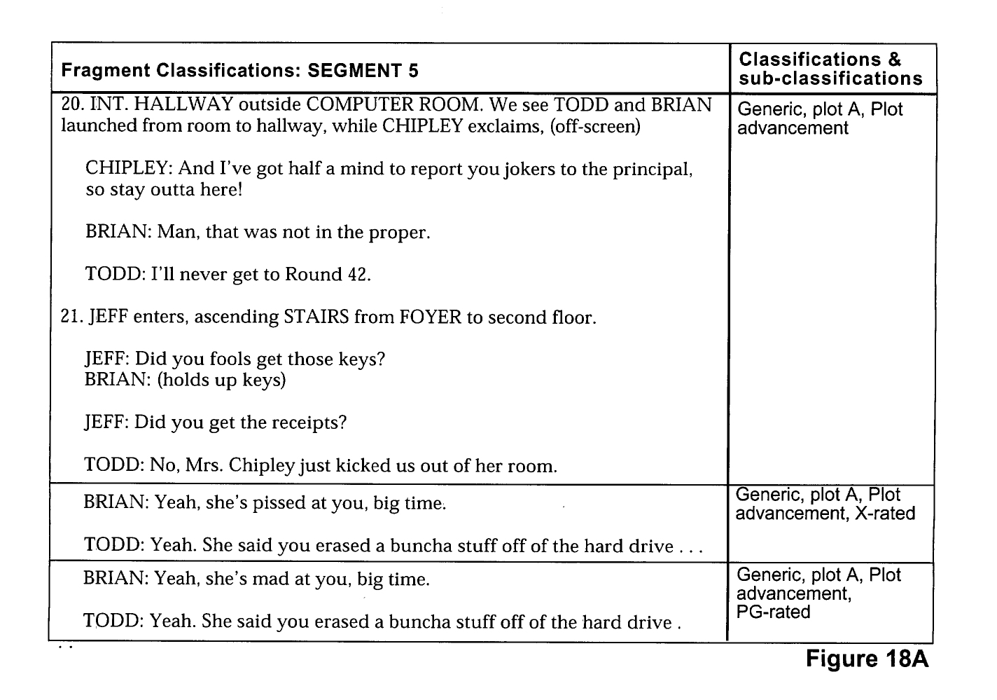

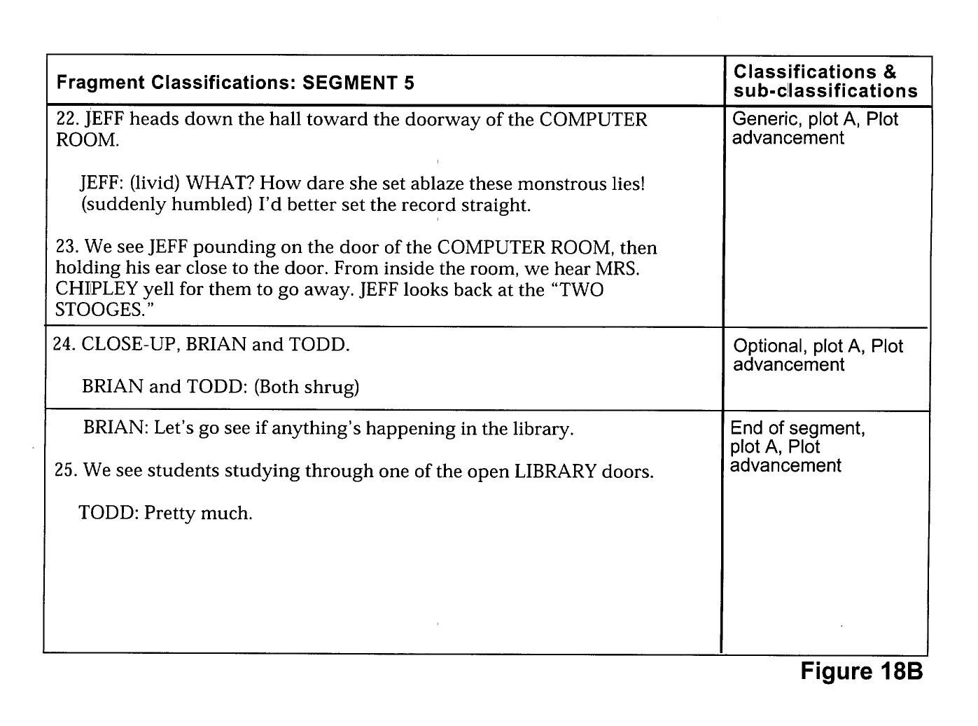

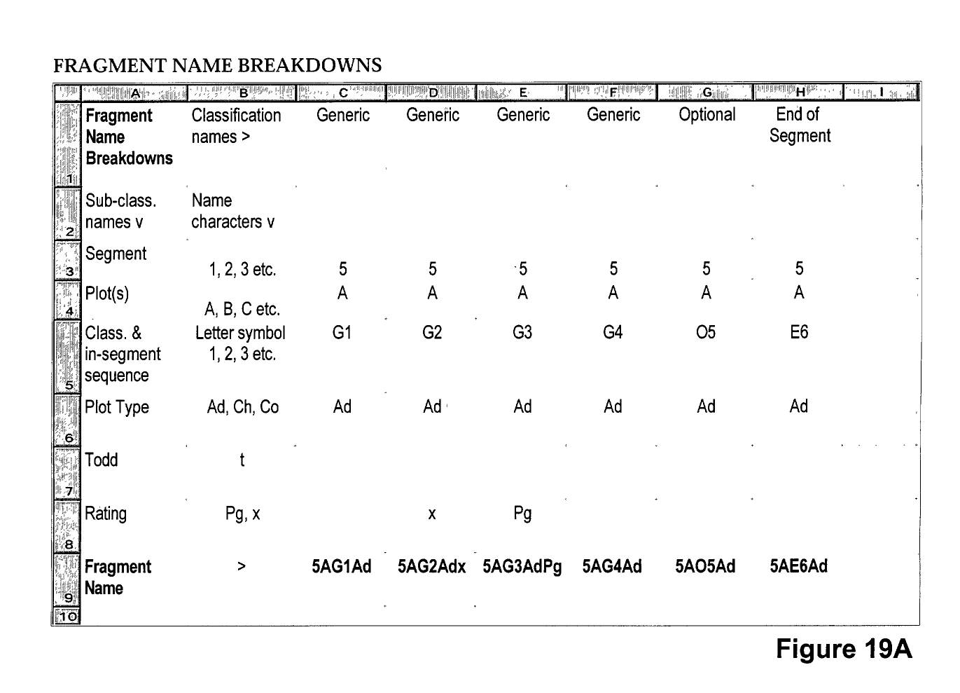

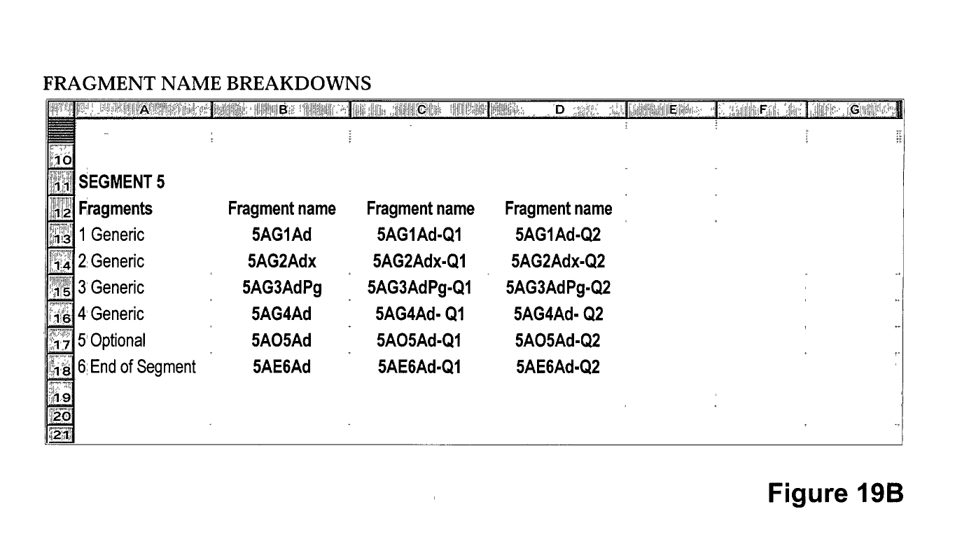

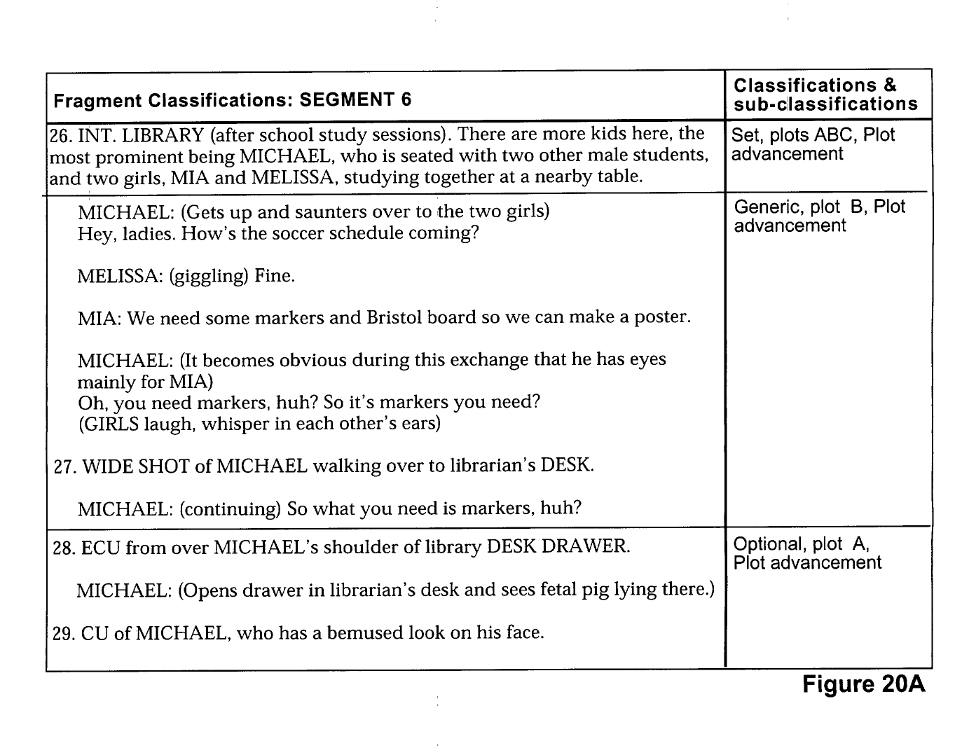

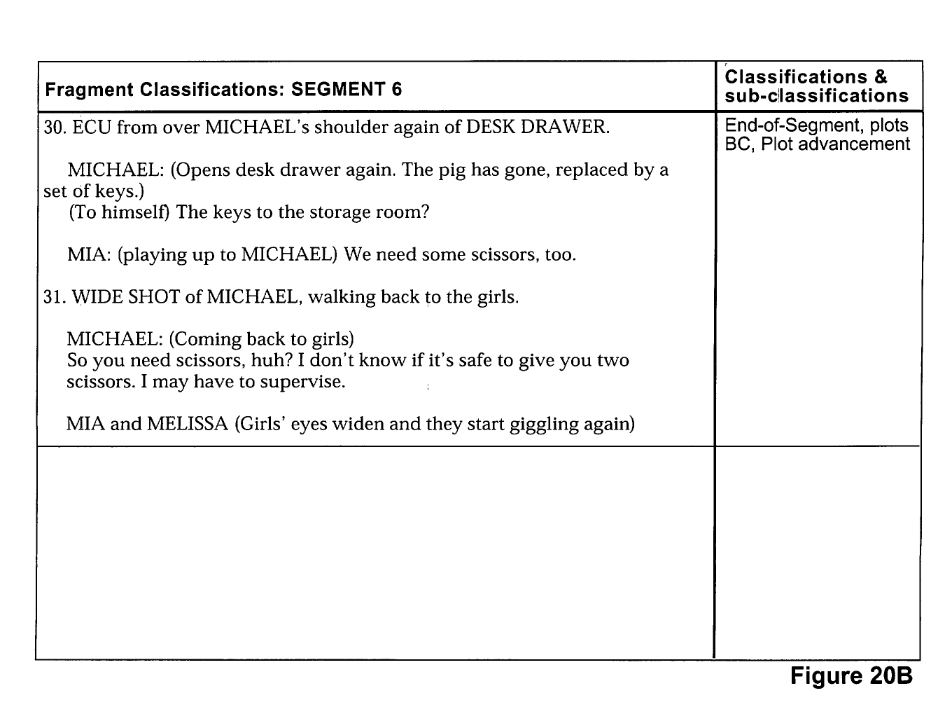

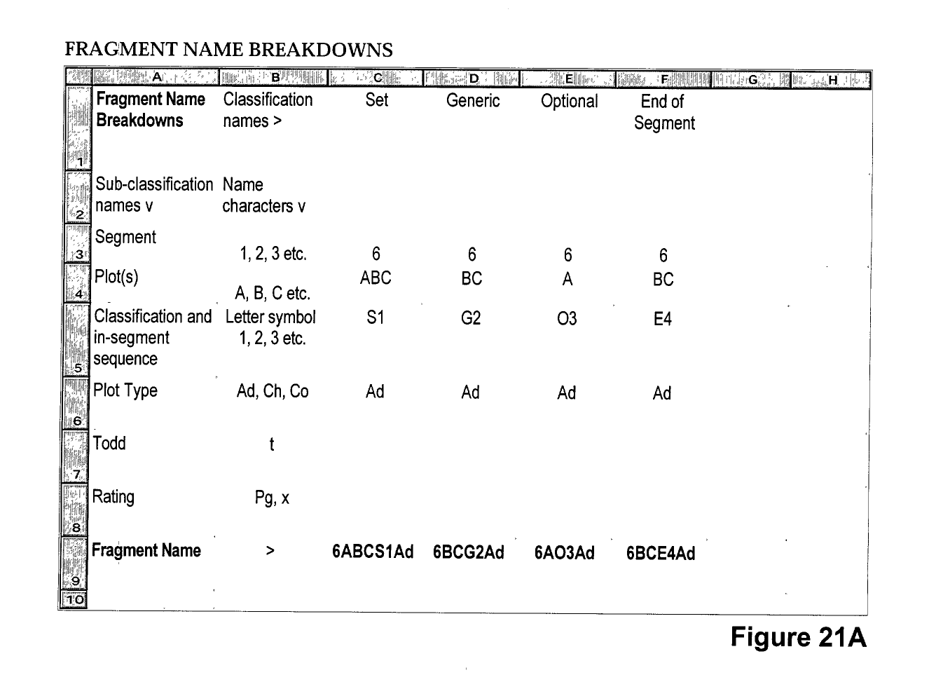

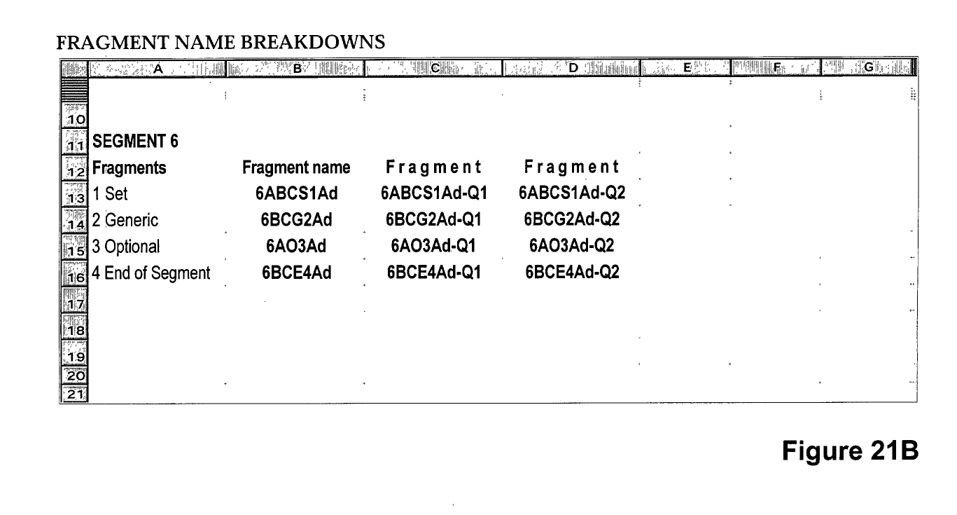

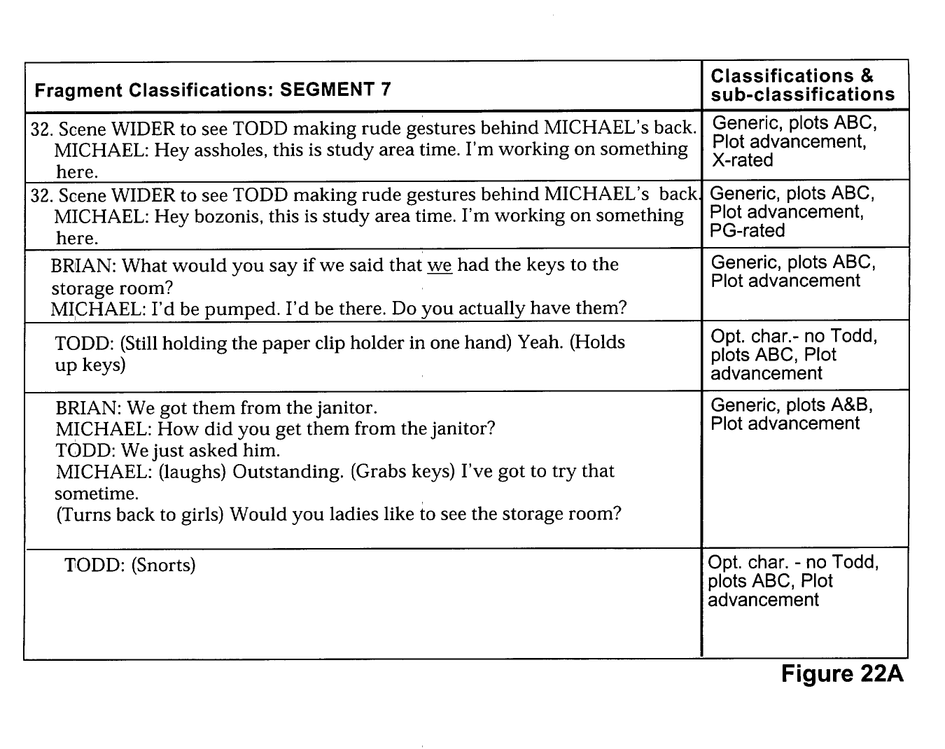

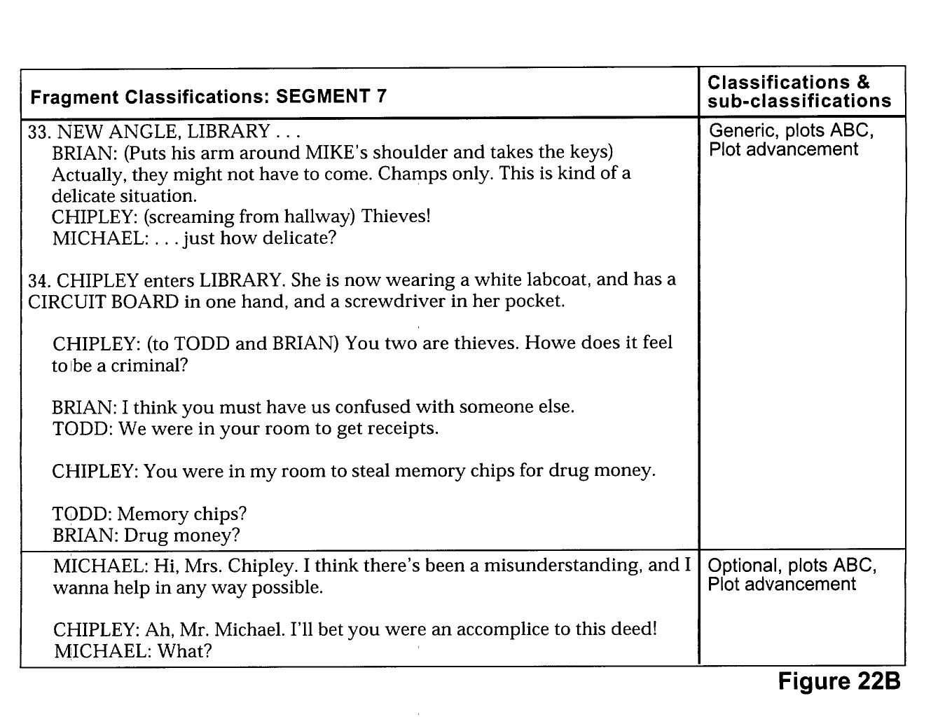

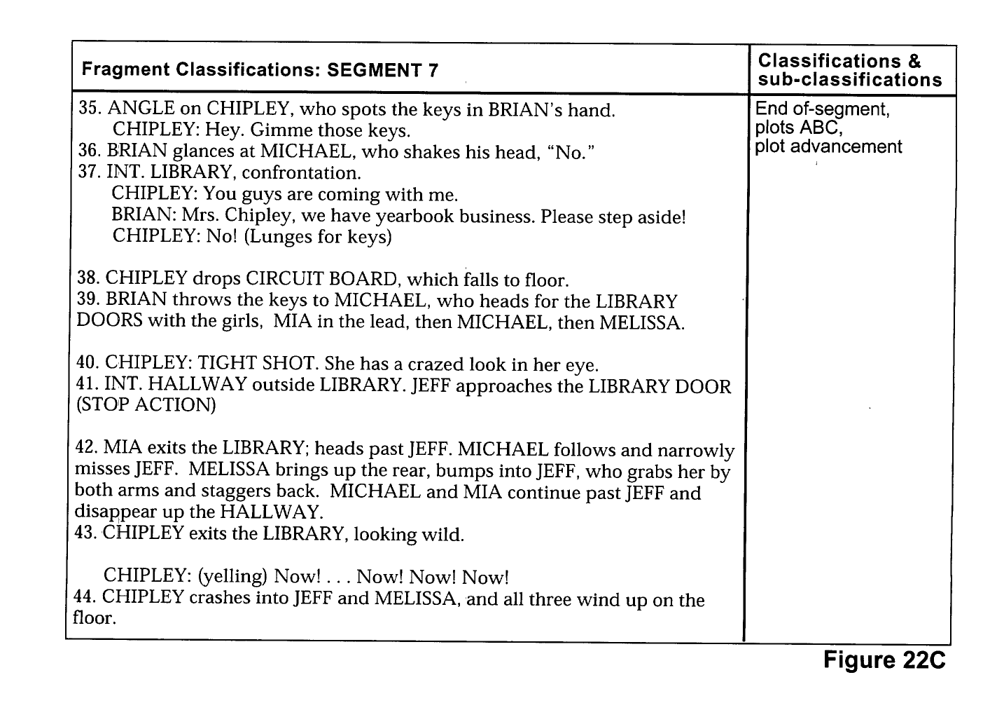

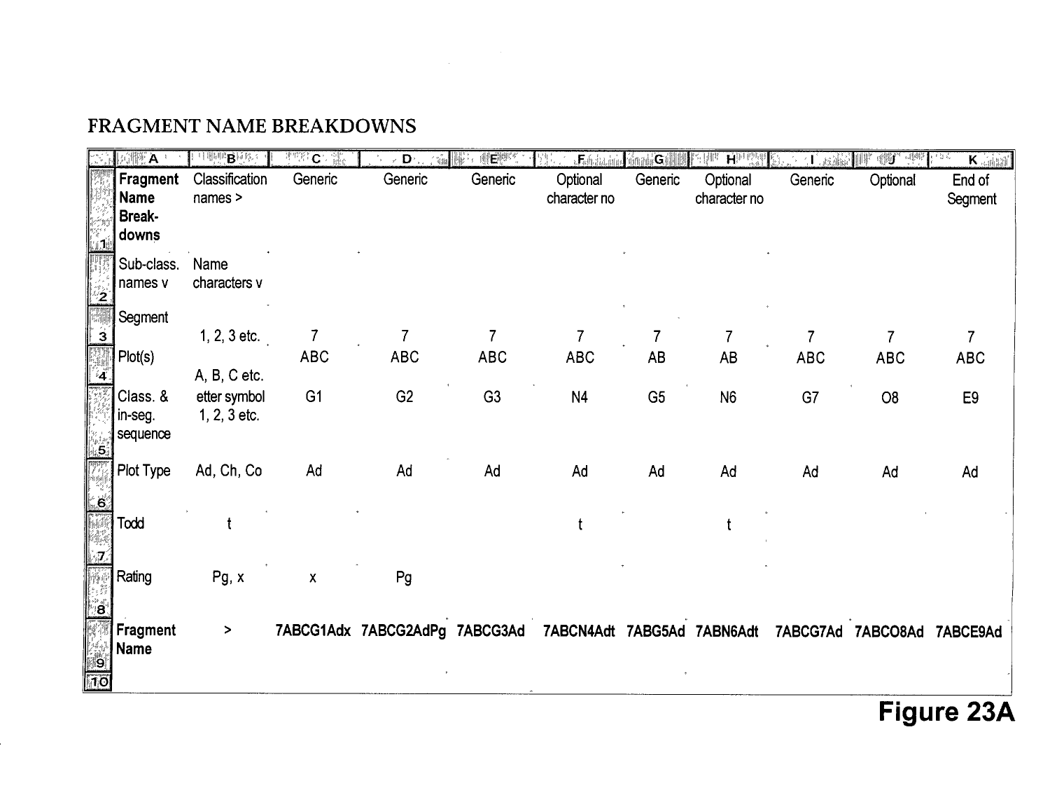

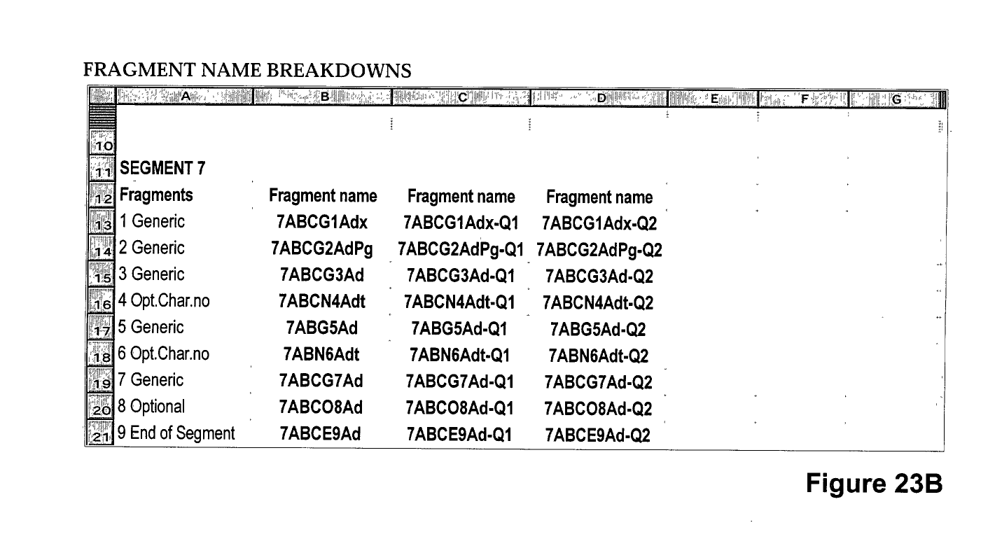

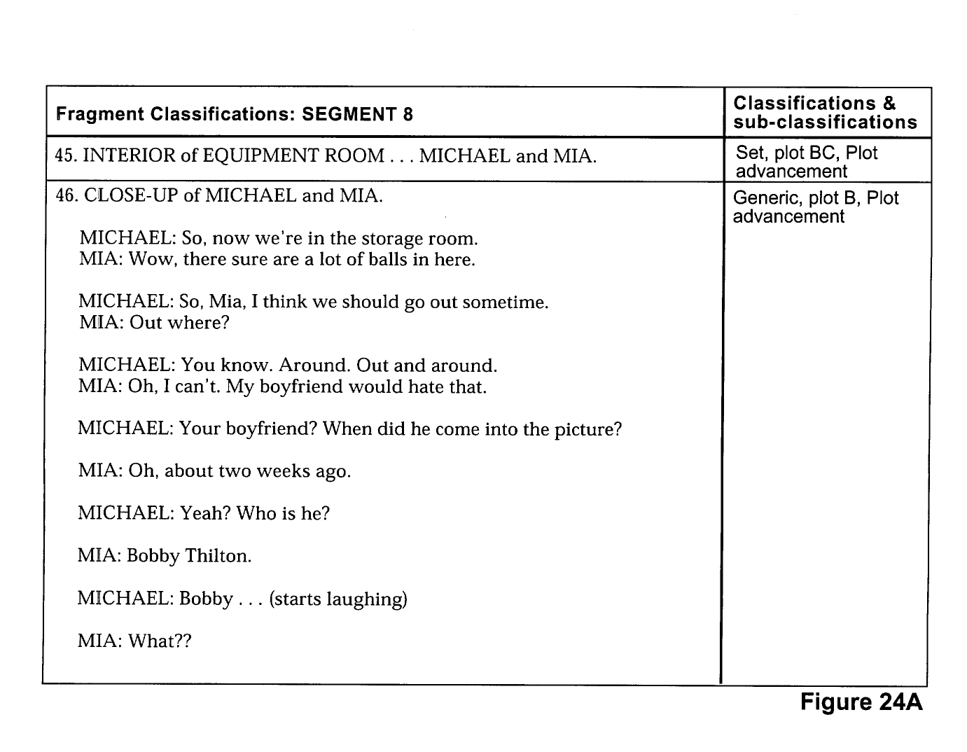

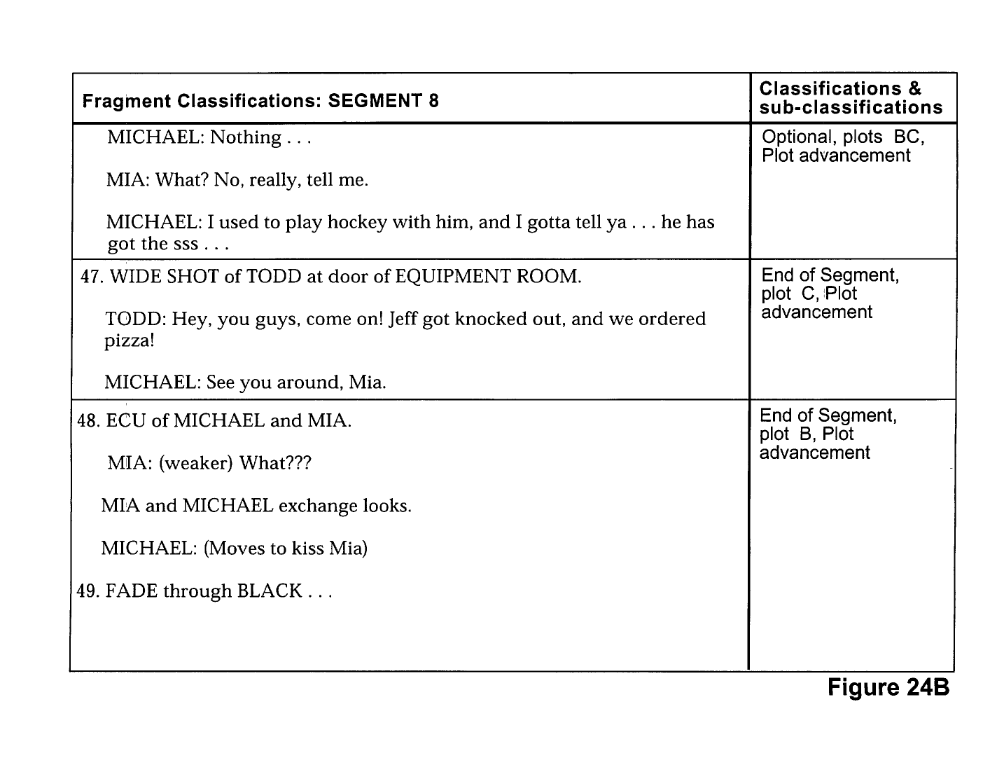

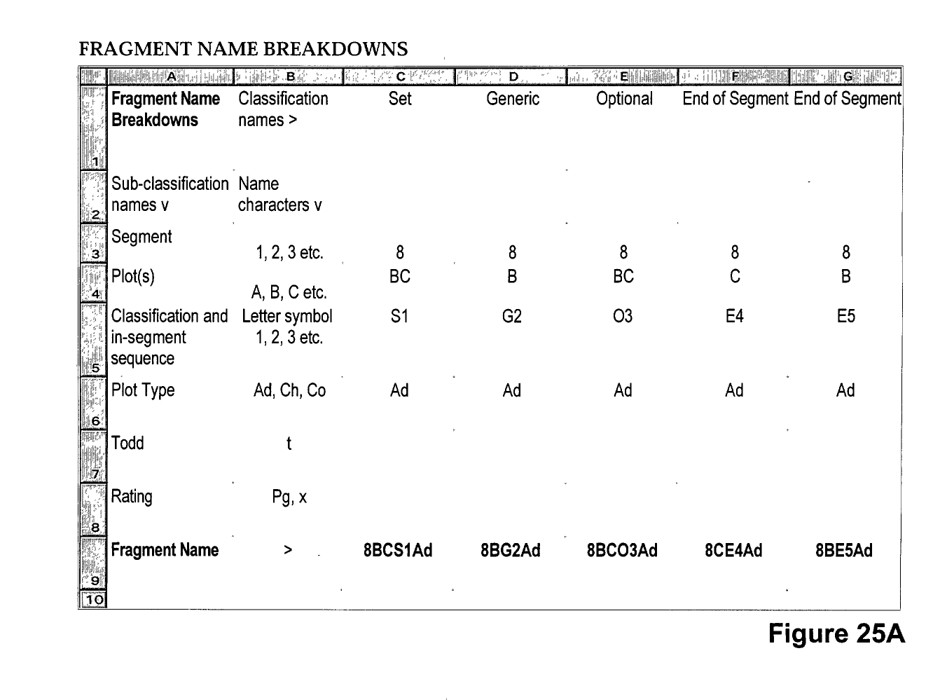

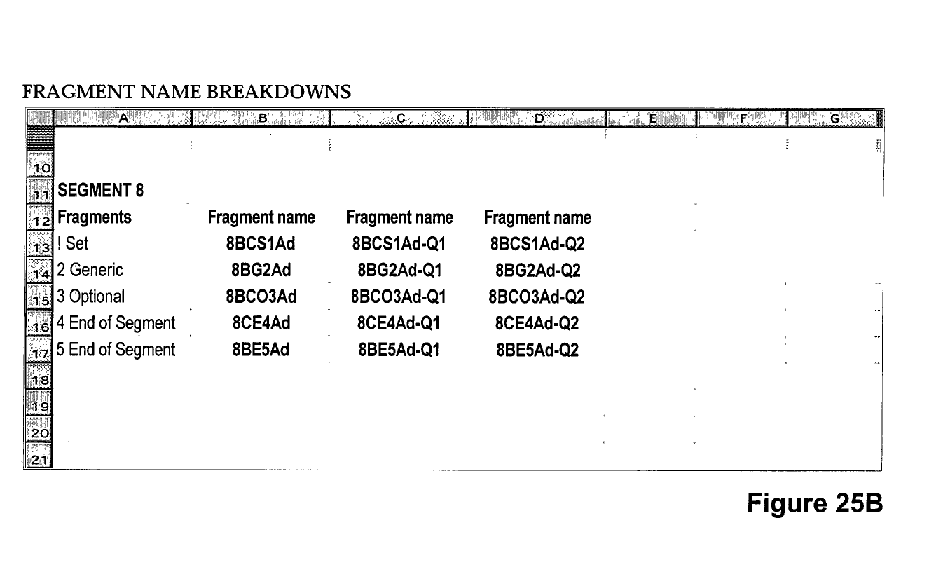

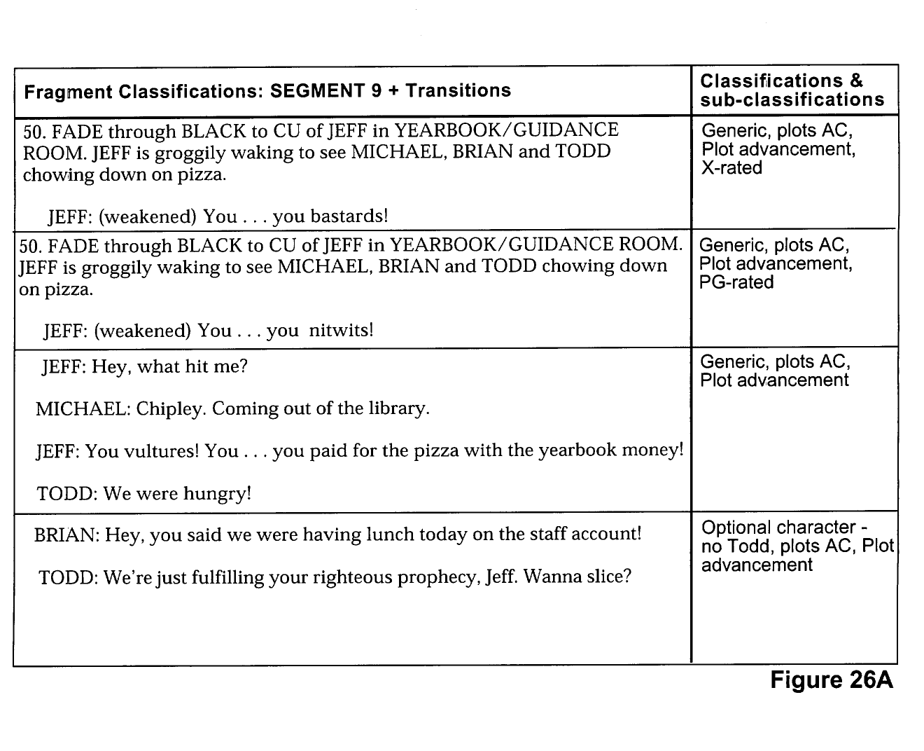

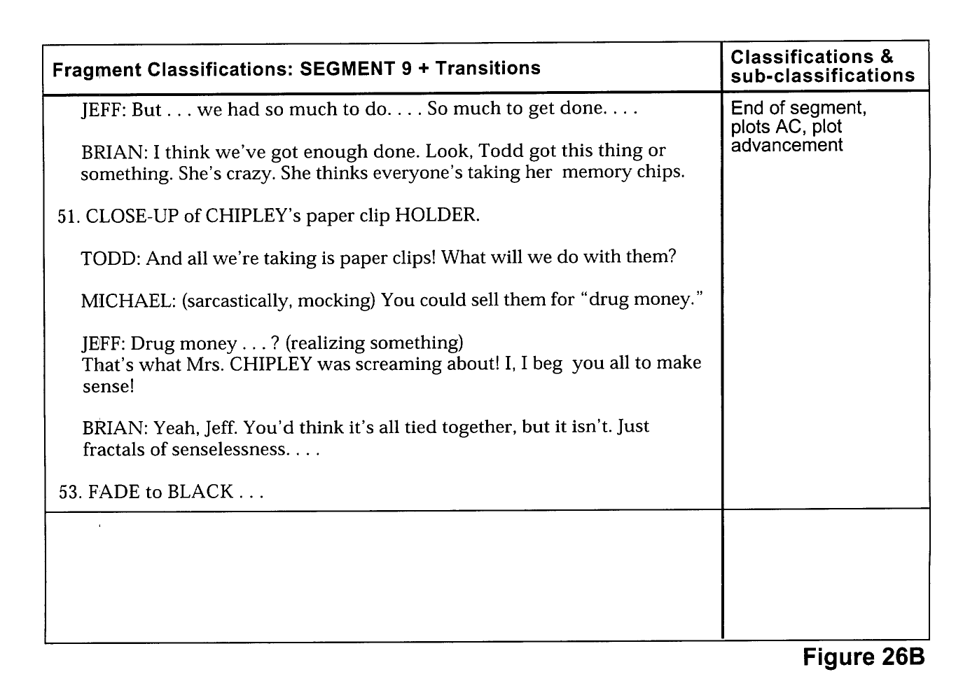

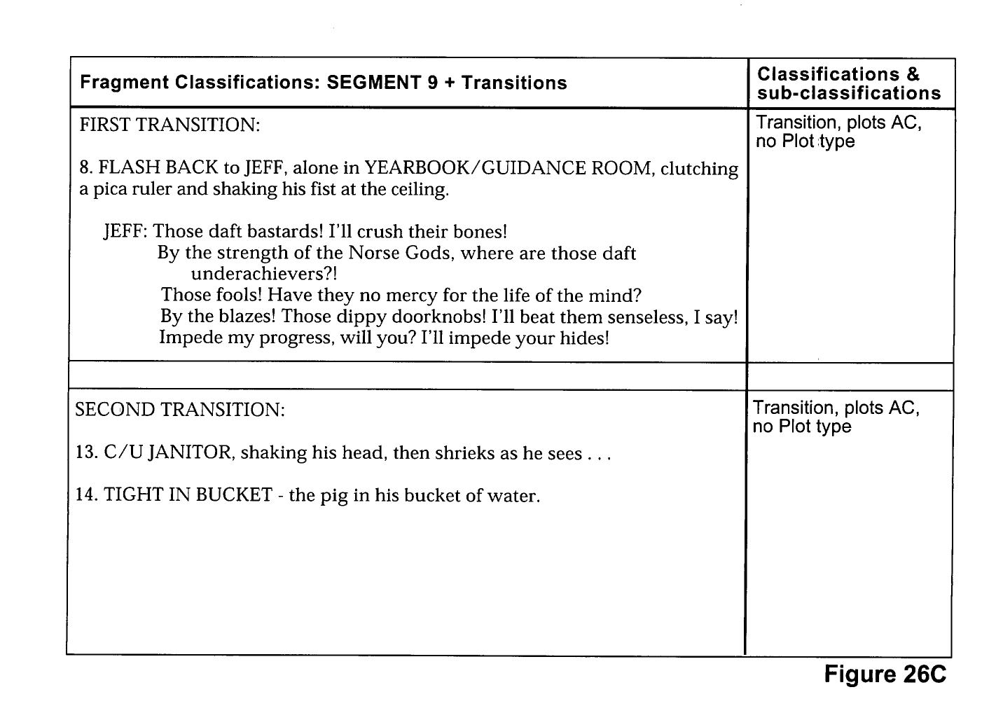

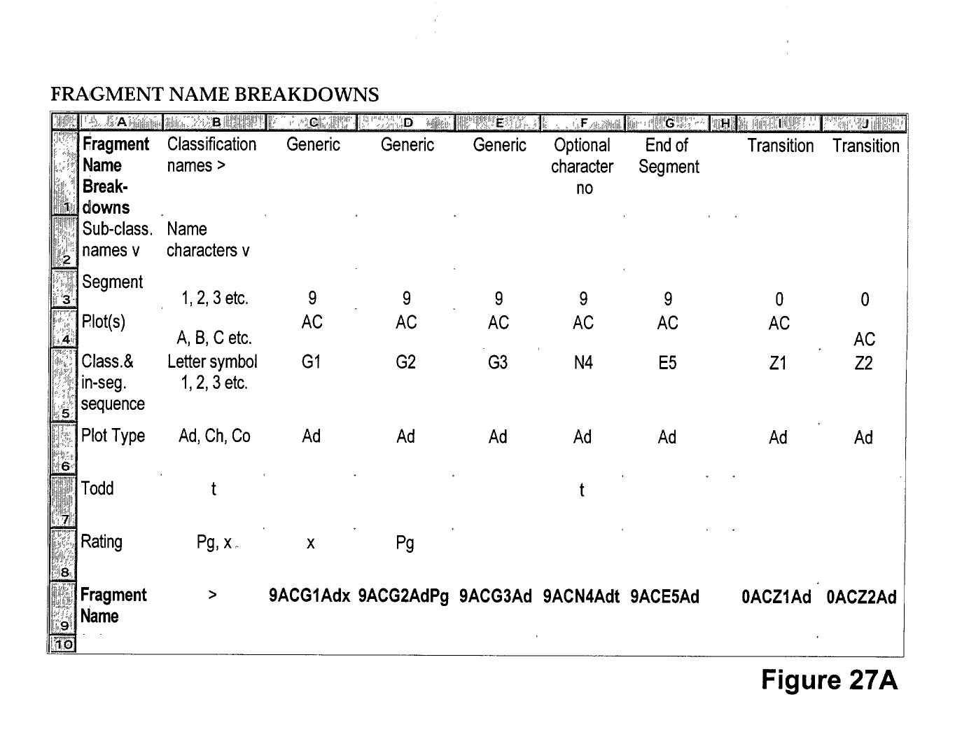

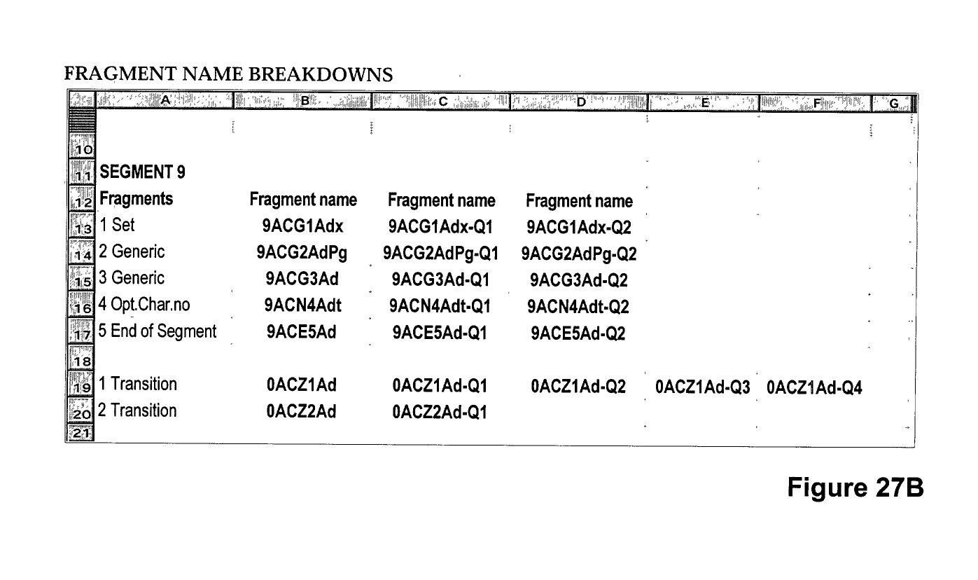

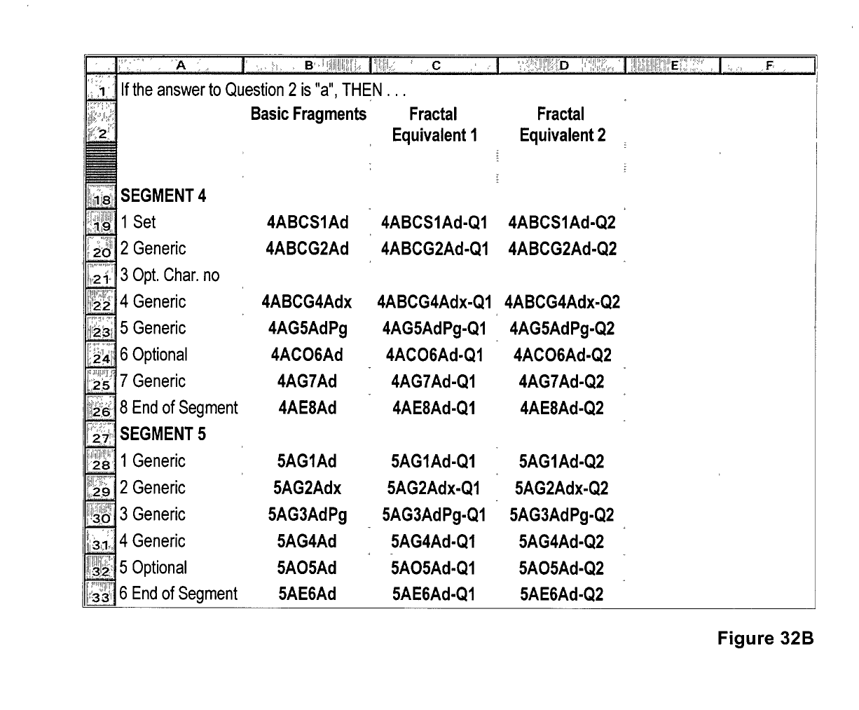

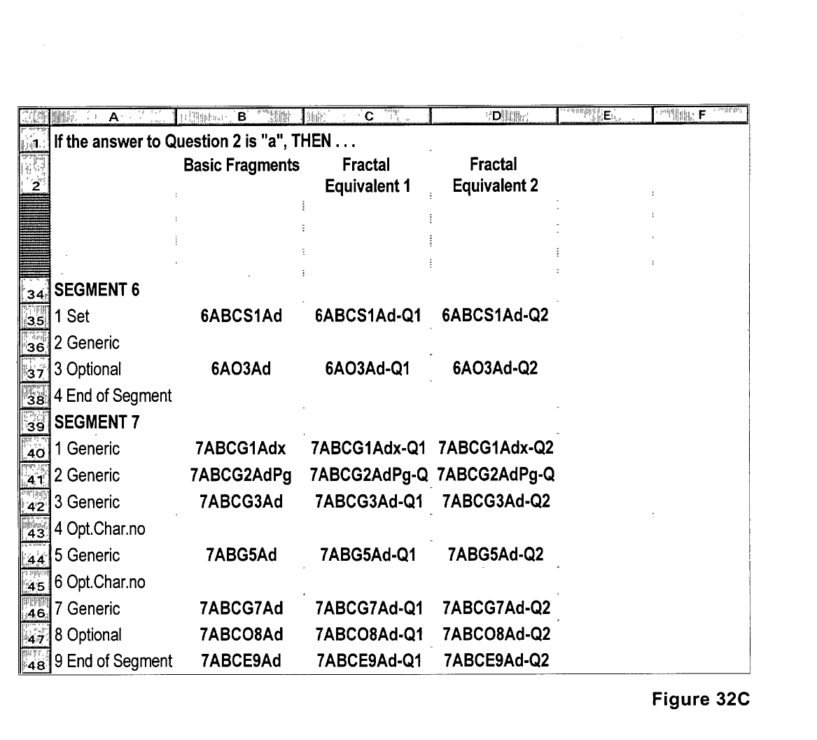

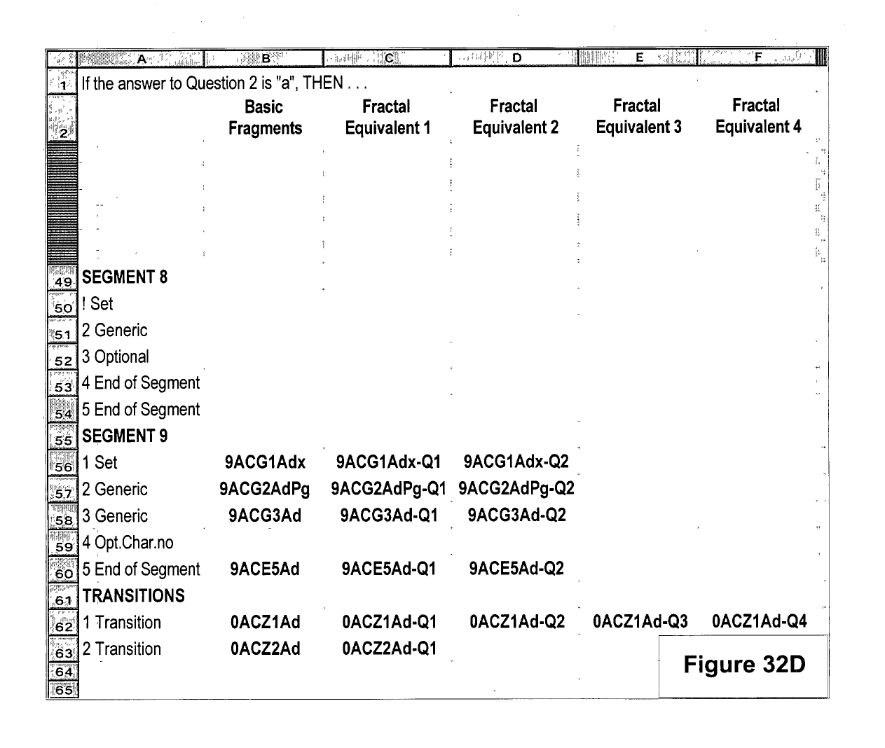

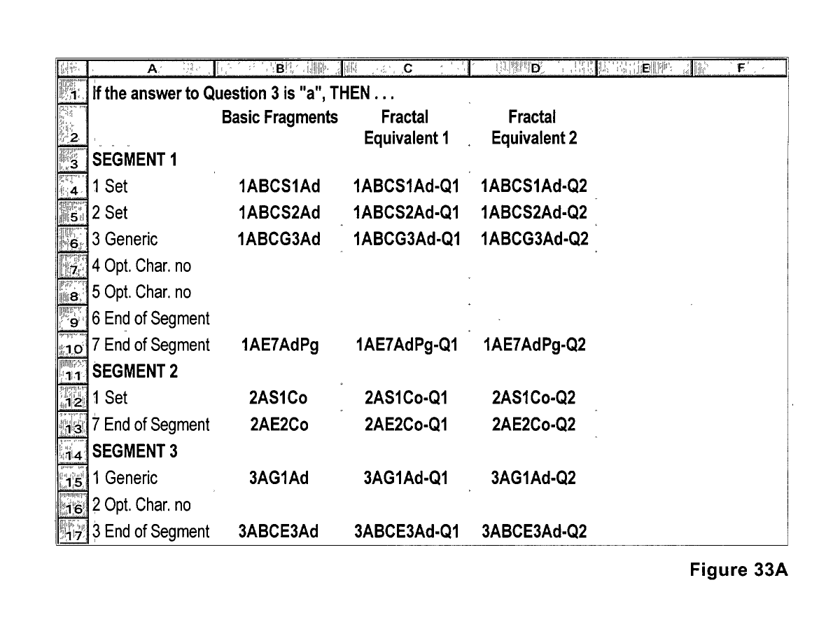

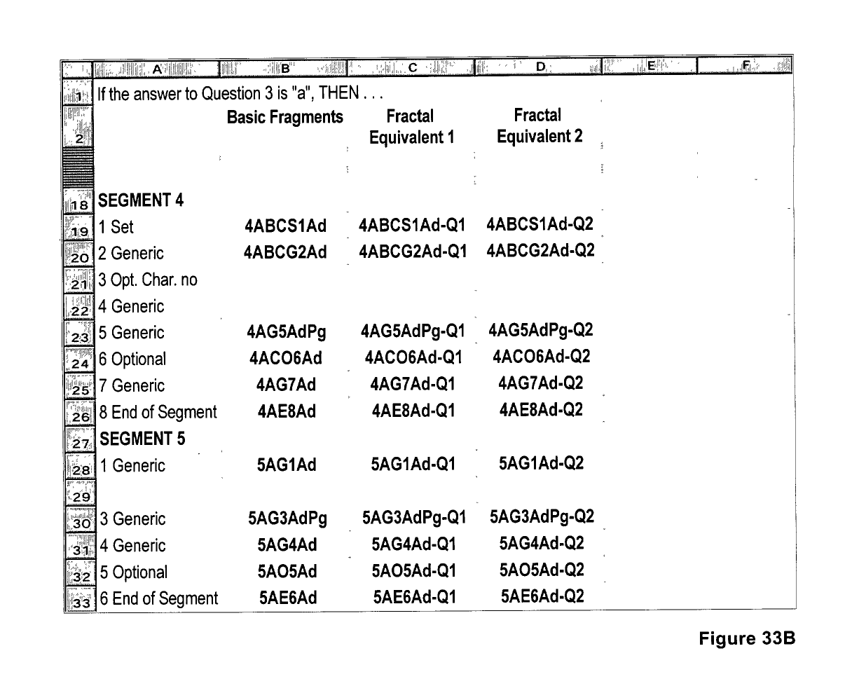

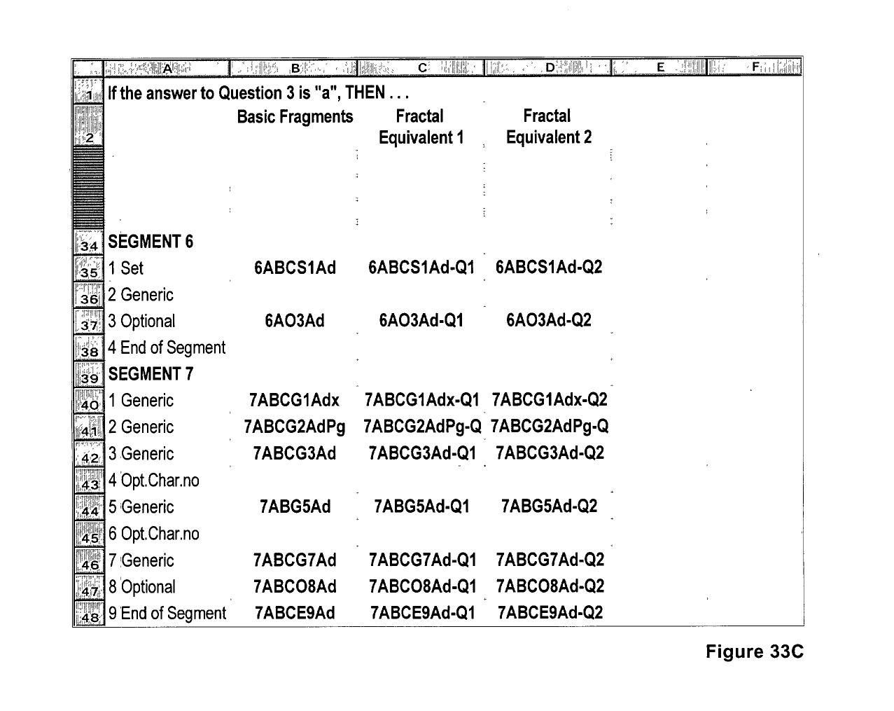

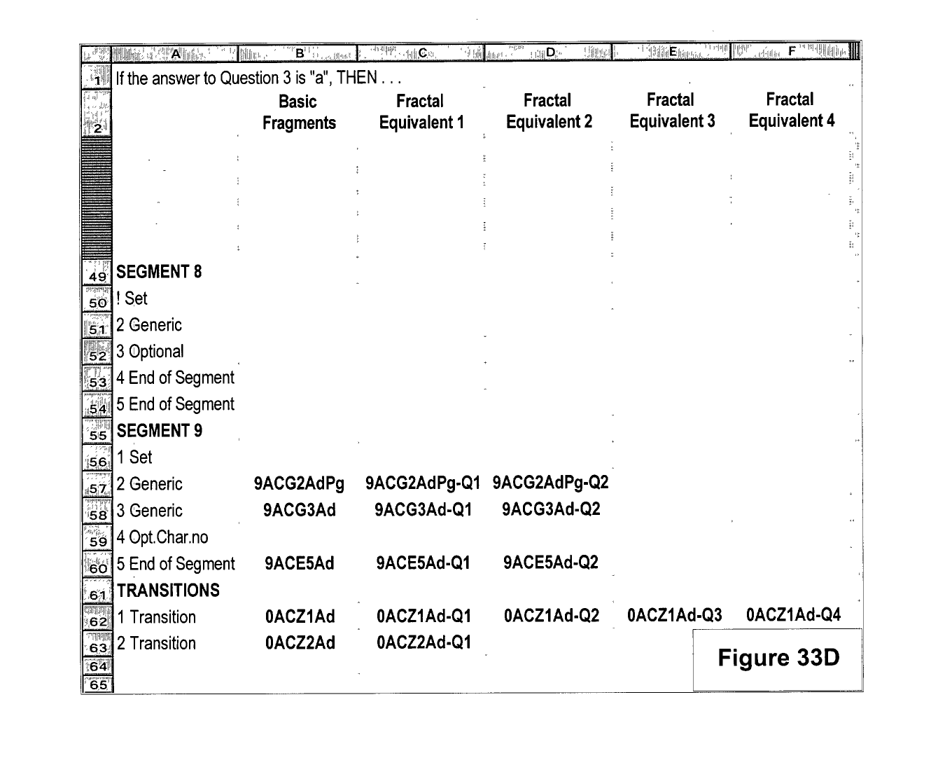

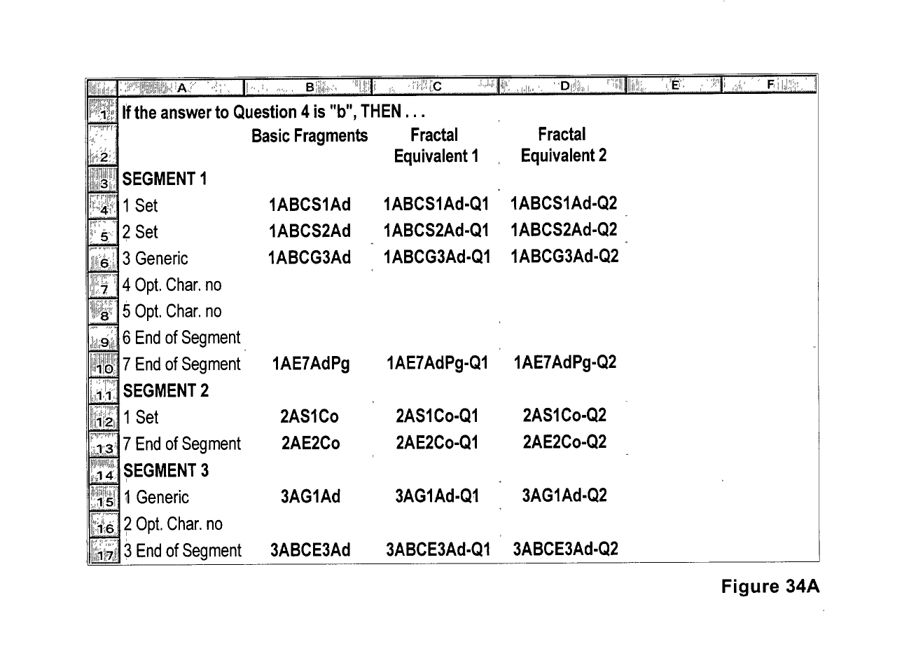

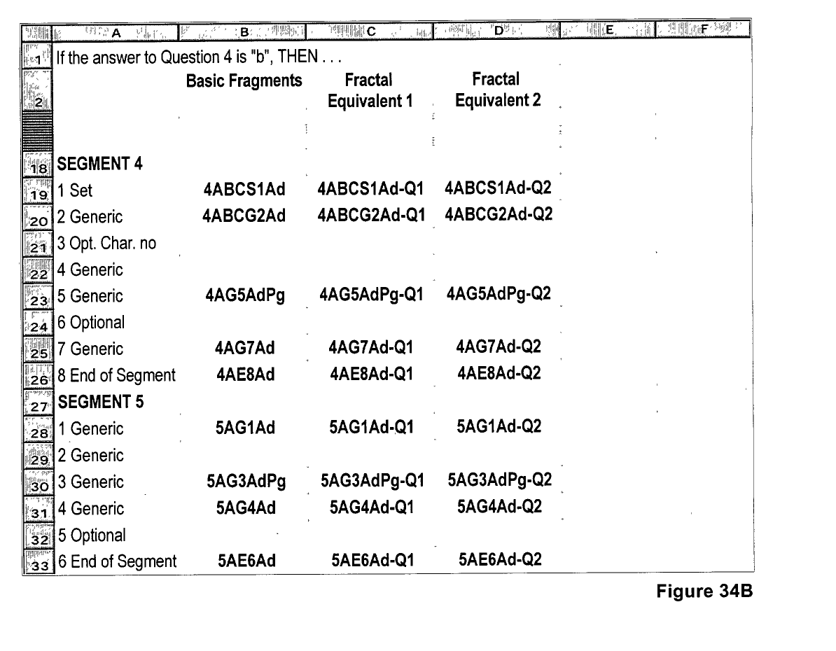

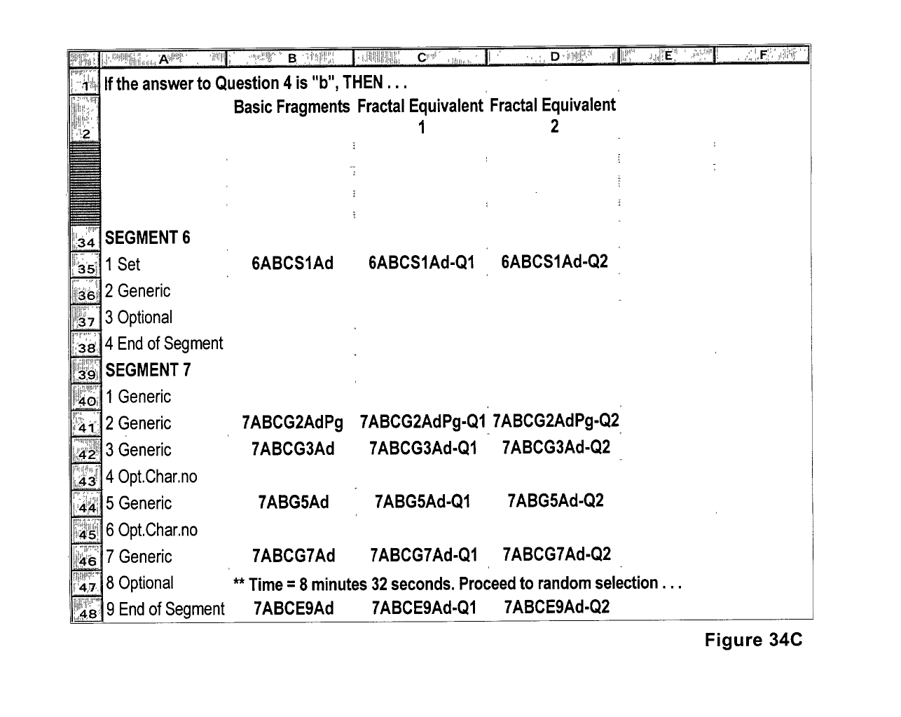

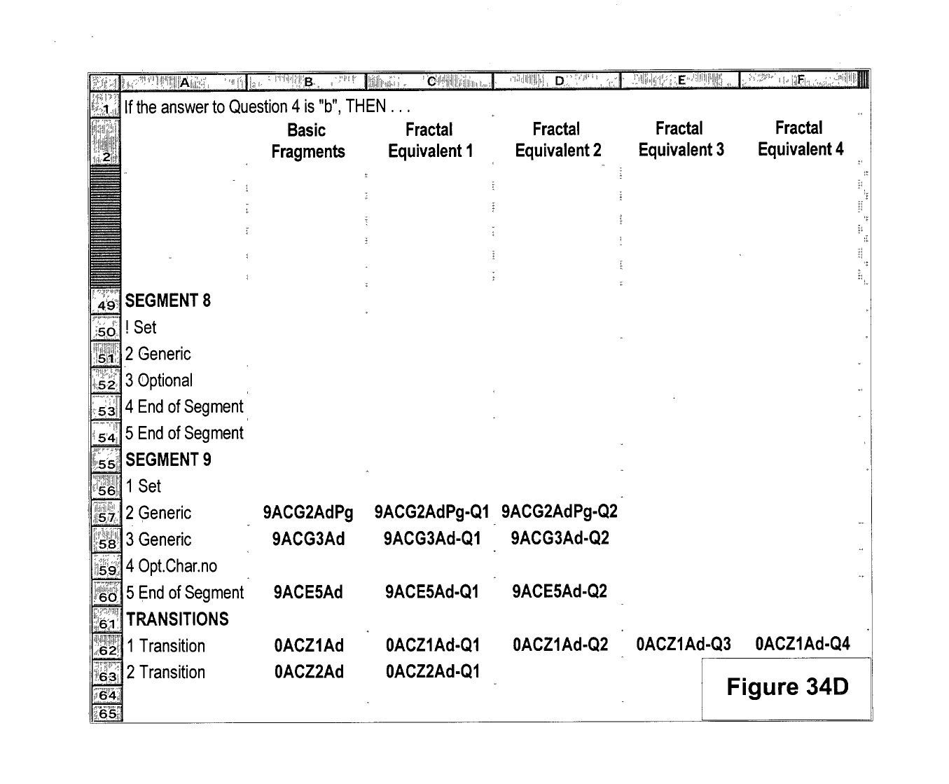

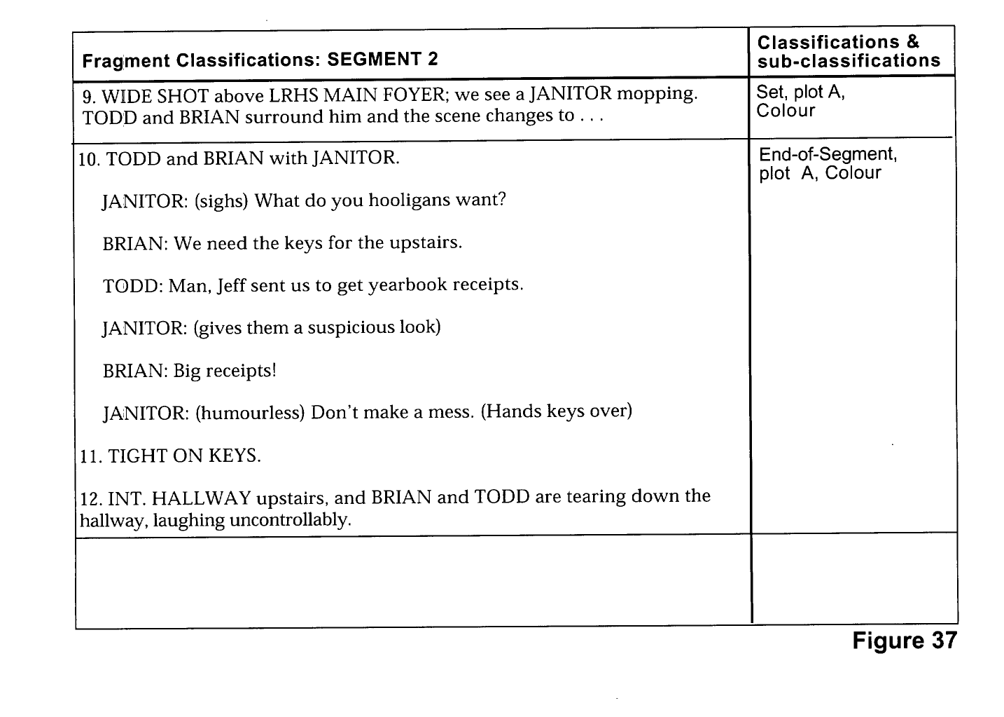

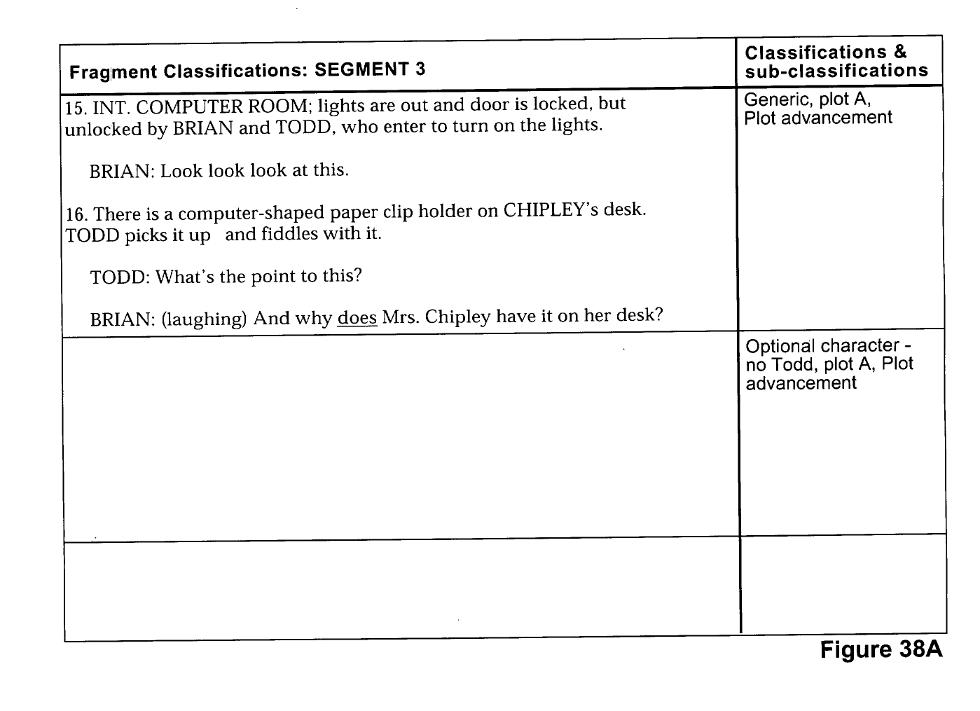

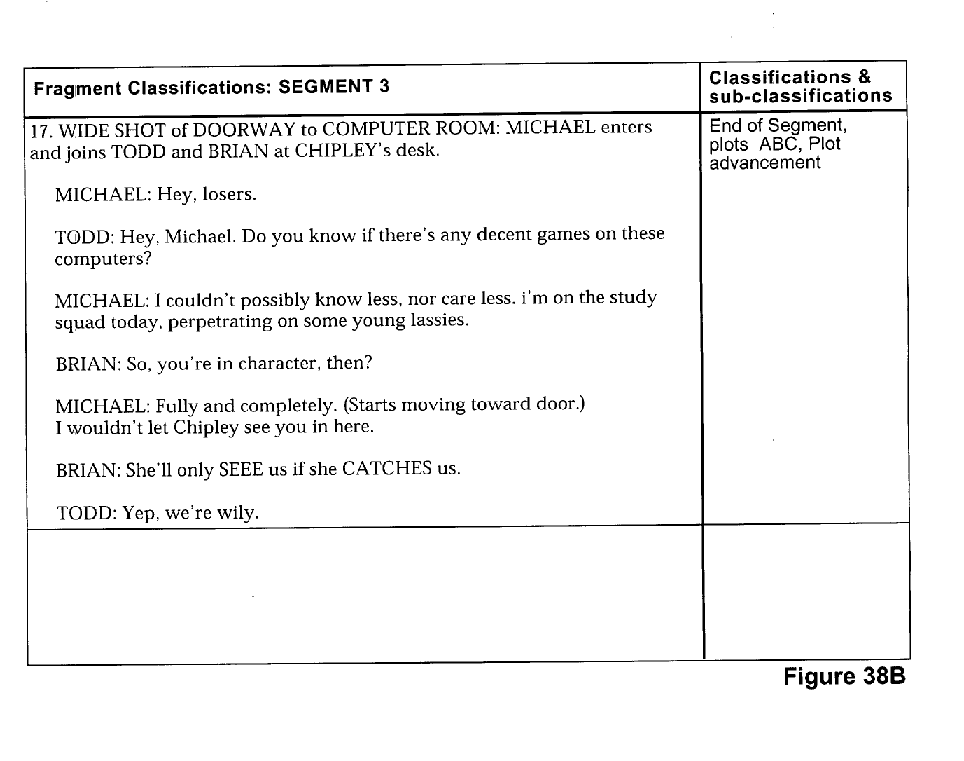

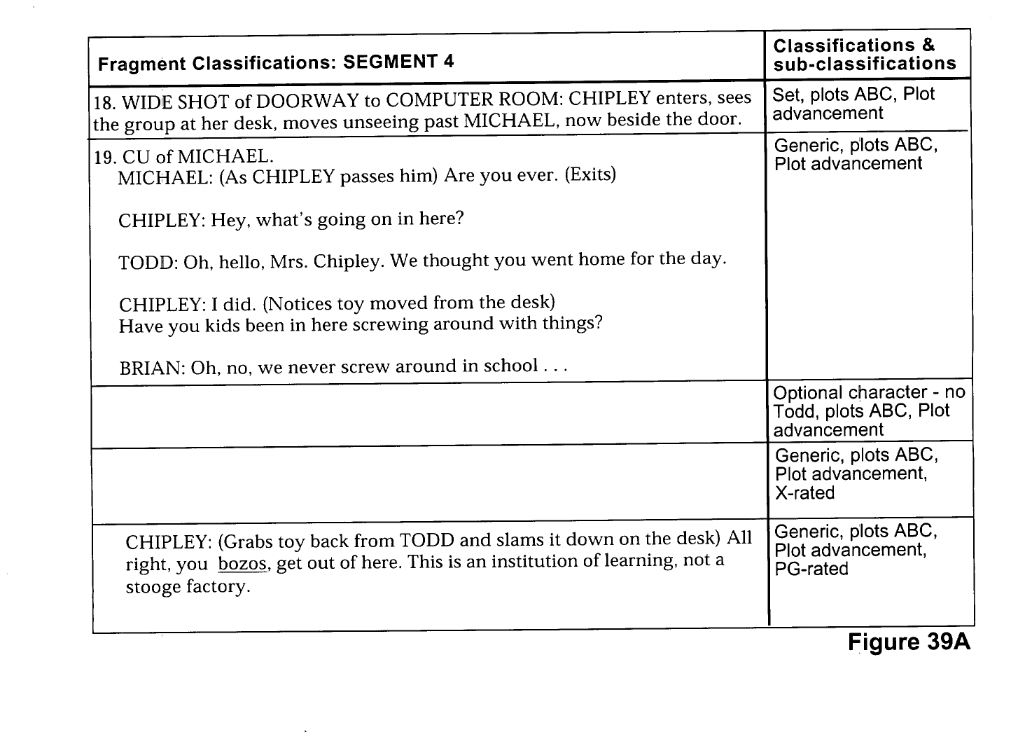

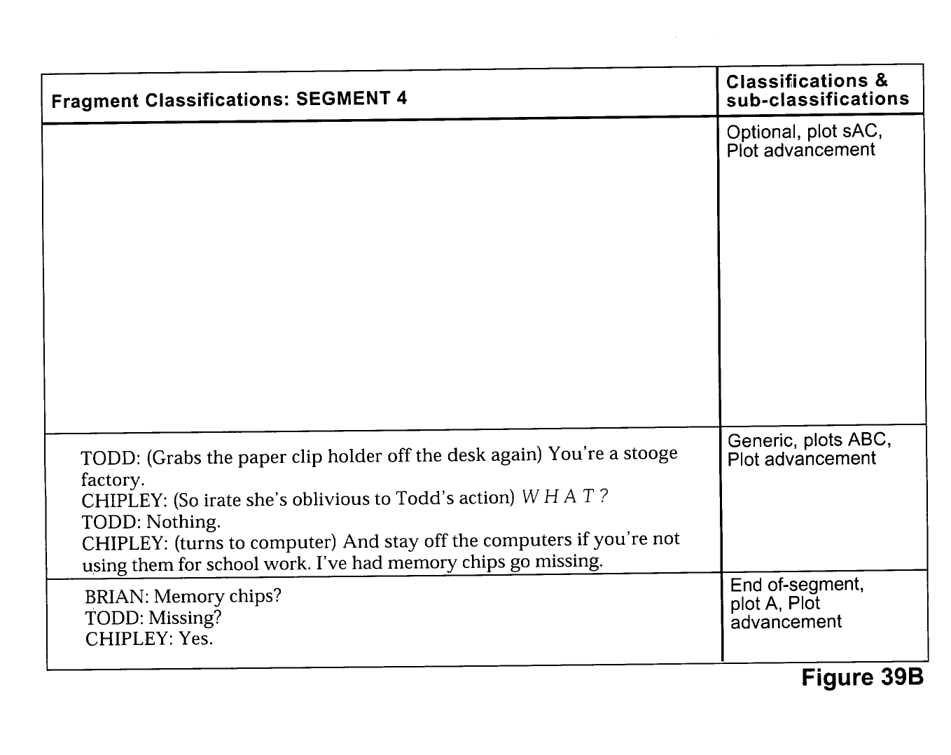

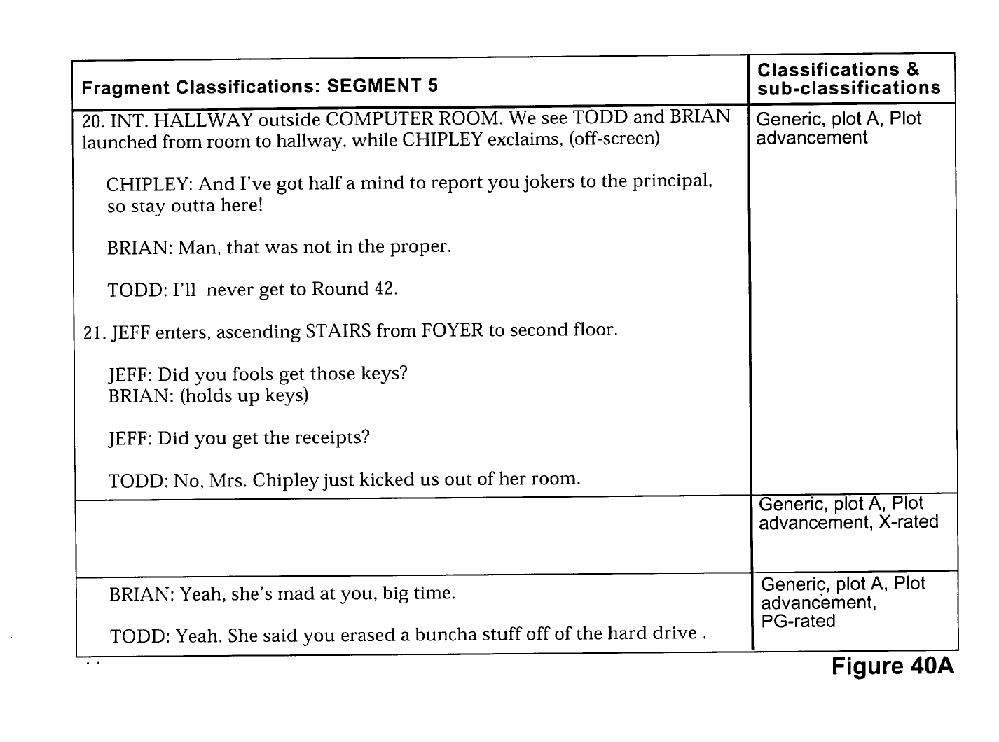

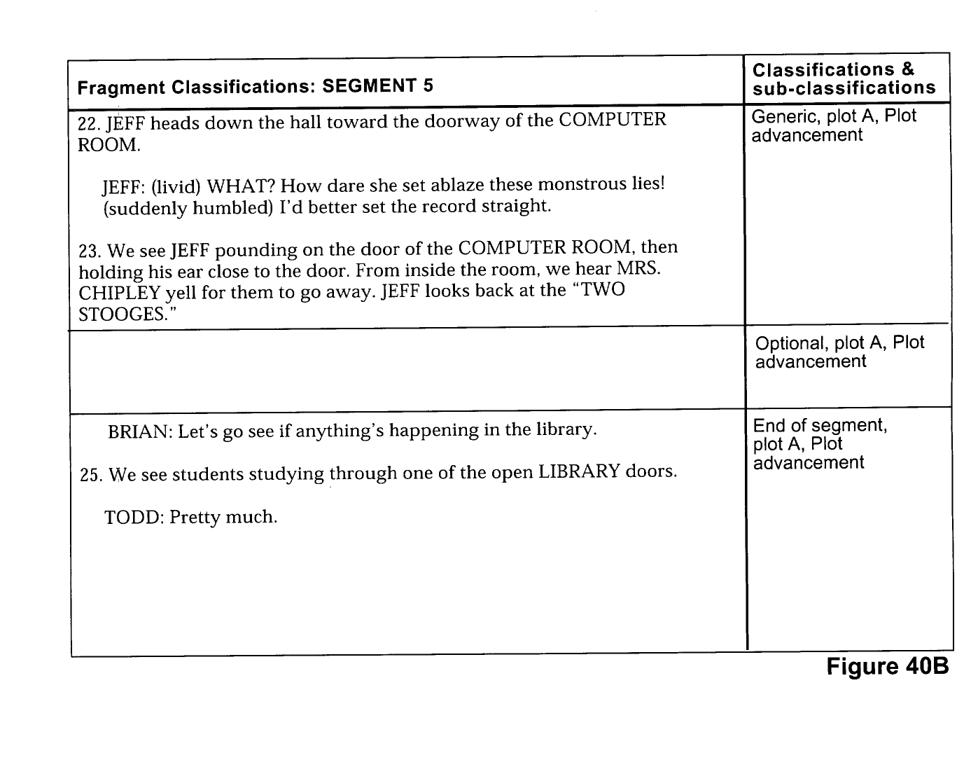

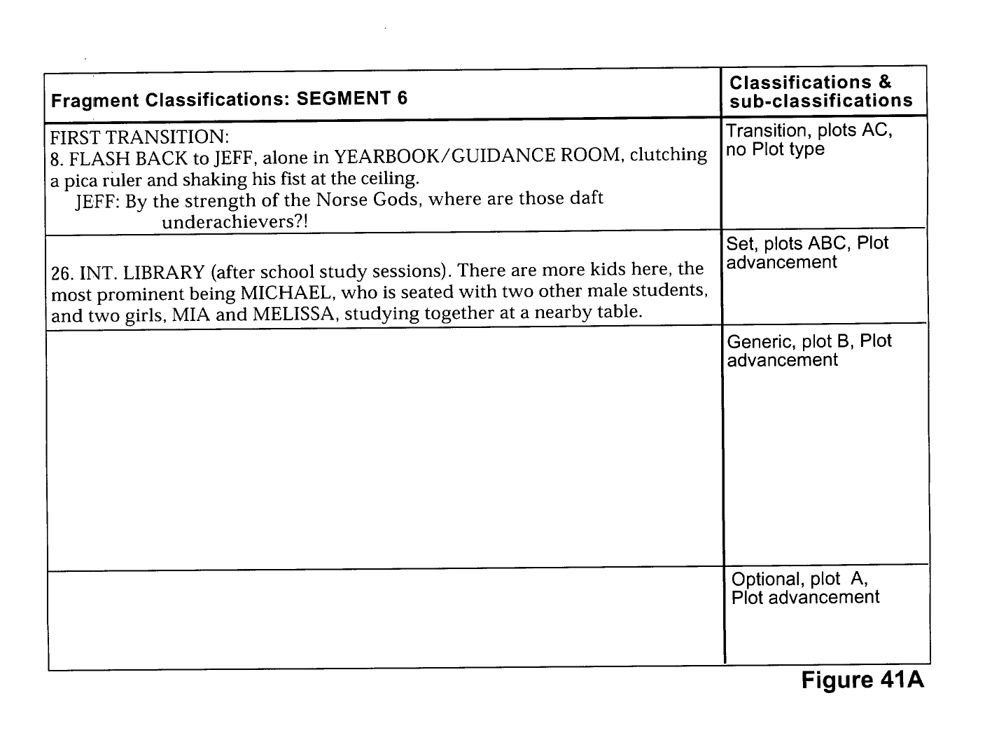

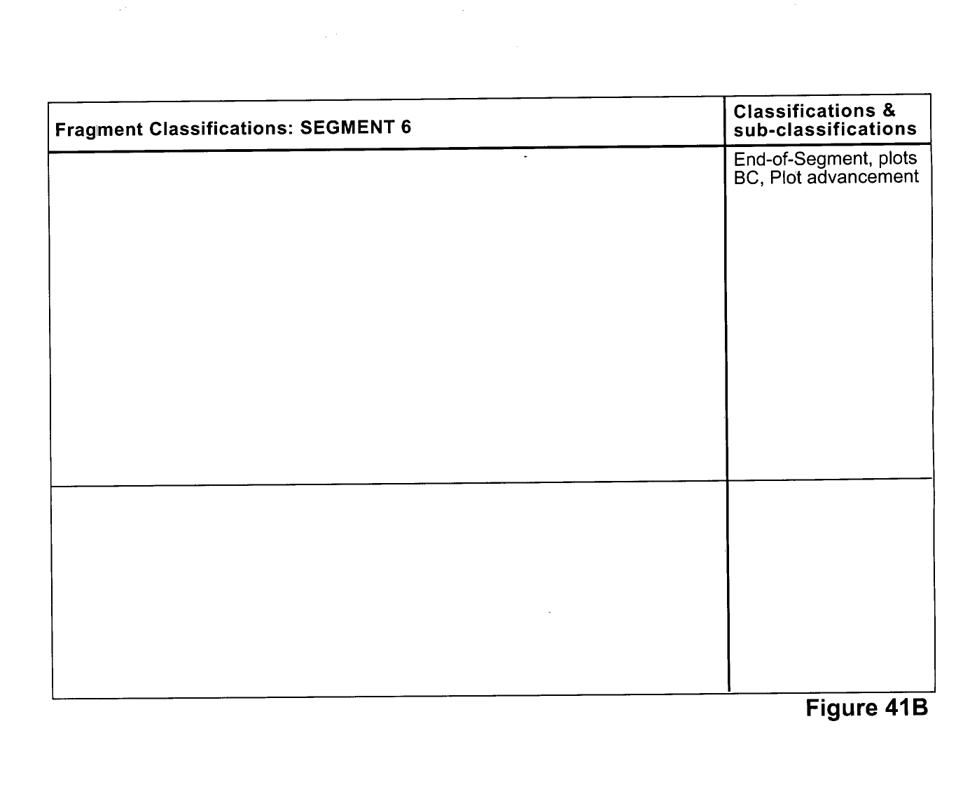

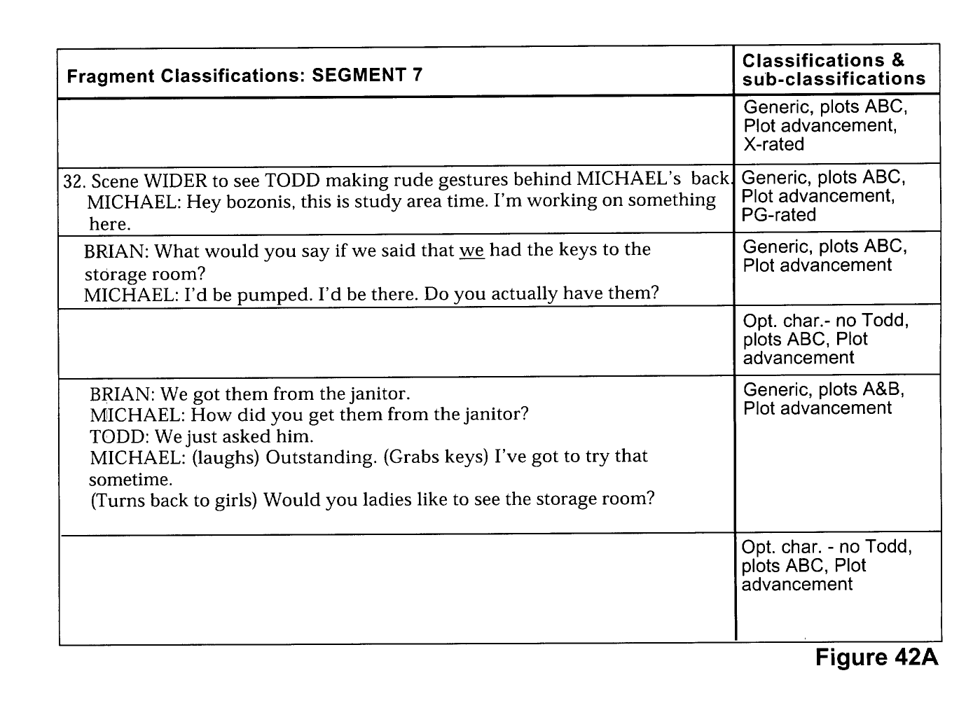

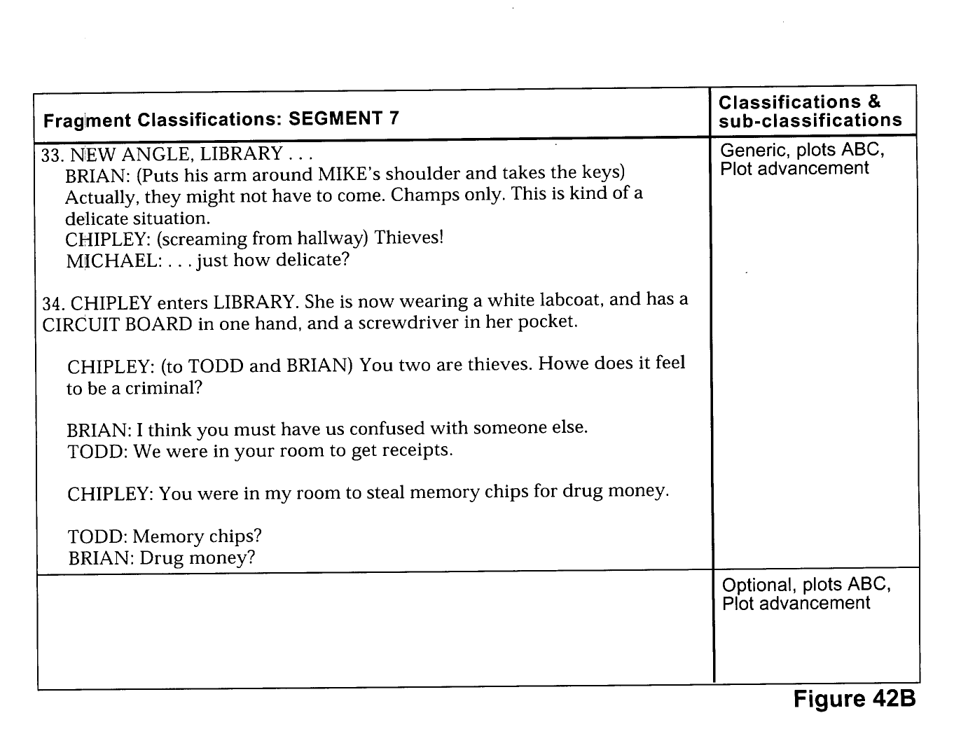

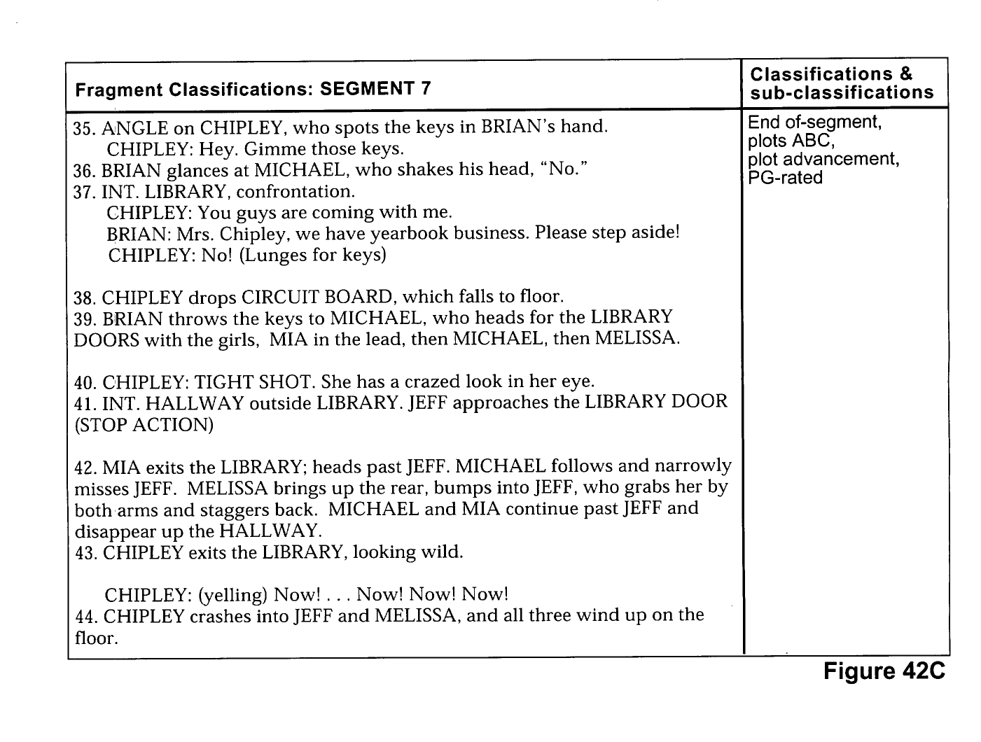

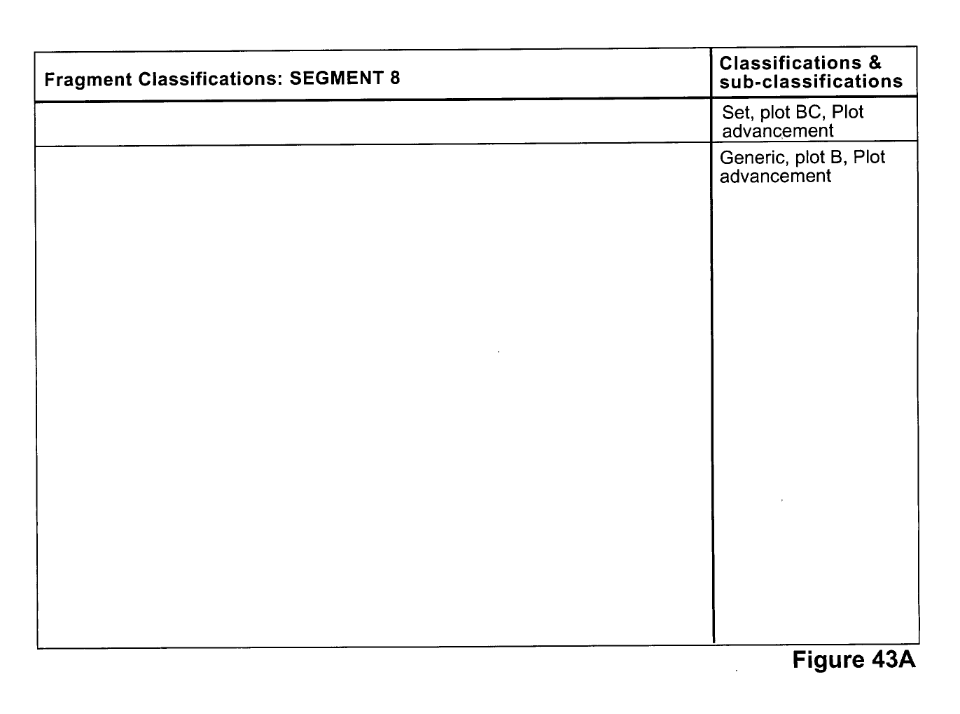

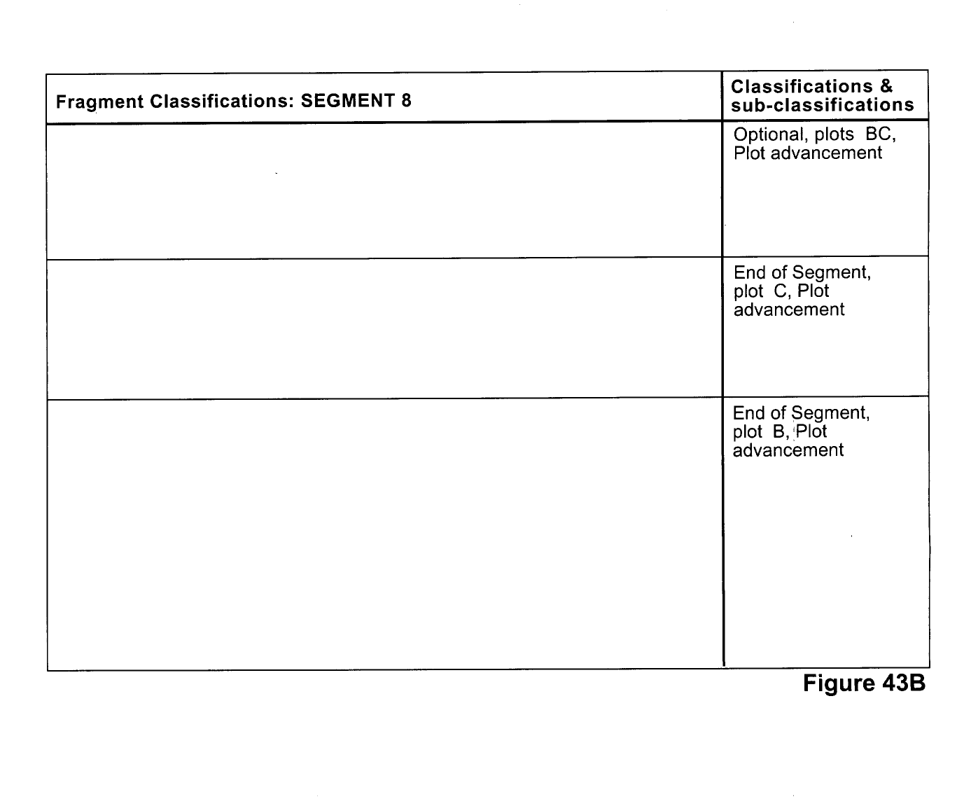

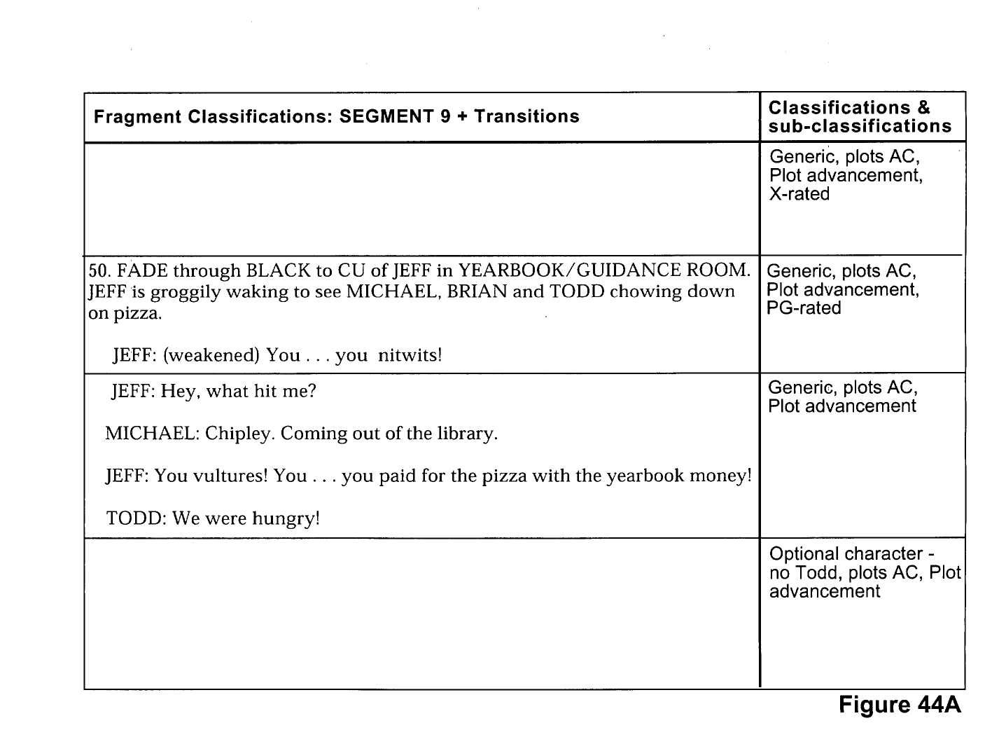

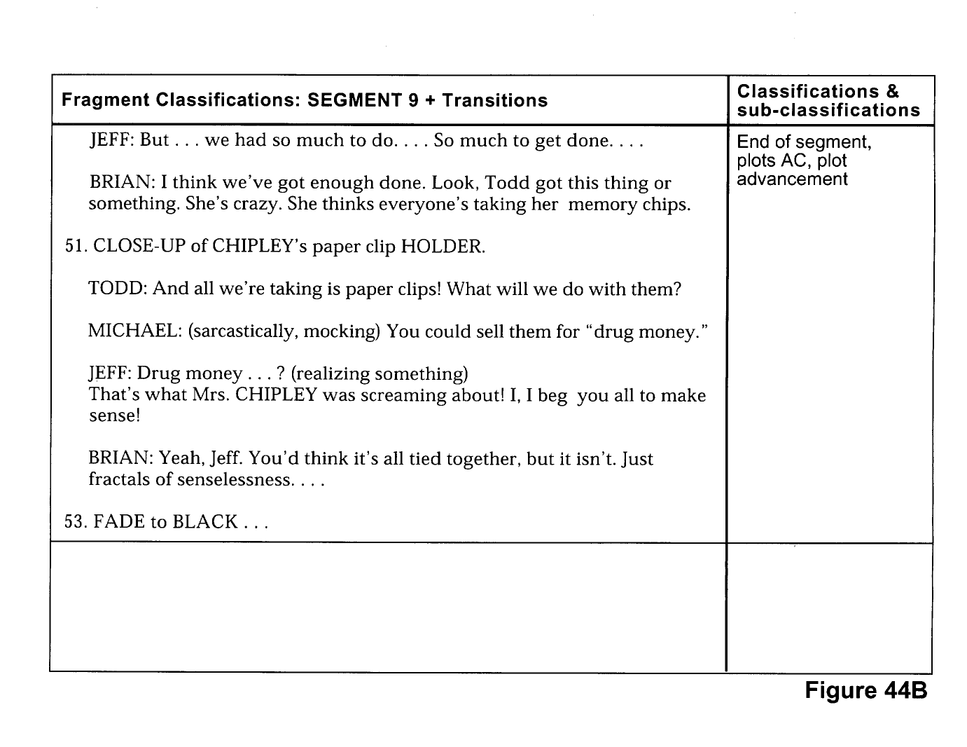

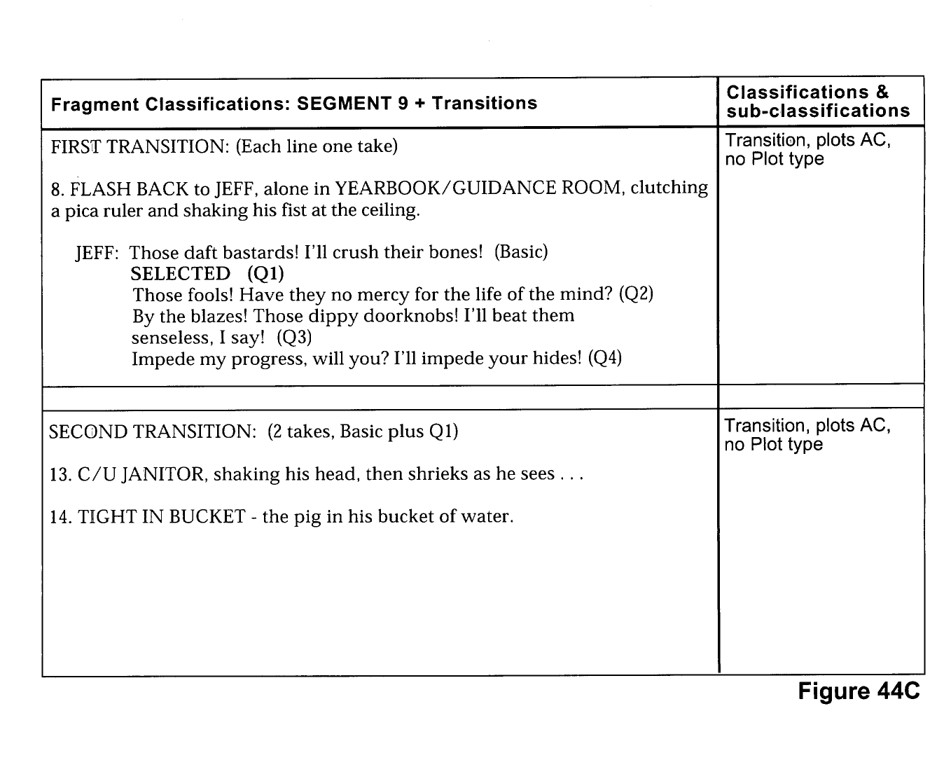

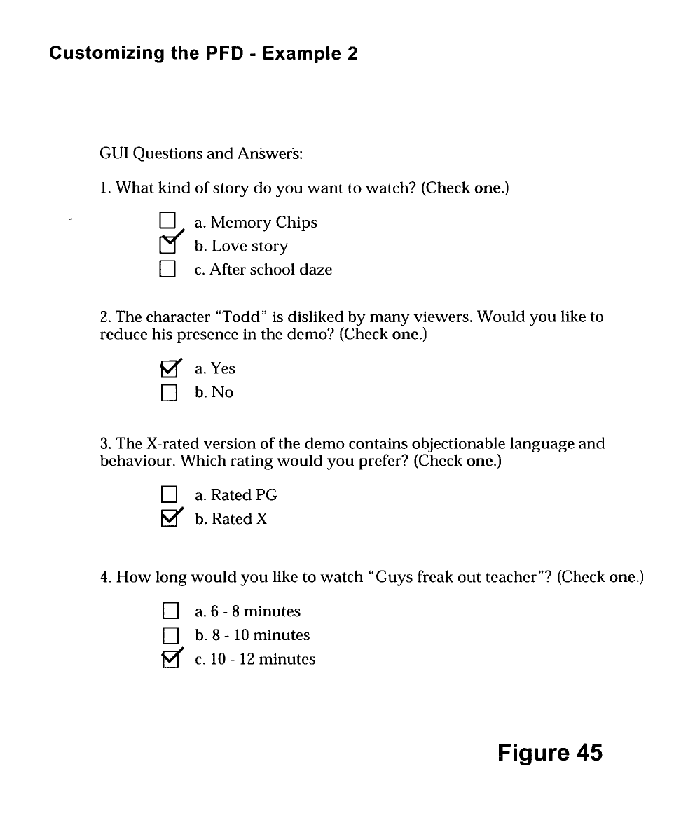

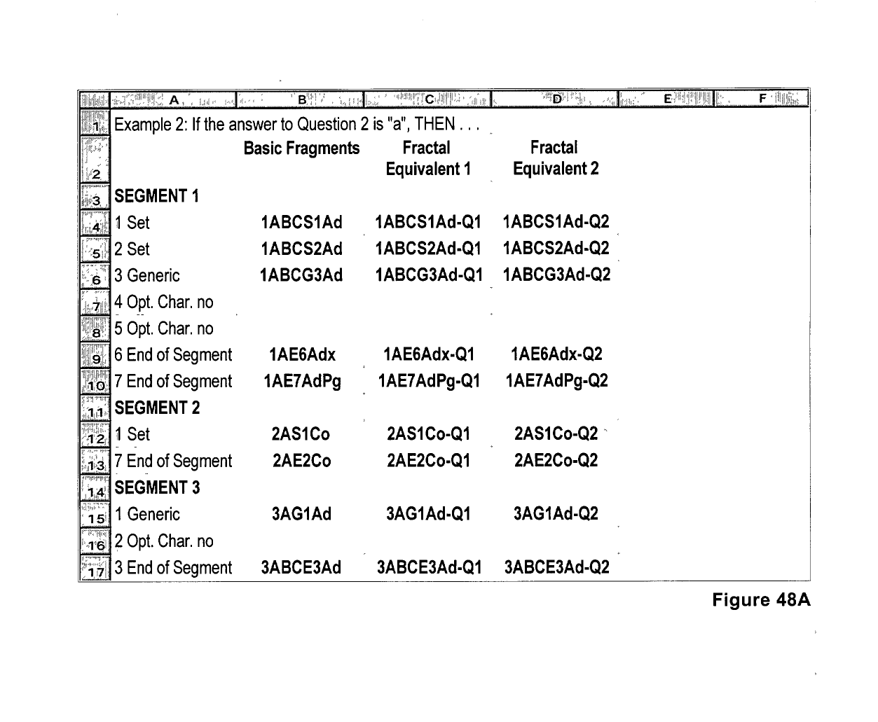

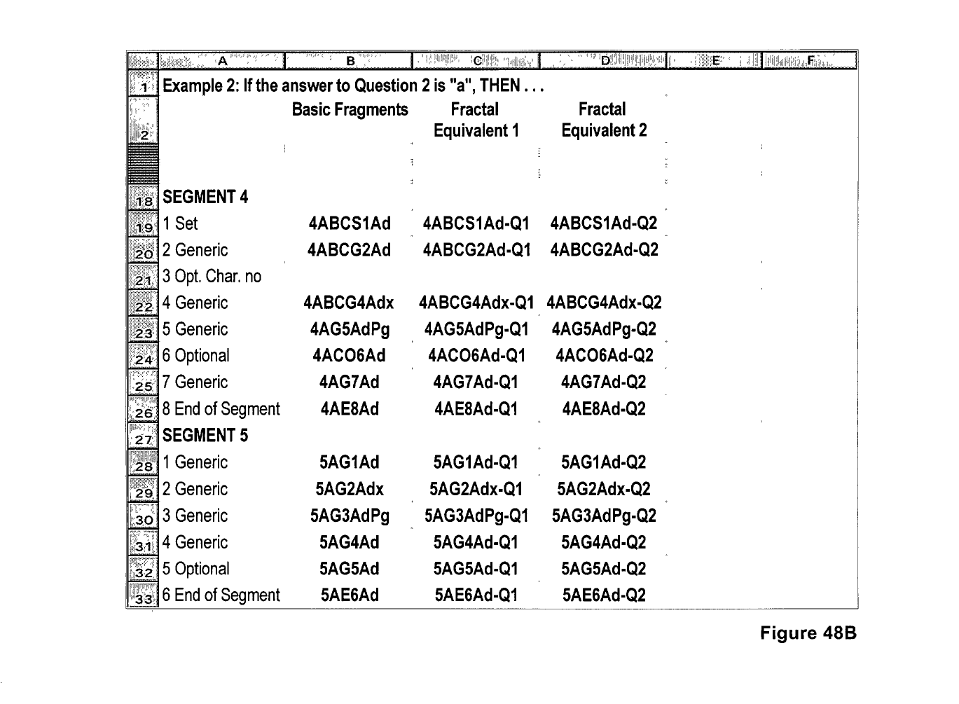

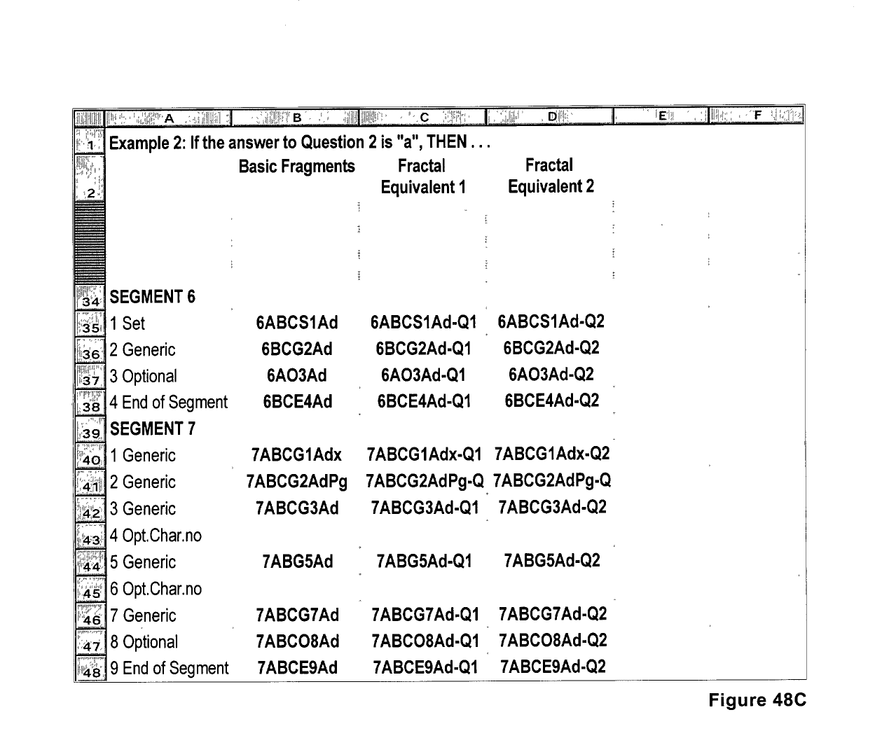

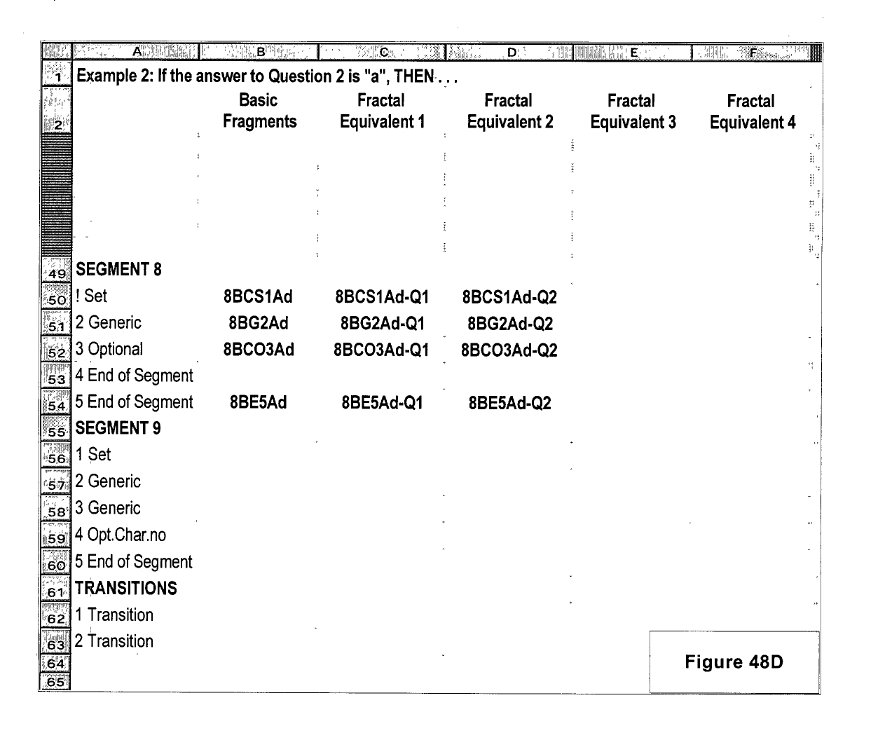

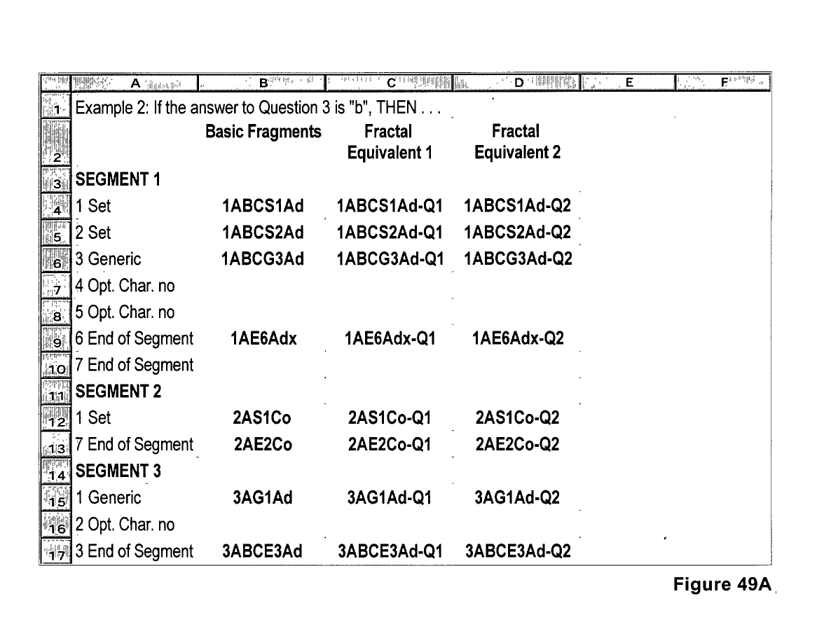

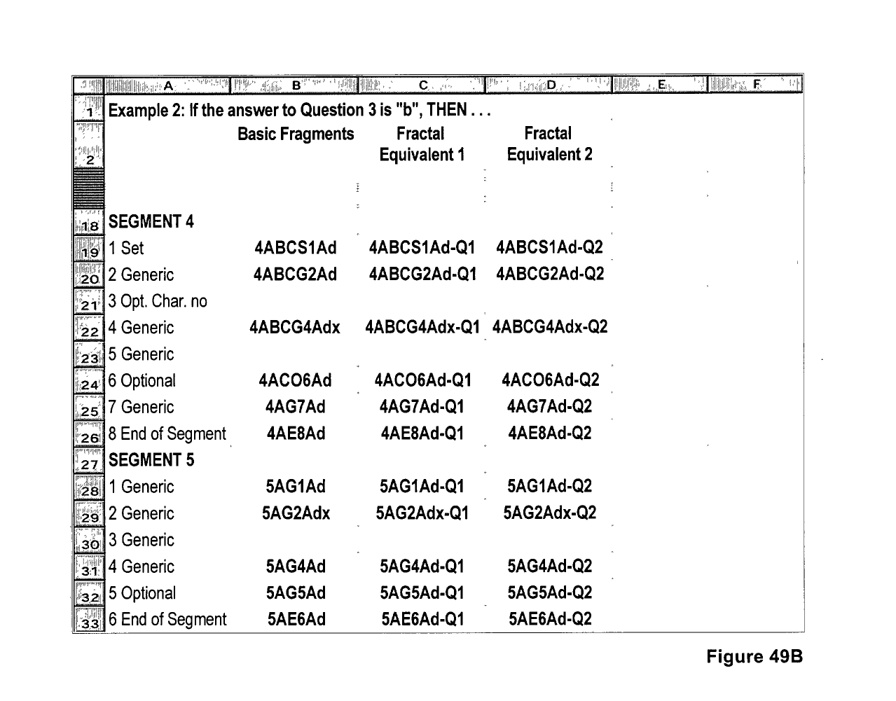

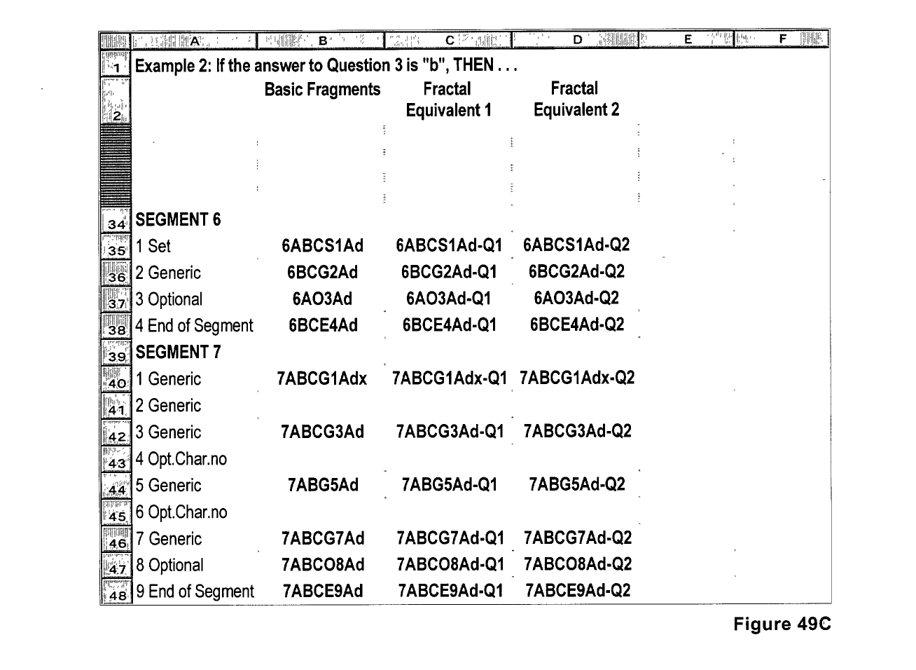

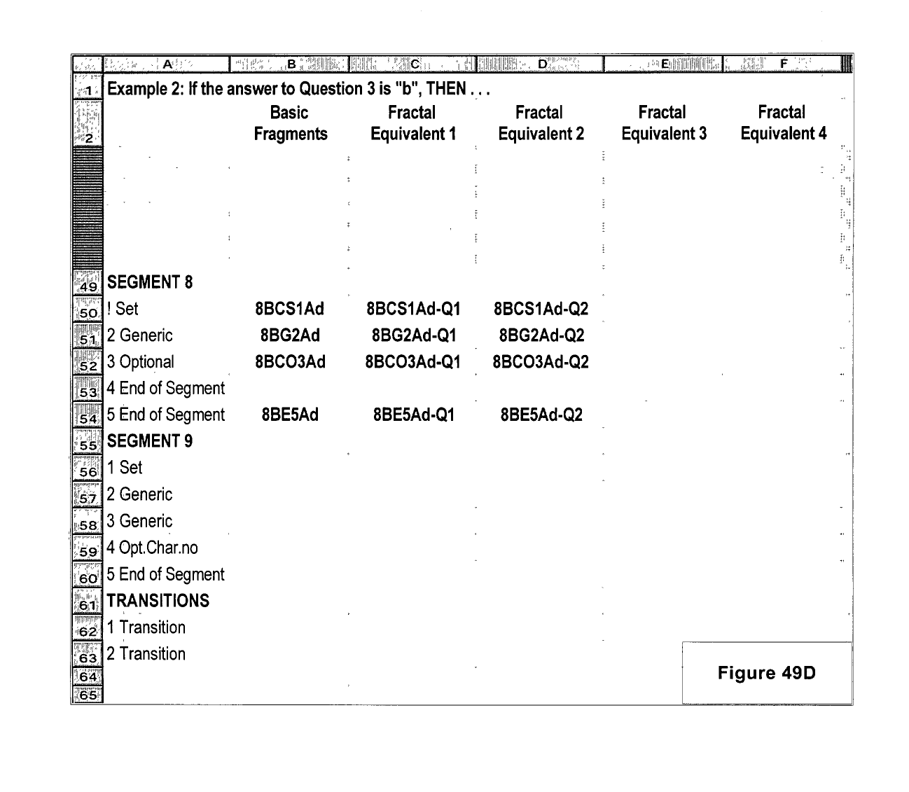

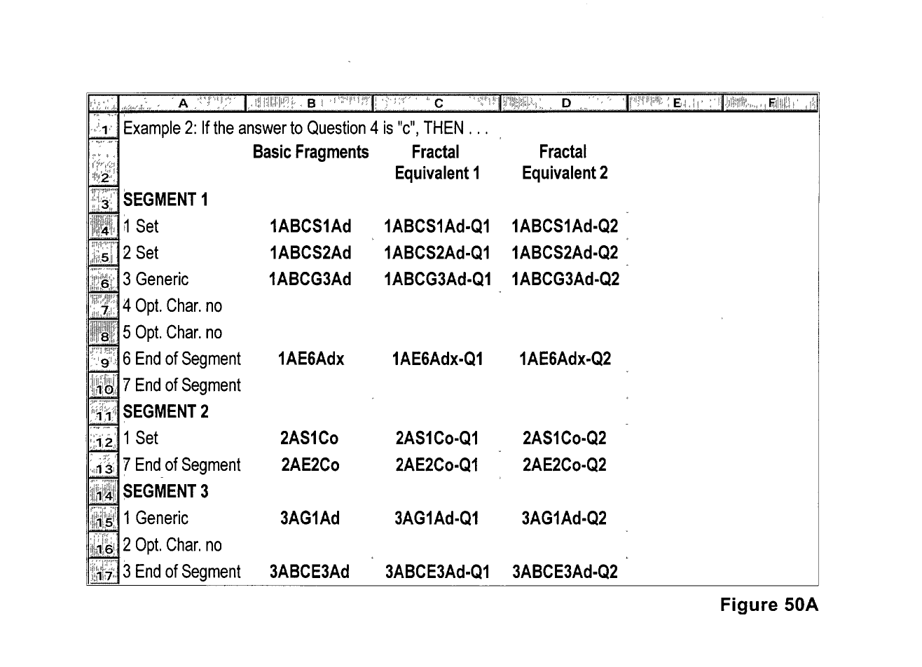

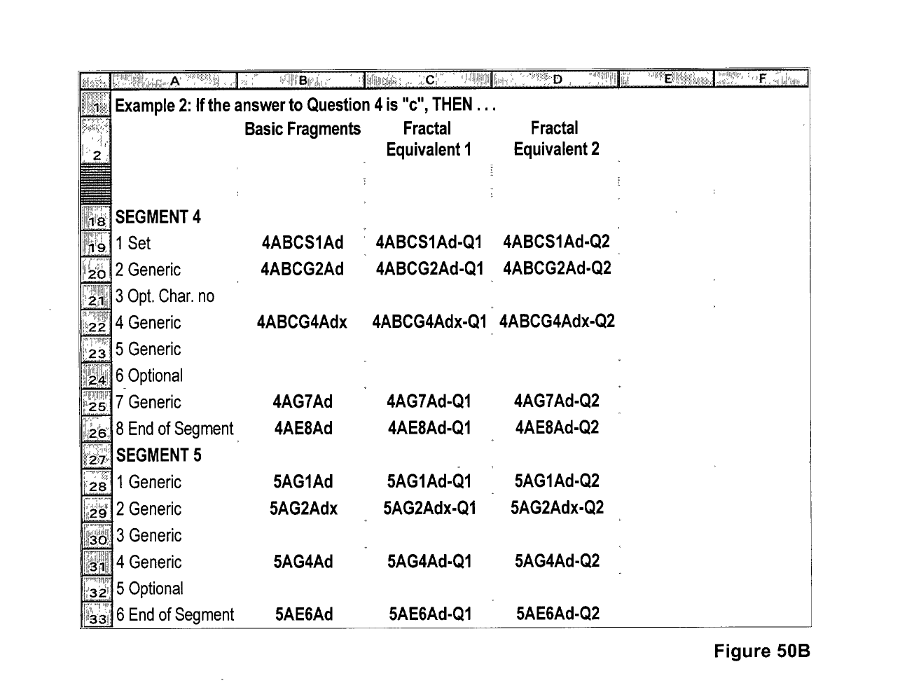

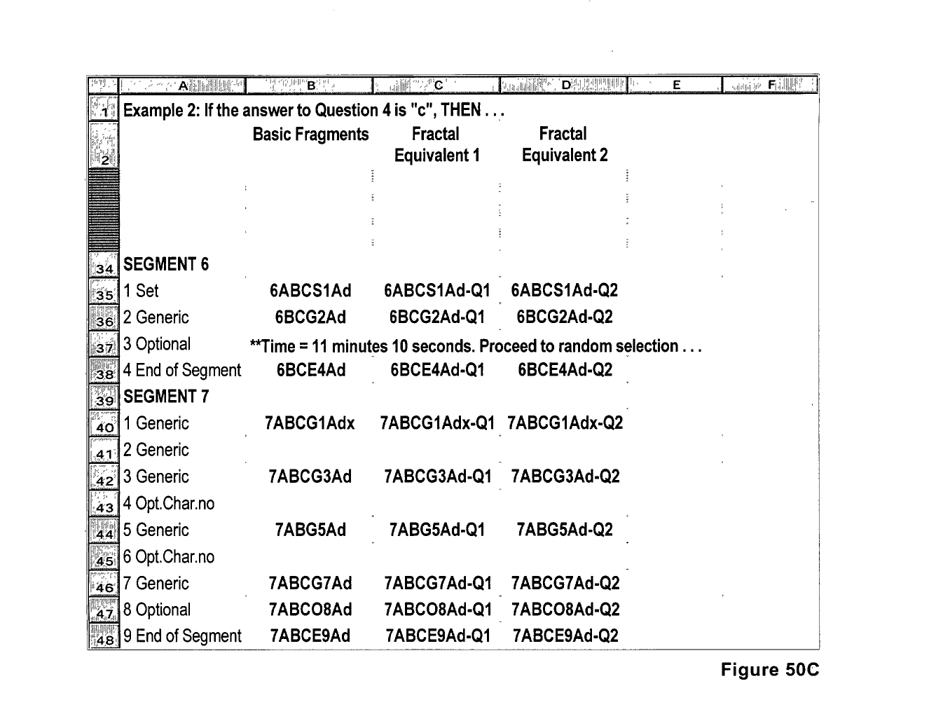

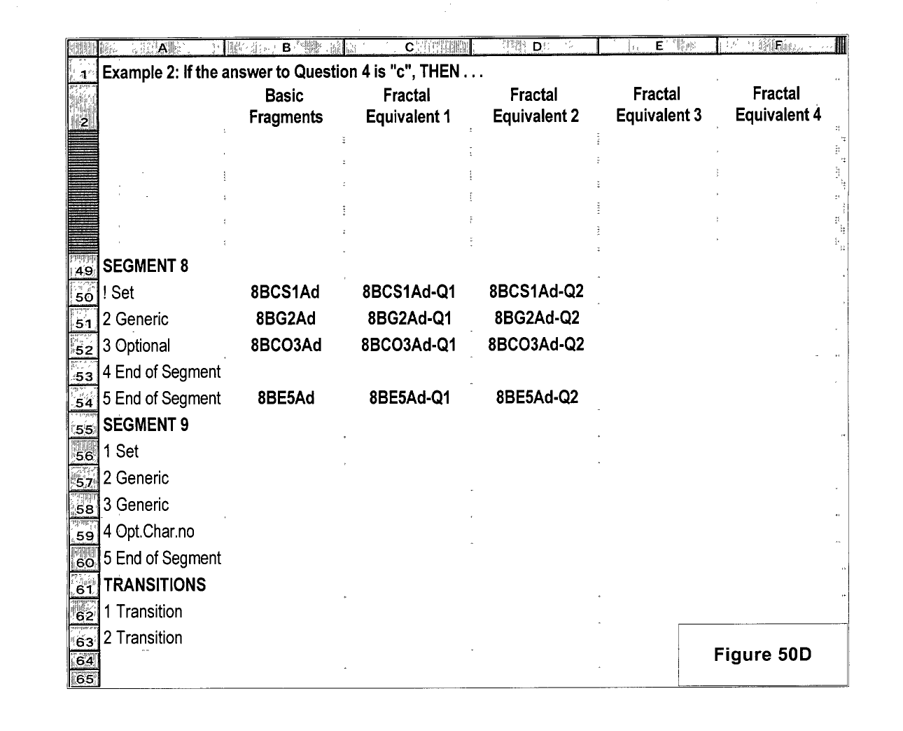

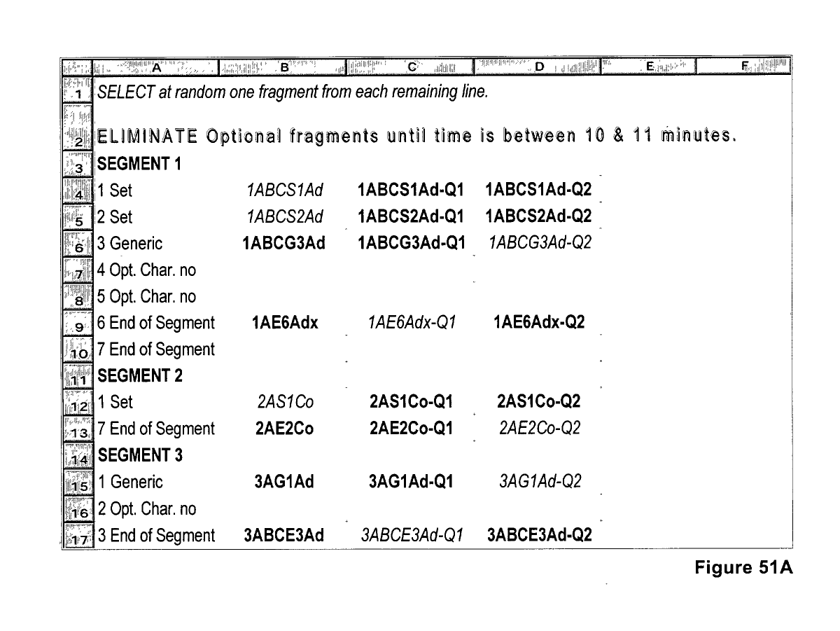

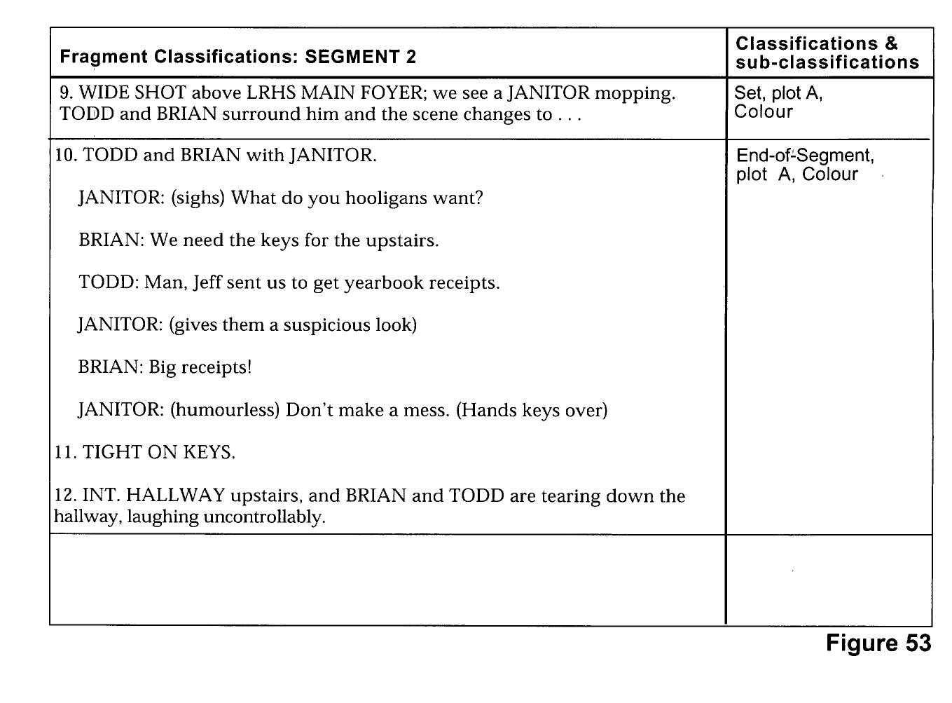

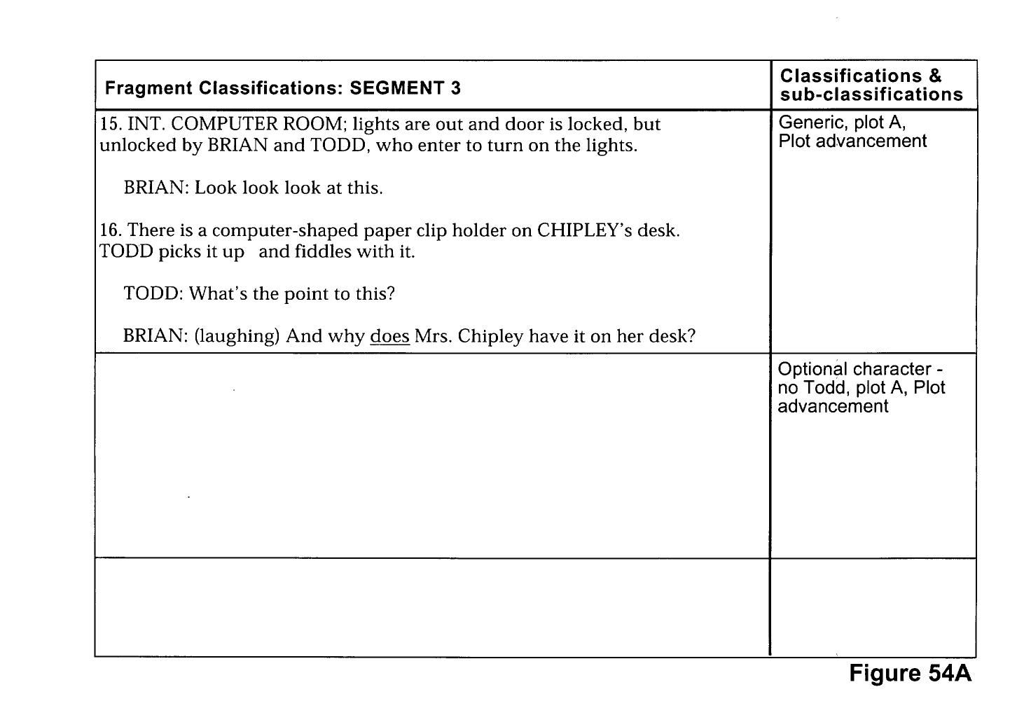

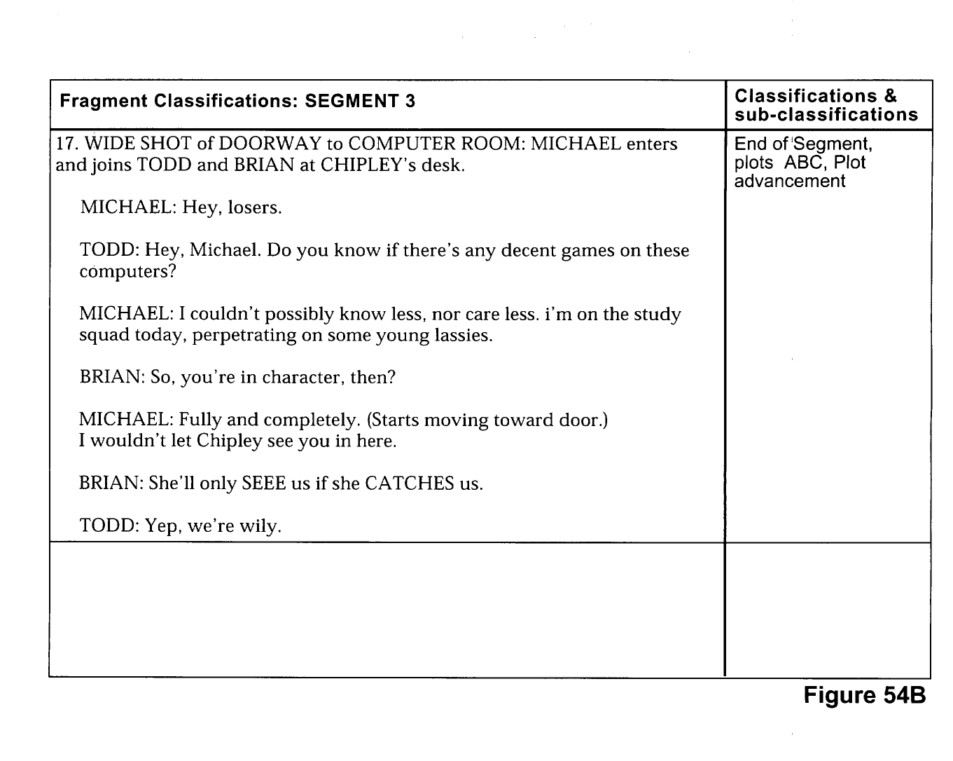

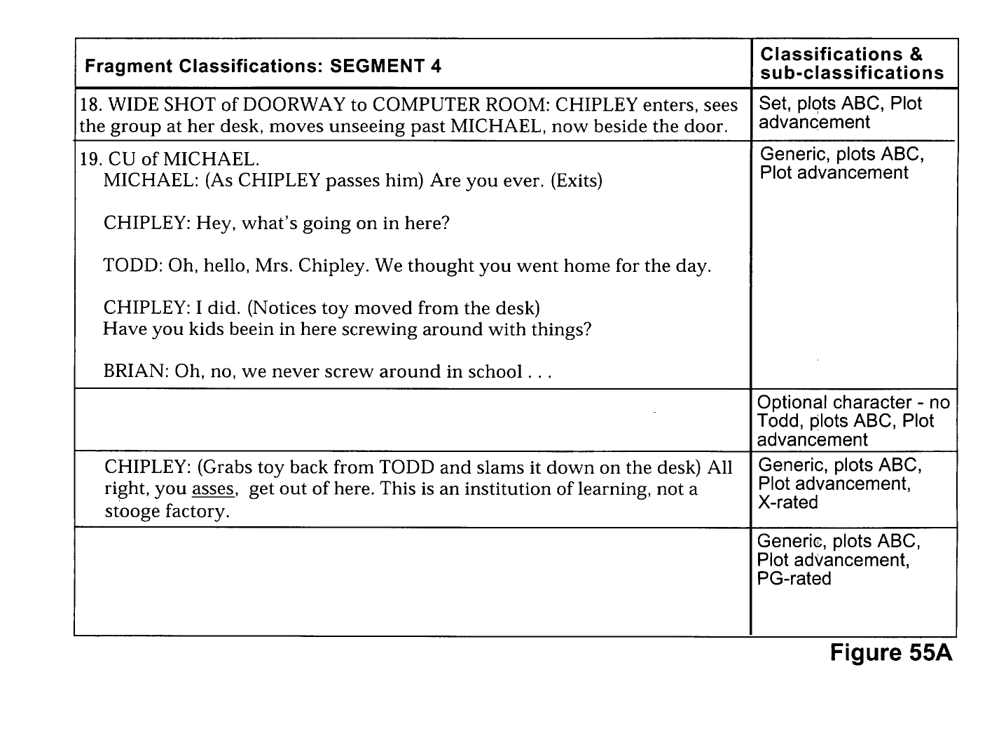

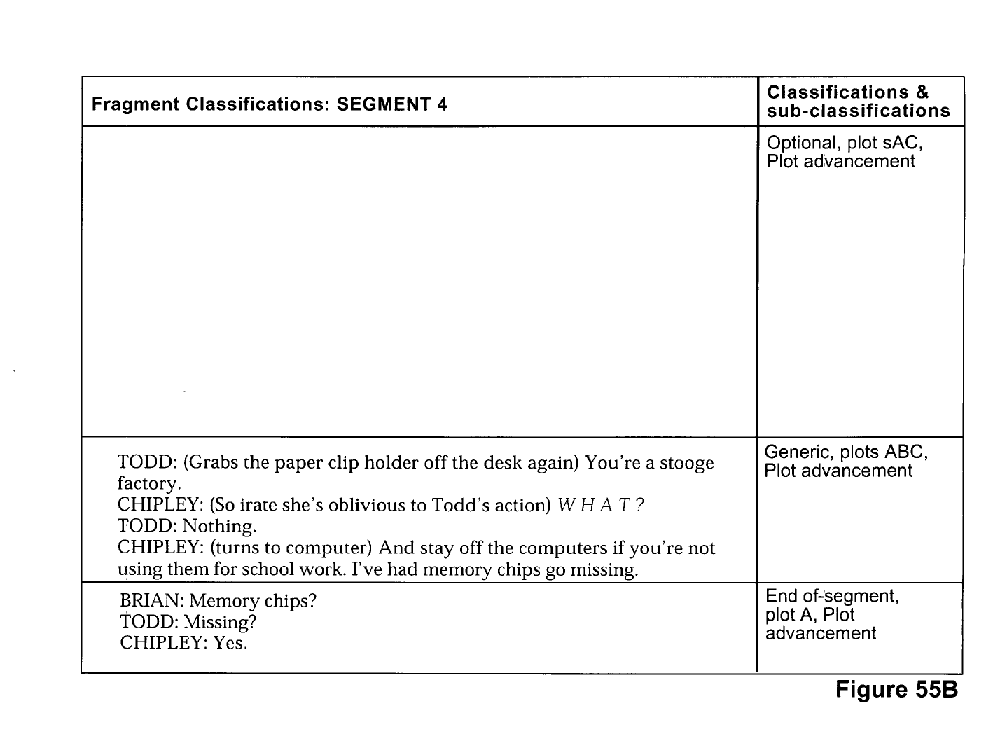

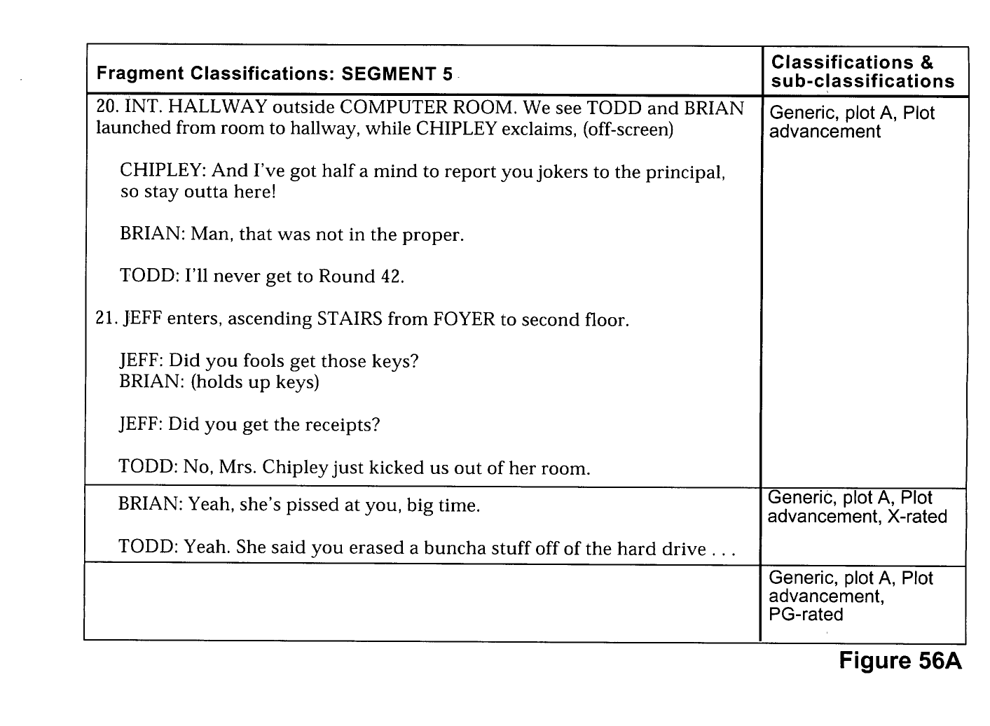

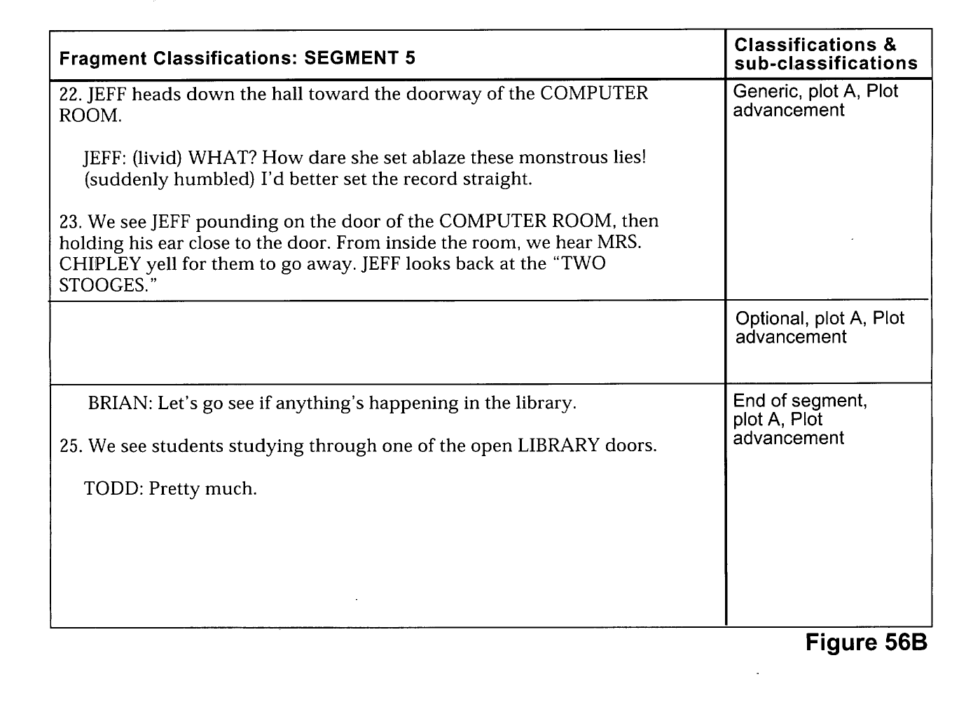

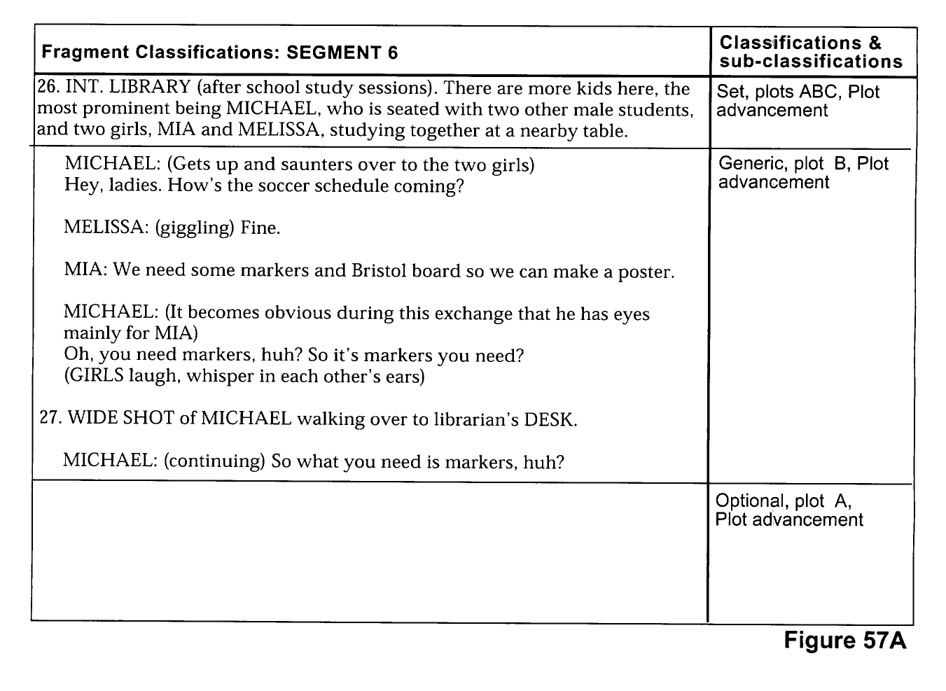

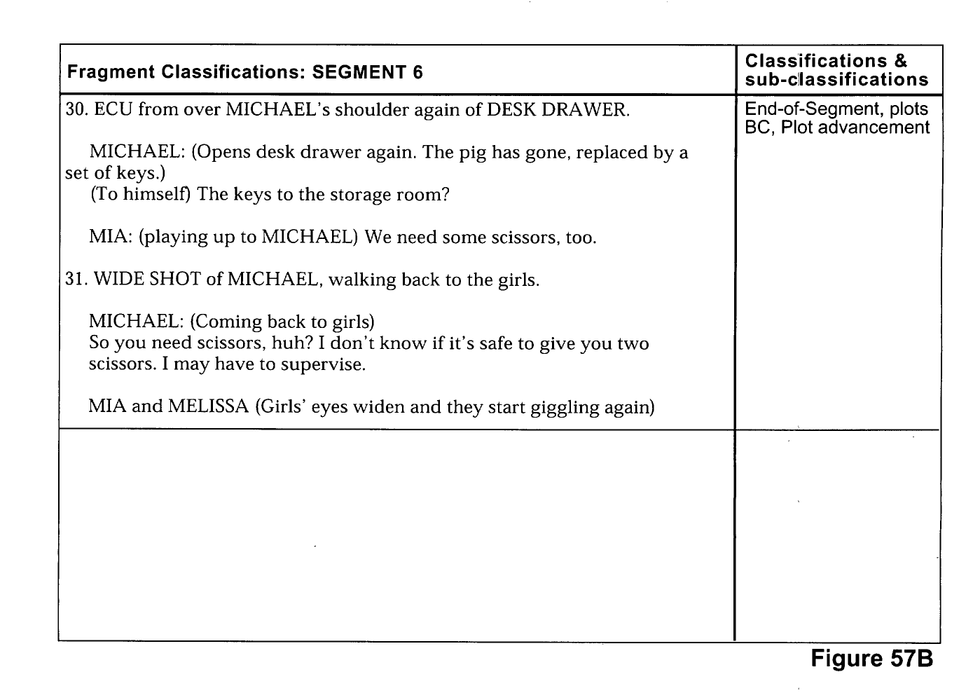

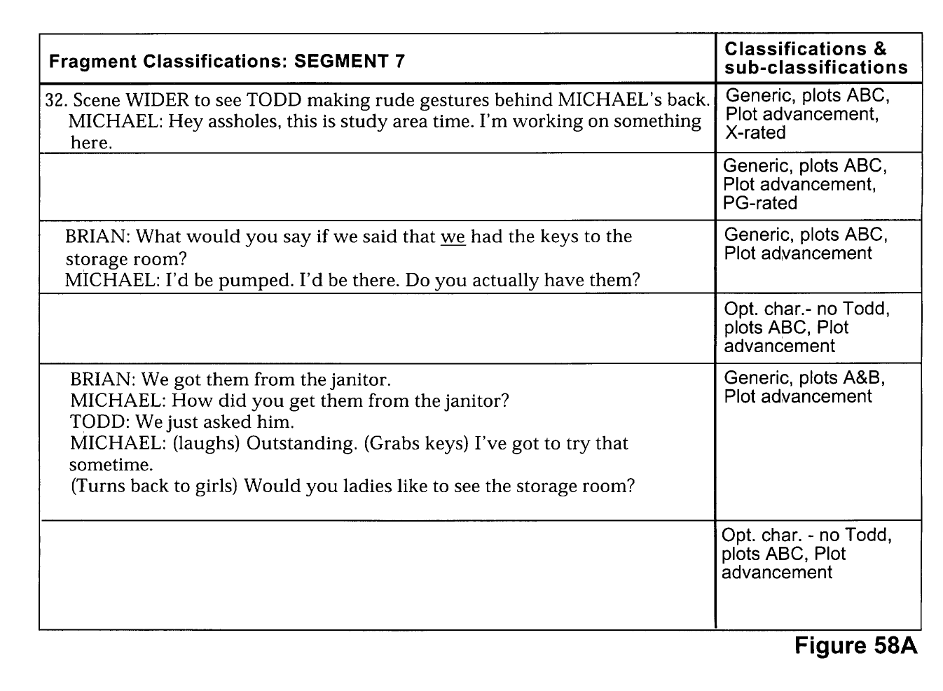

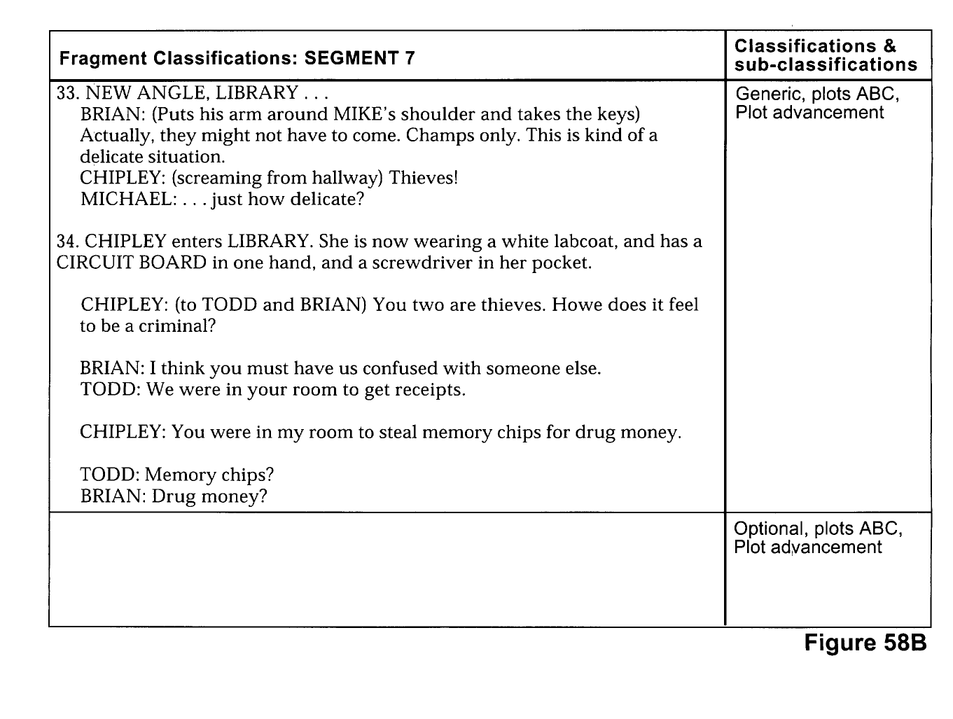

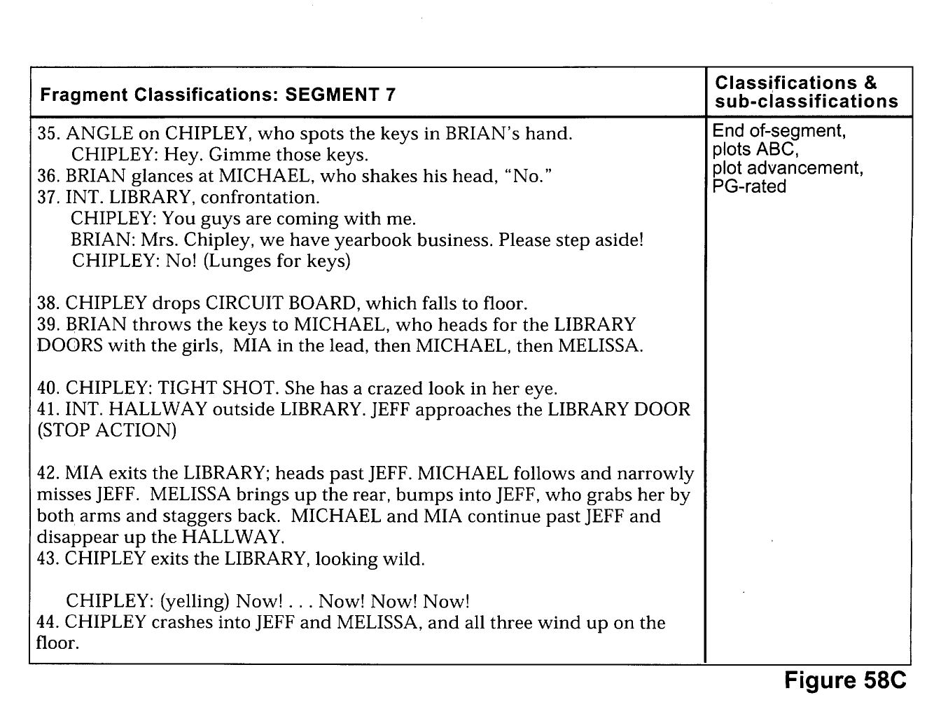

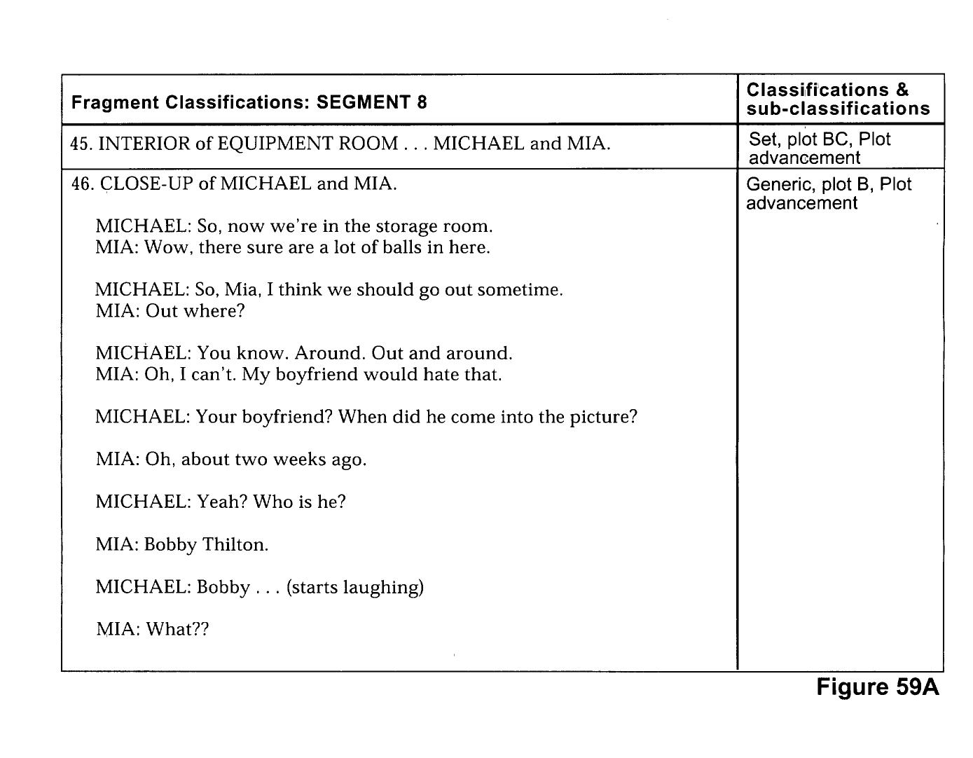

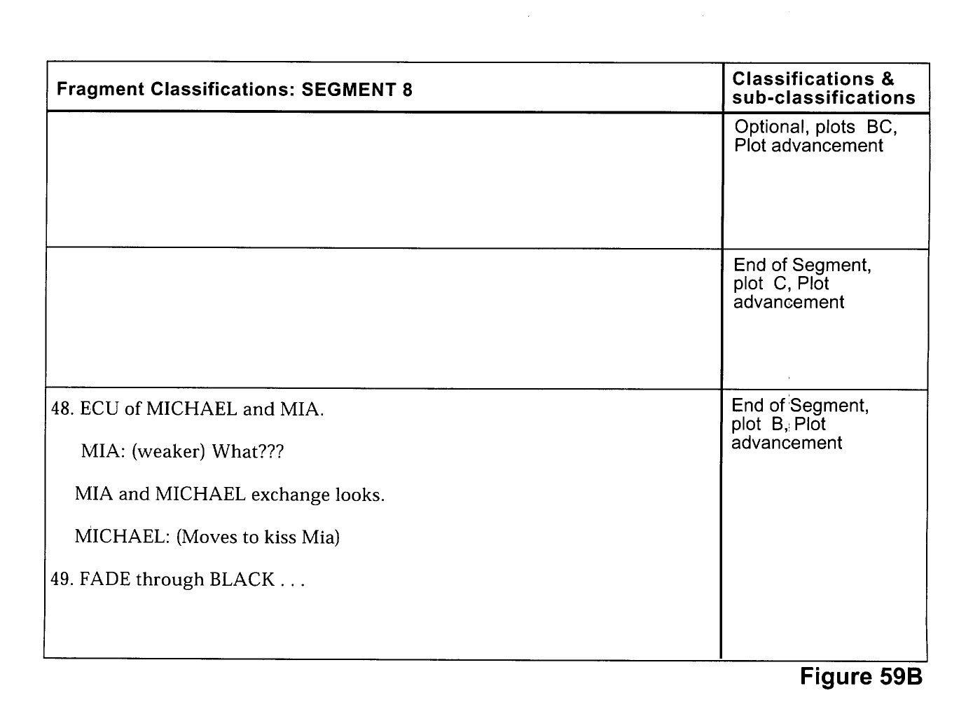

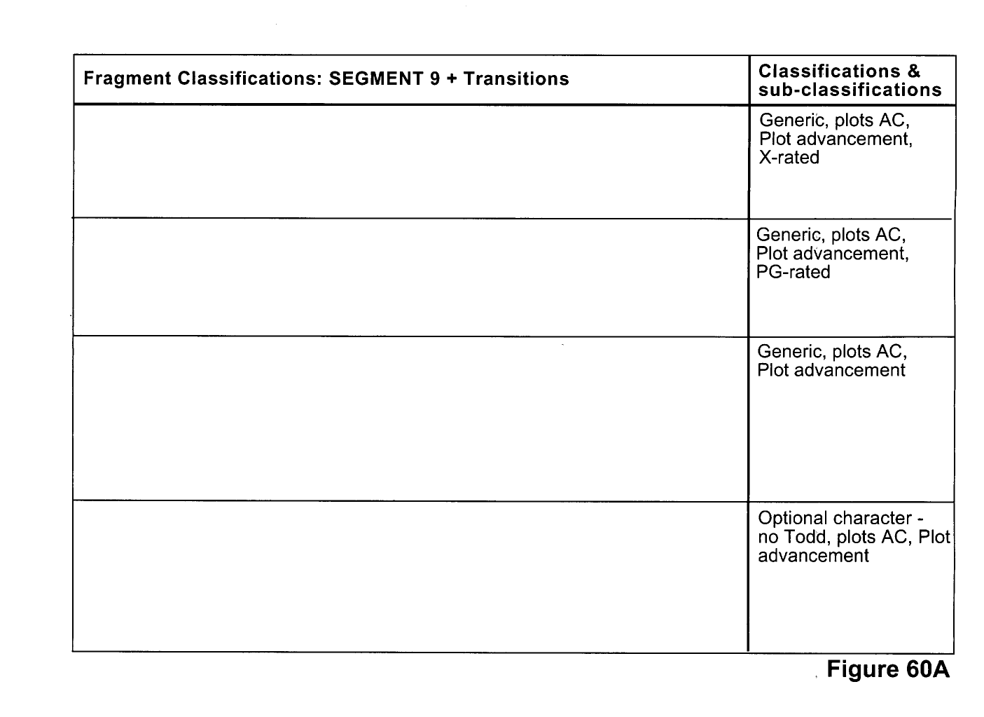

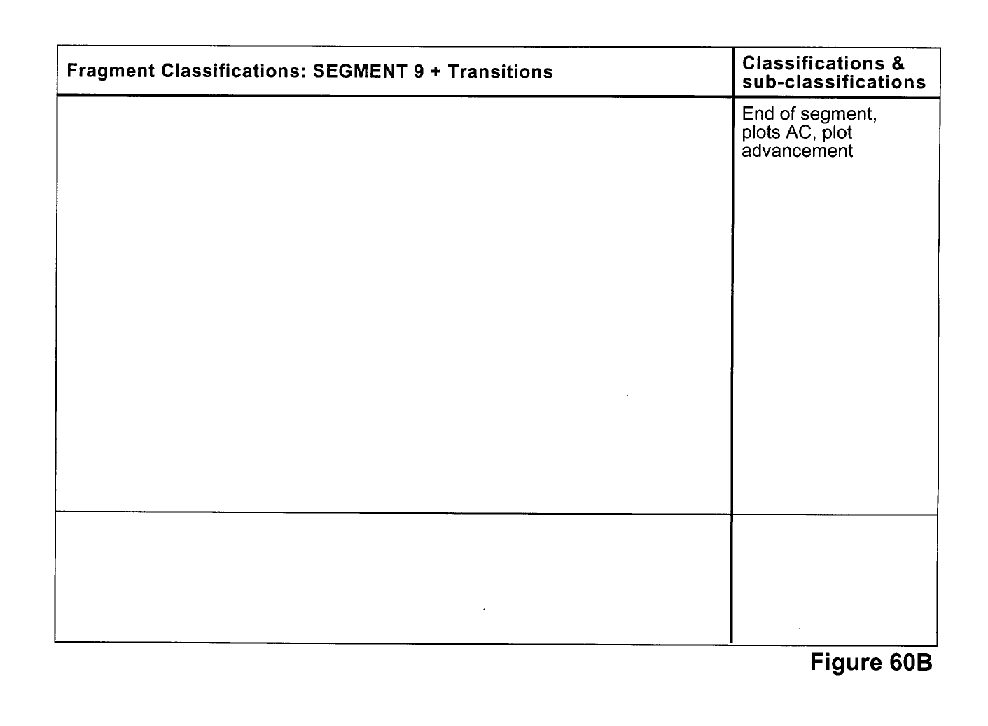

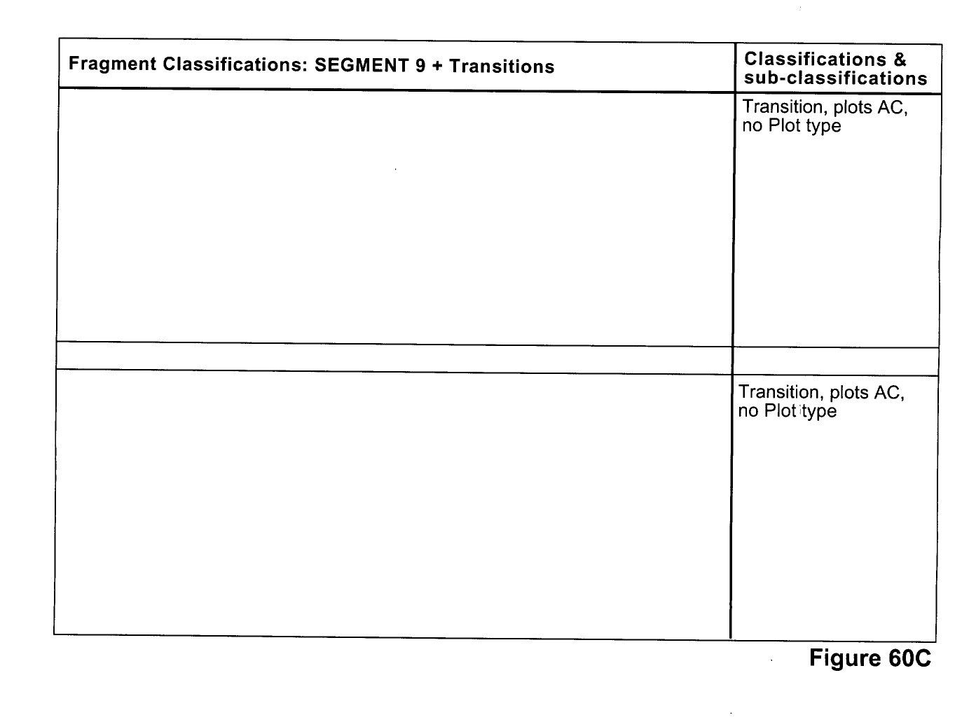

To illustrate the process of creating an RDM movie, a demonstration video was created with a very limited budget, and using amateur actors and crew. The shooting ratio was only about 3:1 for easy scenes, higher for more difficult ones. The pro forma demo (PFD) provided in FIGS. 10A to 60C are a text version of the demonstration video which projects how the PFD may be organized into a FRCA system for RDM content. The demonstration video itself is somewhat longer and slightly more complex than the PFD.

The following are general steps involved in creating an RDM movie:

1. A content producer chooses a work upon which to base an RDM movie.

2. A scriptmaster and technical advisor begin the process of turning the work into an RDM movie. The scriptmaster may have production experience in a variety of program fields such as drama, music, variety, documentary, etc. The technical advisor may have an understanding of computer science and mathematics. Alternatively, the same person may perform the tasks of the content producer, scriptmaster and technical advisor with little or no expertise.

3. The work is parsed to determine the number and nature of component parts which the content producer wants to customize. These may include but are not in any way limited to: plots, sub-plots, characters, events, mood, interactivity, vocabulary and location.

Determination of the number of component parts may depend on practical criteria such as the producer's technical, creative and financial resources. The stronger those resources are, the greater the ability to handle a high level of detail, or complexity. Each level of detail adds to the cost of producing the work, although these additional costs are mainly in the less expensive pre- and post-production phases. The greater the number and smaller the size of the digital fragments 200, the greater the level of complexity available to the system.

Determination of the nature of component parts may depend on literary criteria based on the building blocks of narrative, such as plot, character, themes and description, or, in the case of non-fiction RDM content, elements such as subjects, references (i.e., people quoted), themes and description. In one example of an embodiment of the present invention, the original work on which a feature film is to be based is parsed into the following components:

CHARACTERS:

Principal characters

Supporting characters

Minor characters

Peripheral characters

Cameos & extras

ELEMENTS:

Character Elements

Location Elements

EVENTS:

Plot Advancement Events

Character Development Events

Colour Events

LOCATIONS:

Arenas

Major locations

Minor locations

(For example, arenas are the designation of an environment such as “town” or “school”. A major location in town arena might be a restaurant where characters often gather; whereas a minor location in town might be a small store that characters visit only once or twice.)

MISCELLANEOUS:

Dialogue

Music

Products

Not all components will necessarily be a factor when converting the work to RDM. However, parsing reveals the level of detail available, in addition to defining the degree to which components are essential to preserving the narrative integrity of the original work. It also helps the scriptmaster and technical advisor analyse the original as a system of fragments 200, instead of as a seamless whole.

4. The component parts are further divided into fragments 200 which are assigned classifications. If the work is particularly complex, sub-classifications and classification groupings may be identified to optimize the functionality of the system.

The component parts are used, in the case of RDM movies and television, as the basis for screenplays. Two main criteria for deciding which components should be discarded at this point, and which should be kept, include (i) the degree to which the components are essential to maintain the narrative integrity and quality of the source of the RDM work, and (ii) the creative, financial and technical resources of the content producer.

The screenplay may be divided into fragments 200 using the criteria above, as well as (iii) the number and nature of the options the content producer wishes to offer to users. For visual content, additional classifications will likely arise when the film is edited.

The process of dividing content into fragments 200 is called “fragging”. An individual work of content may be fragged in more than one way. For example, a content producer may licence distribution of a work of content to more than one content provider. The producer could provide the work of content as both a conventional and an RDM work, or the licence agreement may allow content providers to use the basic work and frag it to suit themselves and their target users.

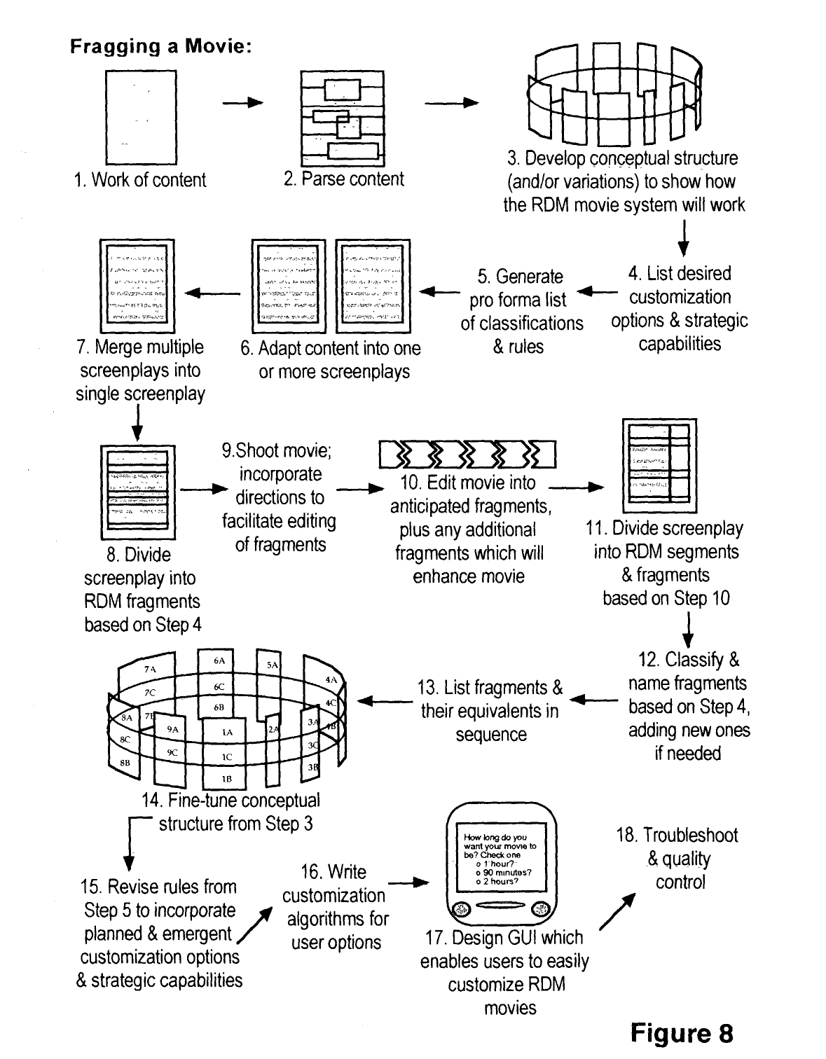

FIG. 8 shows an example of a process of fragging a movie. The process is as follows:

1. Start with a work of content;

2. Parse the work of content;

3. Develop a conceptual structure with variations to show how the RDM movie system is likely to work;

4. List the desired customization options and strategic capabilities;

5. Generate a pro forma list of classifications and rules;

6. Adapt content into one or more screenplays;

7. If there are multiple screenplays, “merge” them into one;

8. Divide the screenplay into RDM fragments based on the lists generated in Step 4;

9. Shoot the movie; incorporate directions to facilitate the editing of the fragments 200;

10. Edit the movie into the anticipated fragments 200 and any useful equivalents 210. During editing, incorporate additional fragments 200 which may not have been listed originally, but which will enhance the RDM movie;

11. Divide a clean copy of the screenplay into RDM segments 204 and fragments 200 based on the edited fragments 200 from Step 10;

12. Proceeding from start to finish of the movie, classify and name the fragments 200 based on the pro forma classifications in Step 4, adding new classifications if required to incorporate the fragments 200 that emerge during the editing process;

13. List the fragments 200 and their equivalents 210 in order, i.e., 1, 1Q1, 1Q2, 1Q3, etc., then 2, 2Q1, 2Q2, 2Q3, etc.;

14. Fine tune the conceptual structure from Step 3;

15. Revise the pro forma system rules from Step 5 to incorporate the original customization options and strategic capabilities, as well as any new options and capabilities that emerge during the editing process;

16. Write customization algorithms for user options;

17. Design a graphical user interface (GUI) which makes it easy for viewers to customize the RDM movie; and

18. Troubleshoot and quality control.

5. The scriptmaster and technical advisor determine the rules of the system, based on the complexity of the work and the number and nature of the classifications. For particularly complex works, conceptual structures are developed to describe the interaction of the fragments with time, when time involves more than the clock to which the linear time parameter set by the user is slaved.

Fragments 200 are the building blocks of the FRCA system, and classifications are the categories of the fragments 200 in the system. Rules describe the limitations on the behaviour of the fragments 200 within the system, and establish the boundaries within which the customization algorithms take place. The rules are determined by the content producer answering questions such as, “What kind of customization options do I want to offer?” and “What needs to be done to make the system work efficiently?” Using a conceptual structure to show the logical and temporal relationships of segments in a FRCA system helps to determine the rules of the system. The basic rules are anticipated early in the process, and fine-tuned once the raw material (the edited fragments 200) is available to be classified and organized into segments 204.

A generic set of rules such as those noted could apply to any number of RDM productions. However, a content producer with good creative, financial and technical resources may want to experiment and develop their own set of rules for more complex productions.

As noted, each work, or series of works of content, is made up of digitalized fragments 200 organized into a nonlinear system. The rules establish the boundaries within which the customization algorithms take place.

The rules for the PFD are as follows:

i. All fragments 200 must have a classification and one or more sub-classifications.

ii. One of the fragment 200 sub-classifications must describe the function of the segment to which it belongs (i.e., Plot Advancement, Character or Colour).

iii. Fragments 200 within segments 204 must have a sub-classification for sequence.

iv. Segments 204 must have a sub-classification for sequence.

v. Two is the maximum number of adjacent fragments 200 which can include music.

vi. The last fragment 204 in a segment 204 must be classified “End of Segment”.

vii. A transition fragment 200 has no segment 204 number and can be inserted at the beginning or end of any segment 204, but not within a segment 204.

viii. Transition fragments 200 are given the segment 204 sub-classification name character “0” (zero).

ix. Each transition fragment 200 may only be used once per download.

x. Basic fragments 200 are closest to the time median of all the fragments 200 in a line.

xi. FEs 210 are ordered from shortest time to longest time.

The above rules may be applied to any RDM production. However, individual content producers might want to adjust these or develop other sets of rules.

The conceptual structures are defined mathematically and may be represented with the use of any basic drawing software. They are mainly a way for content producers to visualize the segments 204 in a system, their logical and temporal relationships, and the possibilities for combining and recombining fragments 200 and segments 204.

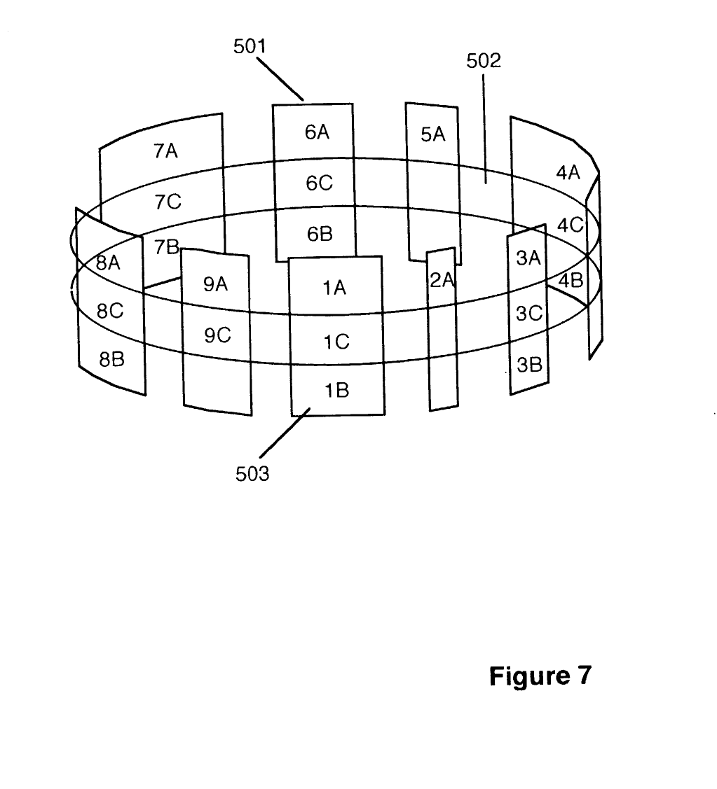

Simple RDM content may not need conceptual structures. Nonetheless, an example is provided for illustrative purposes. Referring to FIG. 7, rectangle 501 represents Segment 6 in the PFD, circular band 502 divides each segment 204 into three parts, and box 503 shows that Segment 1 contains fragments 200 relating to Plot B (“Love Story”). As with the rules shown, the conceptual structure shown could work with any RDM production by adding or subtracting segments and/or grouping them together into scenes. On the other hand, in one example of the present invention, a fairly complex conceptual structure may be developed for an RDM feature movie, to allow for greater flexibility than that provided by the combinatorial possibilities of fragments-within-segments alone.

6. The work may be turned over to one or more screenwriters in collaboration with the scriptmaster, who plays a coordinating role among the writers, the technical advisor, the producer and the director. The scriptmaster marries screenplays together if there is more than one, or adjusts a single screenplay to allow for maximum customization within the parameters set by the content producer. An RDM screenplay will usually be fractionally longer than a traditional screenplay for an equivalent traditional work, allowing for RDM variations.

Individual screenplay: A single screenplay is developed based on the pool of component parts provided by parsing the content work on which an RDM work is to be based. (Sometimes screenplays are generated as stand-alone works, although they are still usually based on an outline or pool of information. If this is not the case, then the screenplay itself would have to be parsed after it was written. The development of the PFD screenplay is described later.) As with conventional screenplays, writers may add material. Each additional plot adds to the potential number of variations. The whole is always greater than the sum of the parts, because each additional plot “borrows” from the original plot(s) and vice versa. This is why it takes little added material to increase the variety of a screenplay. Sometimes a single sentence, word, or even a facial expression or gesture can change the whole meaning of a segment.

Multiple screenplays: These would not be written independently of a prior work of content or outline. Merging screenplays involves separating the different screenplays into segments 204 and comparing each set of segments 204 derived from a common component. Screenplays are merged horizontally and vertically.

For a horizontal merge, the scriptmaster compares the related segments, divides them into fragments 200, and incorporates the most desirable fragments 200 of each one into a single segment 204 (which typically would be larger than any one of its originating segments 204, but less than half the total of all of its originating segments 204). The merged segment 204 is then edited into a final version and its fragments 200 adjusted accordingly. Where a segment 204 in one screenplay has no counterpart, the scriptmaster will choose to incorporate it or exclude it for editorial reasons.

Once all segments 204 are merged individually, the scriptmaster does a vertical merge by looking at the flows of the various plot lines and adjusting the order of the segments 204 to best accommodate all of them. Small additions and adjustments to the screenplay will usually be enough to reintegrate the segments 204 into a common order.

At this point, the preliminary conceptual structure is developed. It can help the technical advisor visualize how the segments 204 of various plots relate to each other, and aid in the development of rules, classifications and algorithms.

7. The RDM movie is shot on digital video or on other media which is subsequently digitalized. The digitalized work is then edited into fragments 200 which match the chosen classifications. All footage which falls within specified qualitative parameters is used. Some fragments 200 will have counterparts which are similar but not identical and these are classified accordingly. Some classifications may be made up of media sequences composed of two or more digital fragments 200.

Classifications describe the basic categories of the fragments 200 in a FRCA system. A longer, more complex work would require more classifications. Sub-classifications define the various functions of each fragment 200 in a FRCA system. Again, the number and nature of sub-classifications will vary according to the complexity of the system and the requirements (or limitations) of the content producer. Classifications and sub-classifications may be represented by any one or more alphanumeric or other characters, so long as these are not duplicated within the system. In the case of the PFD, the following classifications for the fragment 200 names are used:

Set

Fragments 200 which give an overview of the set, location and/or arena of a segment

Generic

Non-specific fragments 200

Optional character no

Fragments 200 which feature a character likely to engender a strong negative reaction from viewers

Optional

Fragments 200 which are not essential to comprehending the segment 204

End of Segment

The last fragment 200 in a segment 204

Transition

Fragments 200 which are not essential to the narrative structure, but which serve as punctuation

To these basic classifications, the following sub classifications are added:

Segment:

The specific segment 204 to which the fragment 200 belongs

Plot:

A fragment 200 within a segment 204 which belongs to a designated plot of the PFD. Segments 204 which can function in more than one plot are given a different letter symbol. For example, in the PFD, Plot A is “Memory Chips”, Plot B is “Love Story”, and Plot C, which combines elements from both Plot A and Plot B, is “After School Daze”.

Classification and in-segment sequence:

The classification symbol of the fragment 200 and its position relative to the other fragments 200 in a segment 204.

Plot type:

The purpose of the segment 204 relative to other segments 204 in the demo. In the PFD, segment 204 functions include plot advancement, character development, and color.

Character name:

The name of a character who may be minimized. In the PFD, viewers are given the option to minimize Todd, who may be perceived by some people to be objectionable. He is assigned the sub-classification name character “t”. Alternatively, a popular character may be maximized.

Rating:

A fragment 200 which may be included or excluded depending on the viewer's tolerance for characteristics such as profanity or violence.

8. A graphical user interface (GUI) is designed for the RDM movie, which presents a series of choices via functions such as radio buttons, check boxes, pull-down menus and/or a combination of these. The initial choice may be the user's preferred level of customization. The simplest level may present a choice of pre-edited linear content works, i.e., the “director's choice”, the studio version, and/or a standard “light” version. The intermediate level may access the RDM movie, and allow for macro choices such as genre, style, rating, and length; while the advanced level may allow for detailed choices such as maximizing or minimizing specific characters, and specifying preferred locations and elements of the work.

9. The user's choices enter a series of instructions into the user's computing system. These may be transferred immediately via broadband connection to the content provider's computing system, or stored for transfer at a later time. When the instructions are entered into the content provider's system, in which the digital fragments 200 are stored, one or more algorithms are triggered which determine the number and nature of the digital fragments 200 to be used, as well as the sequence in which they will be delivered. Depending on the complexity of the algorithms, identical user choices will not necessarily result in identical RDM movies being generated.

The algorithms are mainly a set of “if-then” rules. See FIGS. 6, 30 and 46. The same choices generate a different RDM movie because the algorithm's choices of available fragments 200 are random and the possible number of combinations are large (see below). Even though a basic fragment 200 and its FEs 210 convey the same meaning, the differences between them can be quite substantial i.e., the basic fragment 200 might be a medium (distance) shot, and its FEs 210 might be two variations of close-up shots, while the actors' movements and deliveries of the same lines may vary substantially.

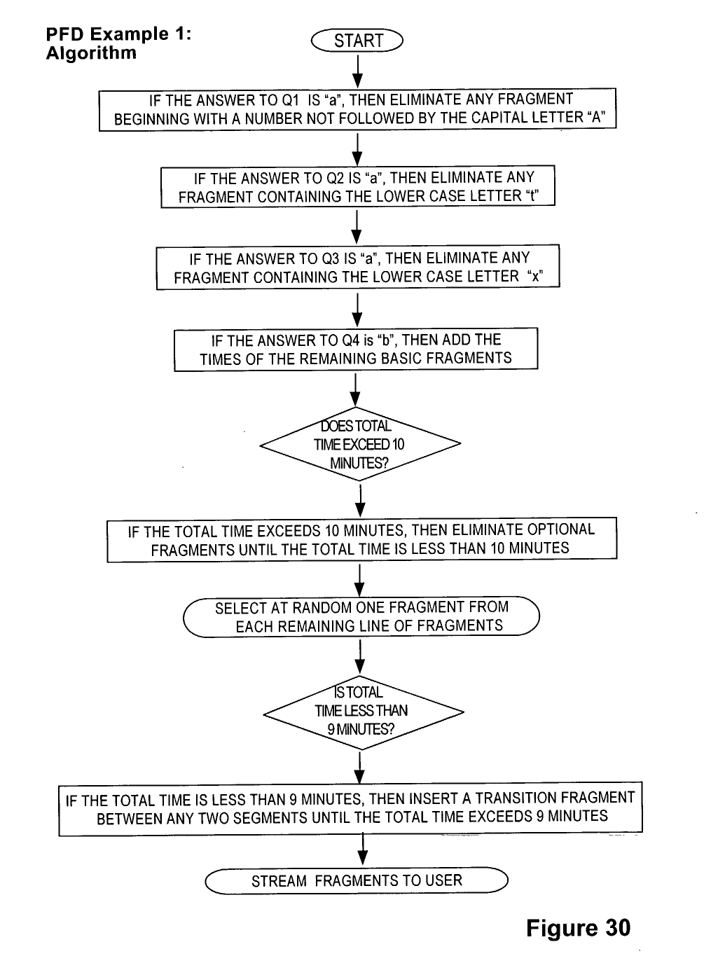

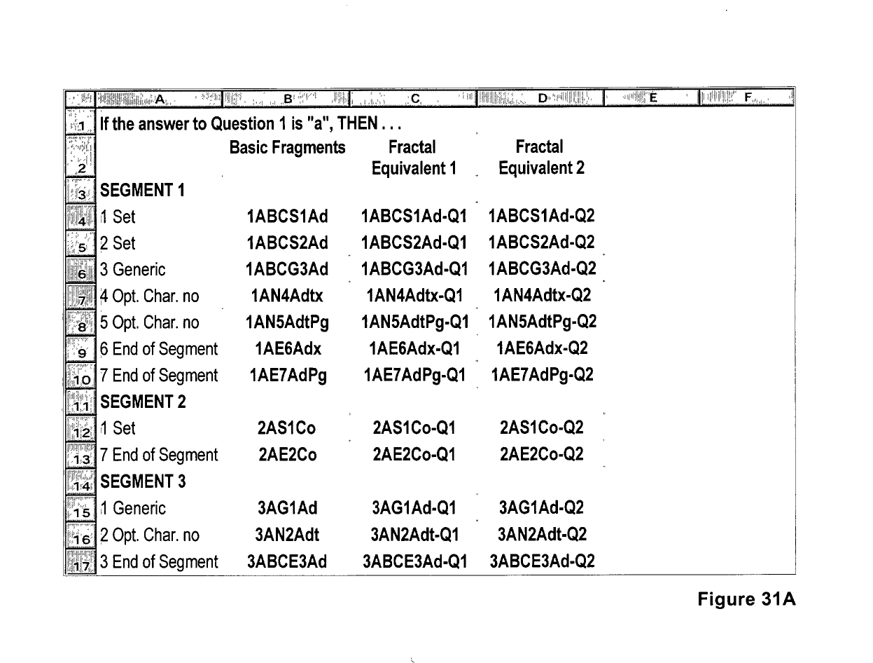

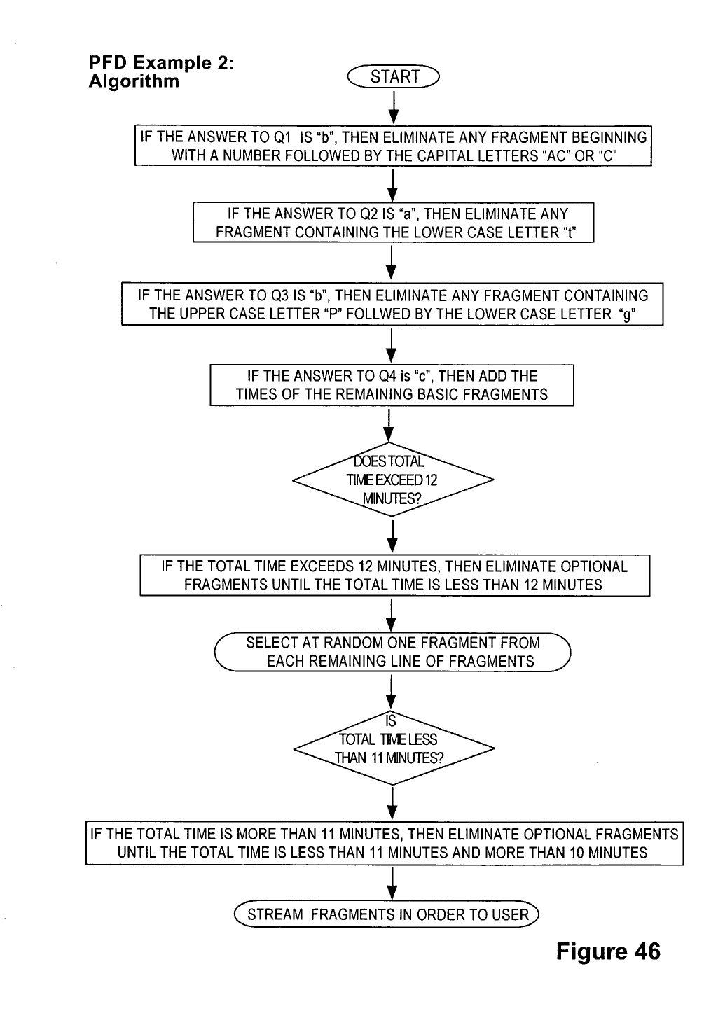

In the example of the PFD, if there were only 50 basic fragments 200 with only one FE 210 apiece, then there would be 50²=2,500 possible variations. If only 10% were substantively different from each other, there would be 250 different movies, as opposed to only one. Conceivably, with RDM, a movie with a 25:1 shooting ratio would be able to create between four and ten FEs 210 for each basic fragment 200 in the movie. A two-hour movie with 250 basic fragments 200, each of which has four FEs 210, would give 250⁵ possible variations of the movie. Even if only 10% of these variations were substantively different from each other, practically speaking the variations would be infinite, since no one person would likely view every variation and remember how each one differed from the rest. And to ensure substantive differences, one or two steps could be added to the algorithms shown in FIGS. 30 and 46.

10. Payment options may be available at different levels, and the user might have the option to purchase a customized download for a fee.

For example, if the content producer wanted to offer three levels of option and three associated payment levels, they might be structured as follows: Payment level 1 (Simplest level; pre-edited linear content works)

The user has three choices:

Option 1: Studio or “commercial” version

Option 2: Director's cut version

Option 3: “Light” version, which is a shorter form of Option 1.

Any one of these might be available for a basic fee, analogous to what it costs to buy a VHS tape or DVD-ROM.

Payment level 2 (Intermediate level; RDM macro choices such as genre, style, rating and length).

This level might be available for the fee above, plus a premium for the customization service.

Payment level 3 (Advanced level; RDM detailed choices such as maximizing or minimizing specific characters, and specifying preferred locations and elements.)

This level might be available for the fee plus a premium for advanced customization service.

The payment system in a preferred embodiment would be to charge a flat fee for an unlimited number of downloads with advertising, with a higher flat fee for ad-free downloads. The unit costs are low or nil, and there are opportunities for targeted advertising, customer relationship development, and marketing associated products.

The Development of the PFD Screenplay:

In the PFD screenplay, a single, short screenplay was generated based on one of the events, titled “Memory chips”, which was parsed from the work of content which is the basis for an RDM feature movie. The screenplay included six characters (four boys and two adults) and, because it was based on a single event, it had a single plot which would appeal to a single audience (e.g., Generation Y boys). In order to broaden the appeal to, say, Generation Y girls, a romantic plot was developed and two girls were introduced to the character mix. This resulted in fairly minor additions to the script, identifiable in the Fragment Classification Forms as Plot B. A little minor tweaking, identifiable in the Forms as Plot C, allowed the full integration of the two plots and thus offered a third choice to users.

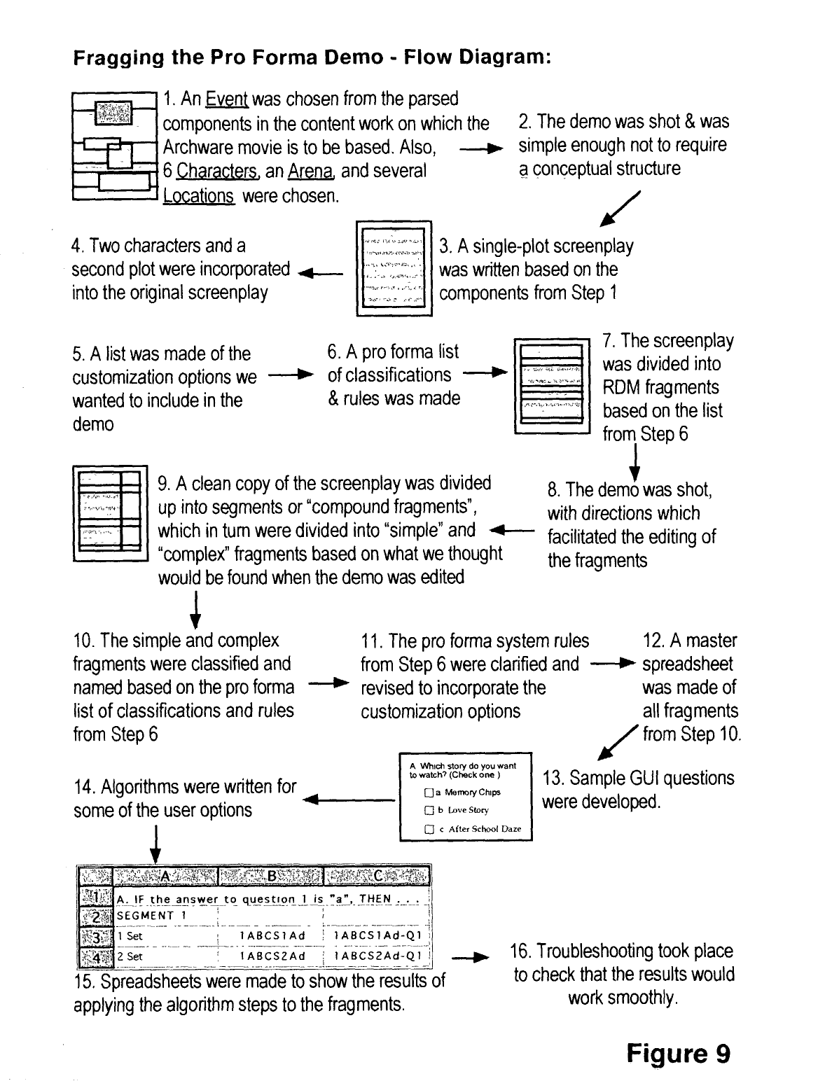

FIG. 9 is a flow diagram showing the steps used to fragment the PFD, which is based on a demonstration video. The following steps were performed to fragment the PFD:

1. Parsed components were chosen from the work of content on which a feature movie is to be based. These included 6 Characters, a Plot Advancement Event (“Memory Chips”), an Arena and several Locations;

2. The PFD is short and simple enough that a conceptual structure was not necessary;

3. A single-plot screenplay was written based on the components from Step 1;

4. Two characters and a second plot were incorporated into the original screenplay;

5. A list was made of the customization options we wanted to include in the PFD;

6. A pro forma list of classifications and rules was made;

7. The screenplay was divided into RDM fragments 200 based on the list made in Step 6;

8. The demonstration video was shot, incorporating directions which facilitated the editing of the fragments 200;

9. A clean copy of the screenplay was divided into “simple” fragments 201 and “complex” fragments 203 based on what will likely be found when the demonstration video is edited;

10. The fragments 200 were classified and named based on the pro forma list of classifications and rules from Step 6;

11. The pro forma system rules from Step 6 were clarified and revised to incorporate the customization options;

12. A master spreadsheet was made of all the fragments from Step 10;

13. Sample GUI questions were developed;

14. Algorithms were written for the various user options;

15. Spreadsheets were done to show the results of applying algorithm steps to fragments 200; and

16. Troubleshooting took place to ensure that the results would work smoothly.

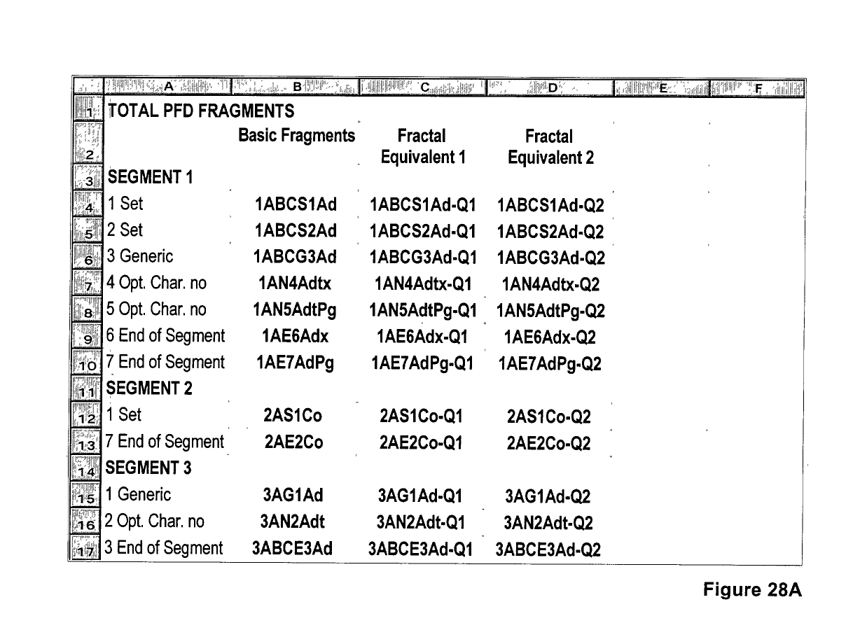

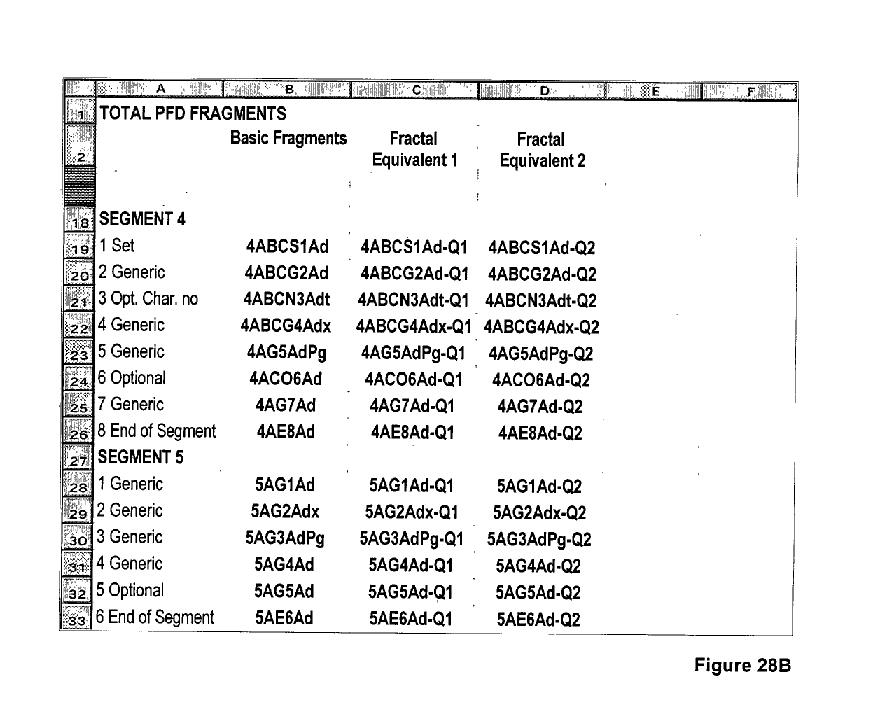

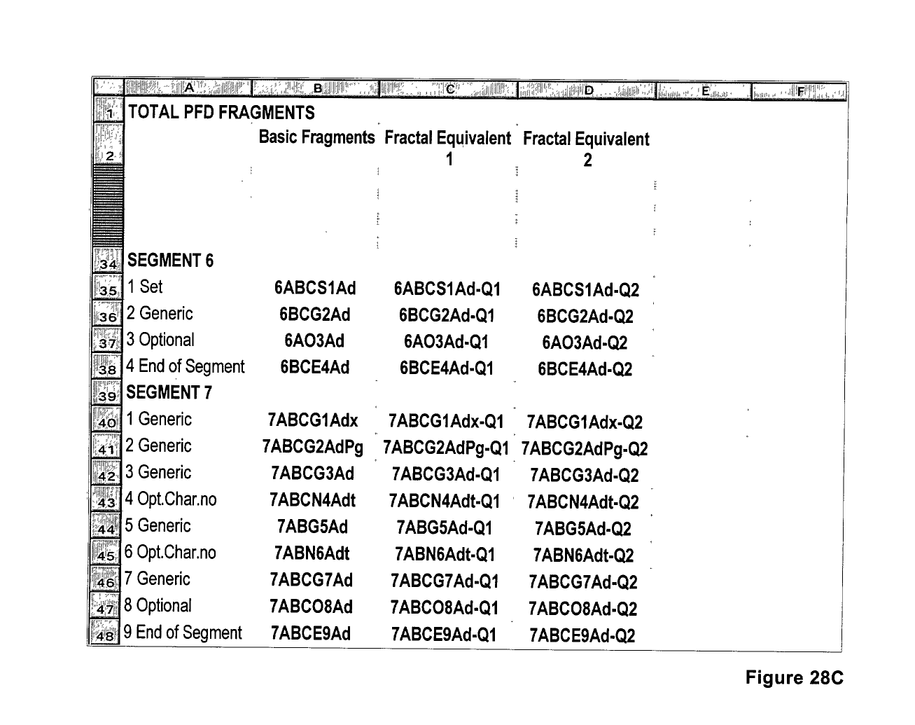

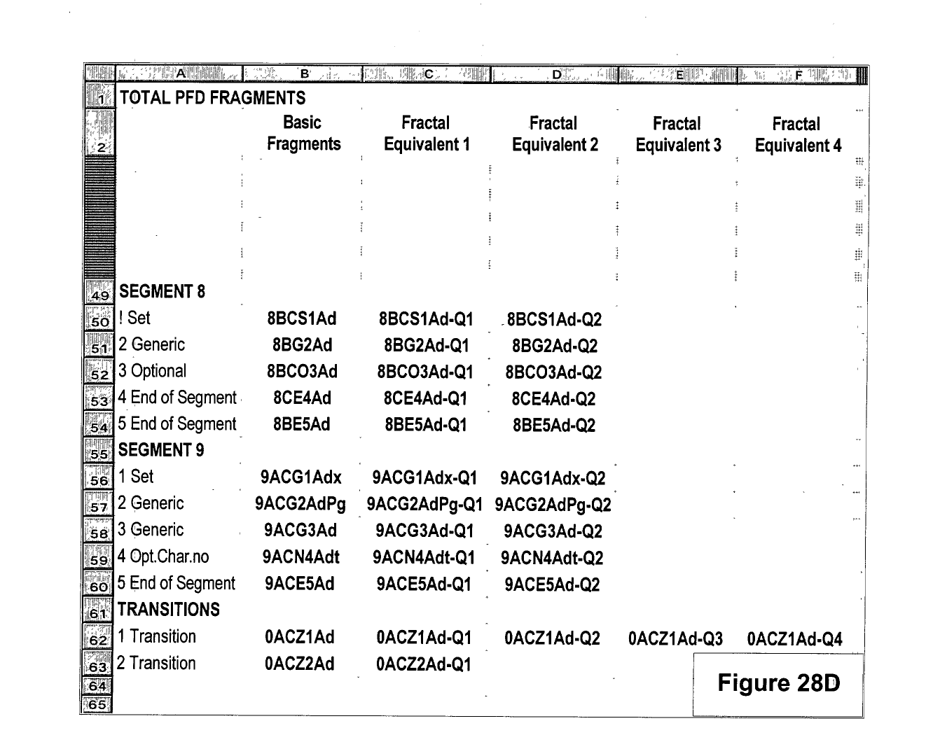

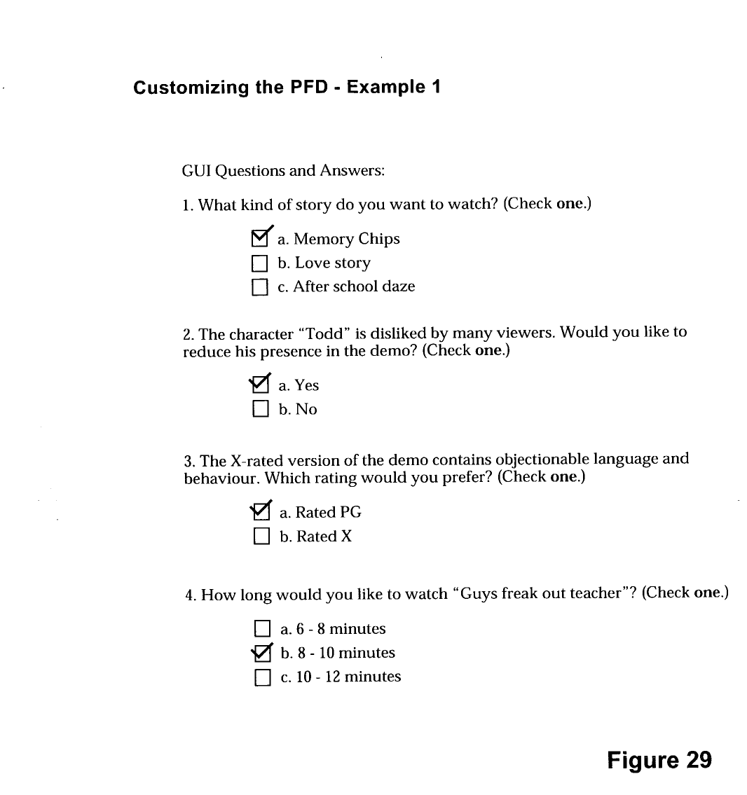

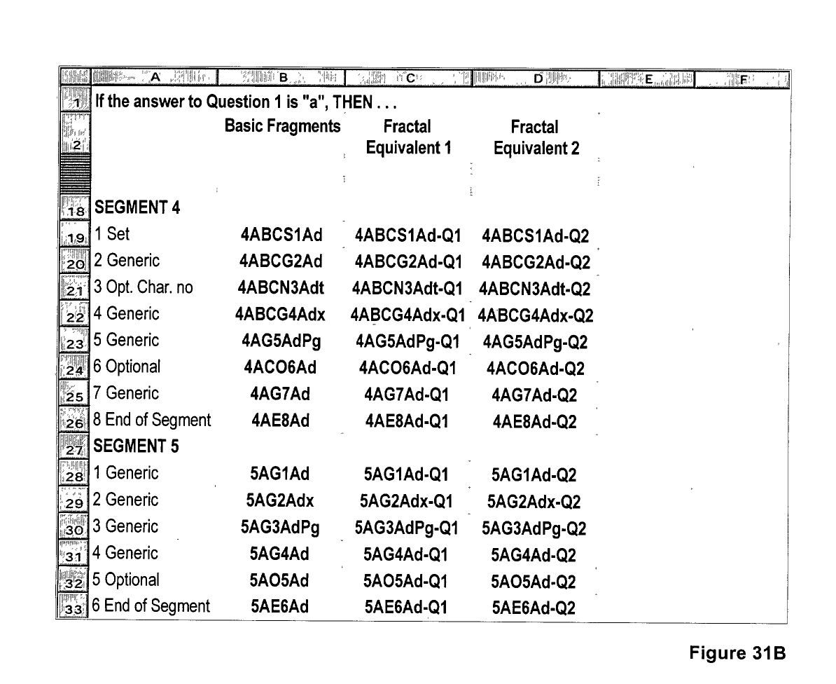

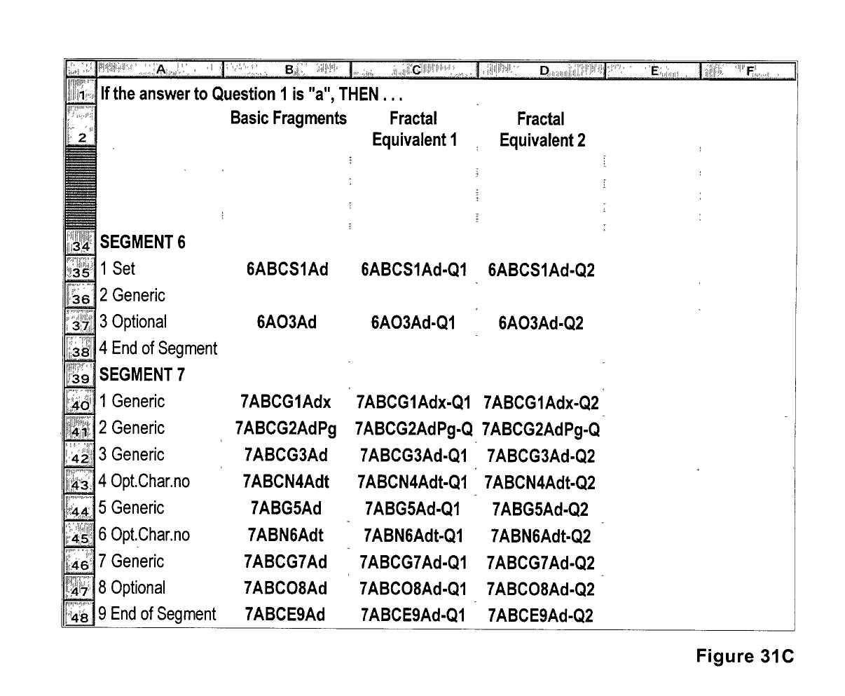

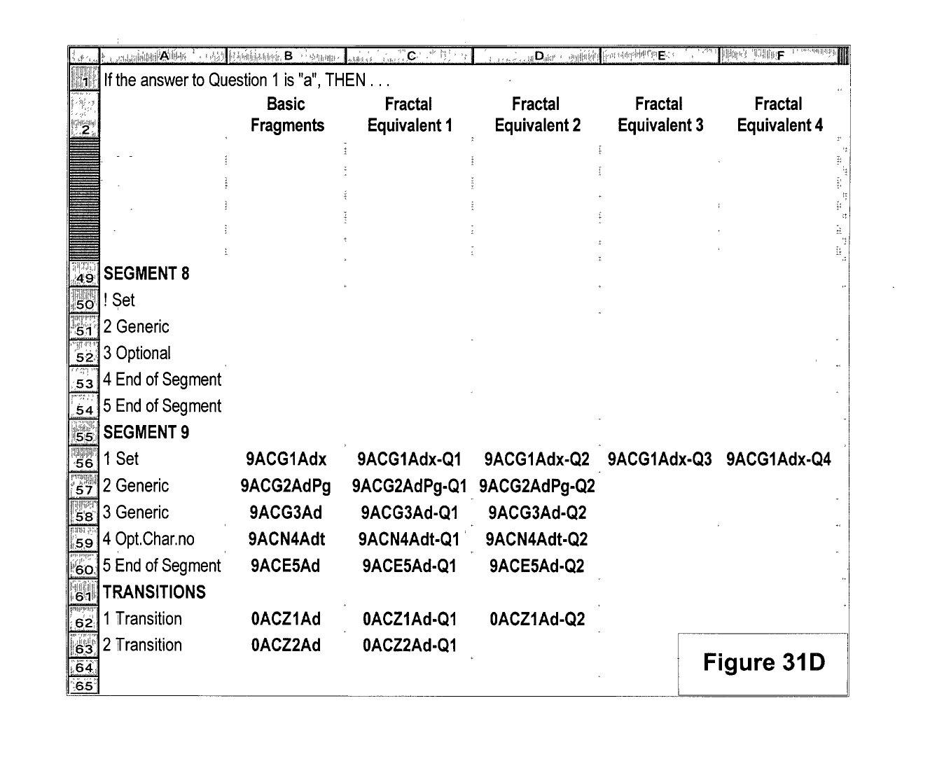

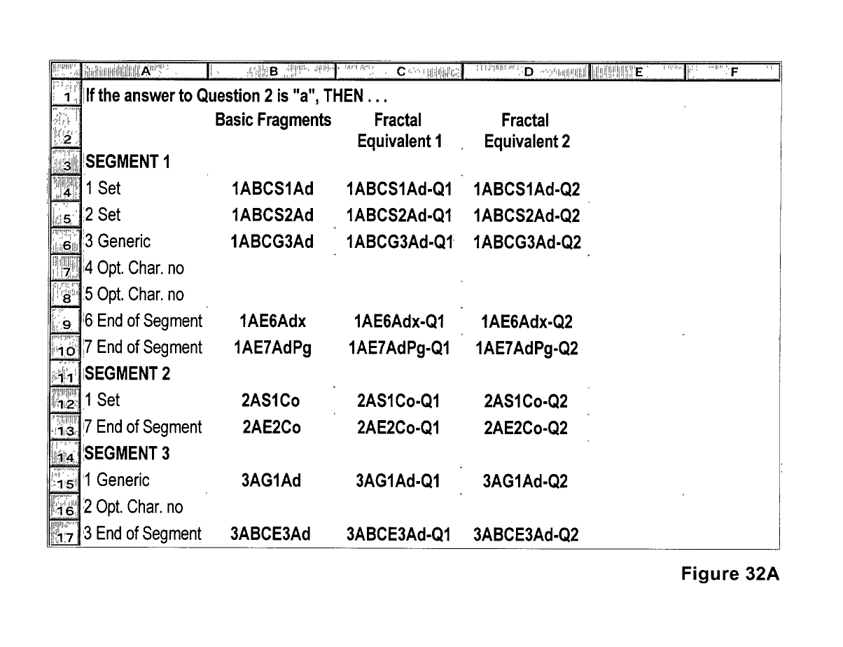

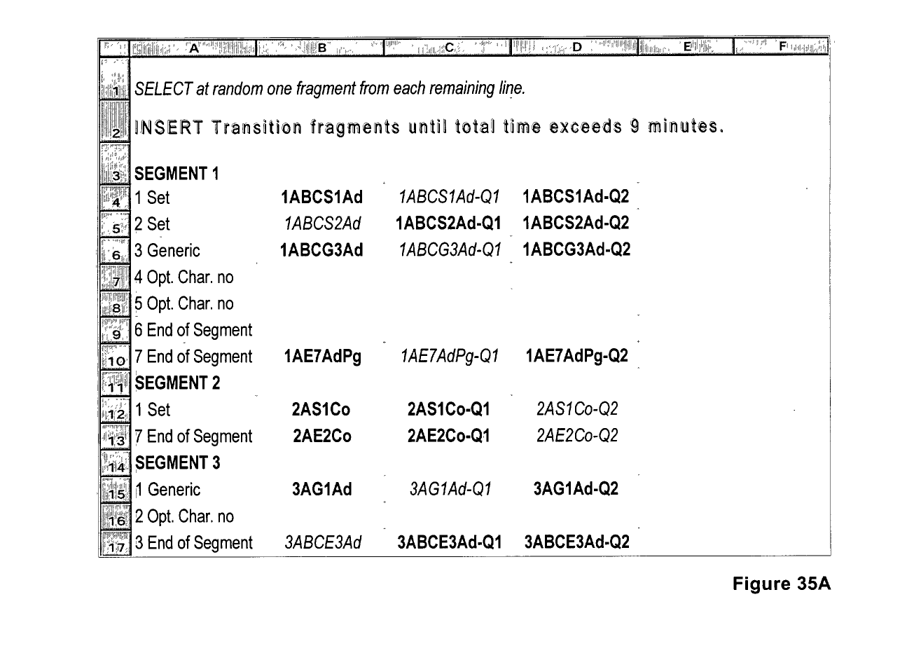

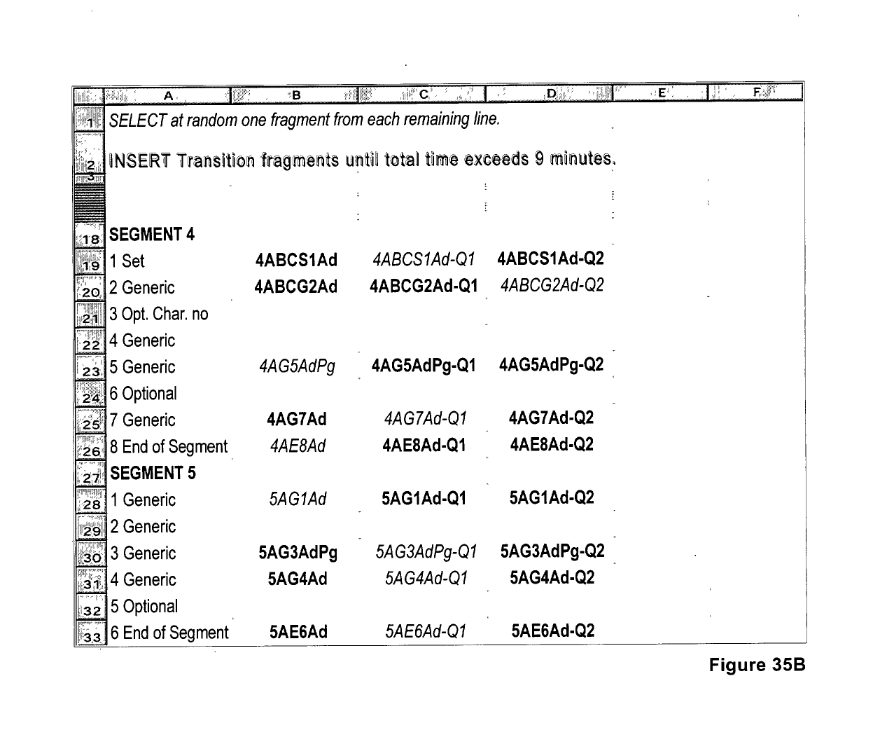

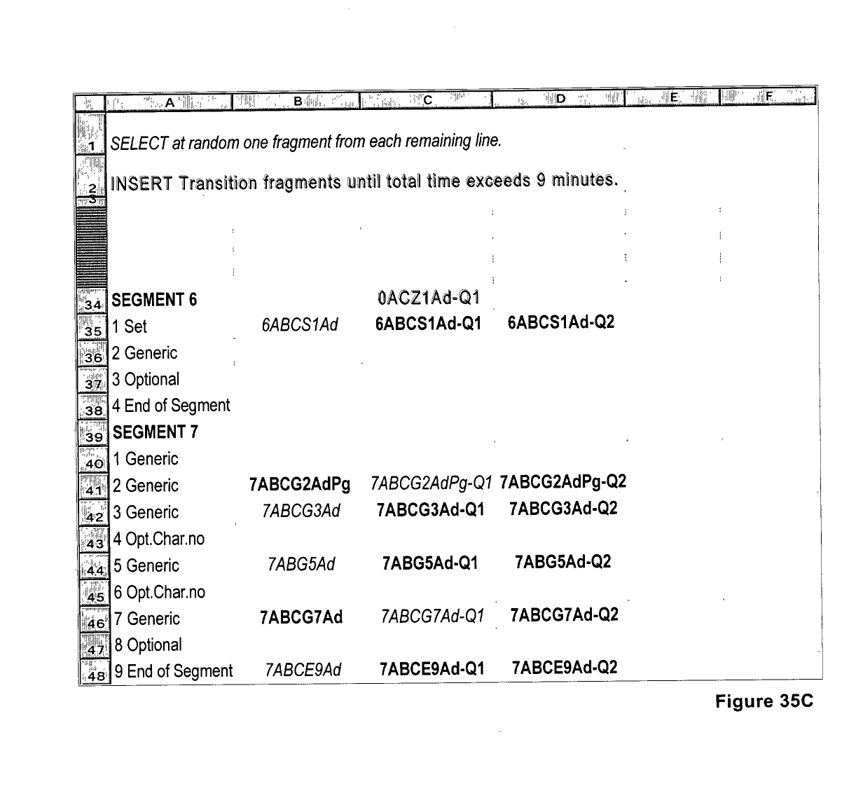

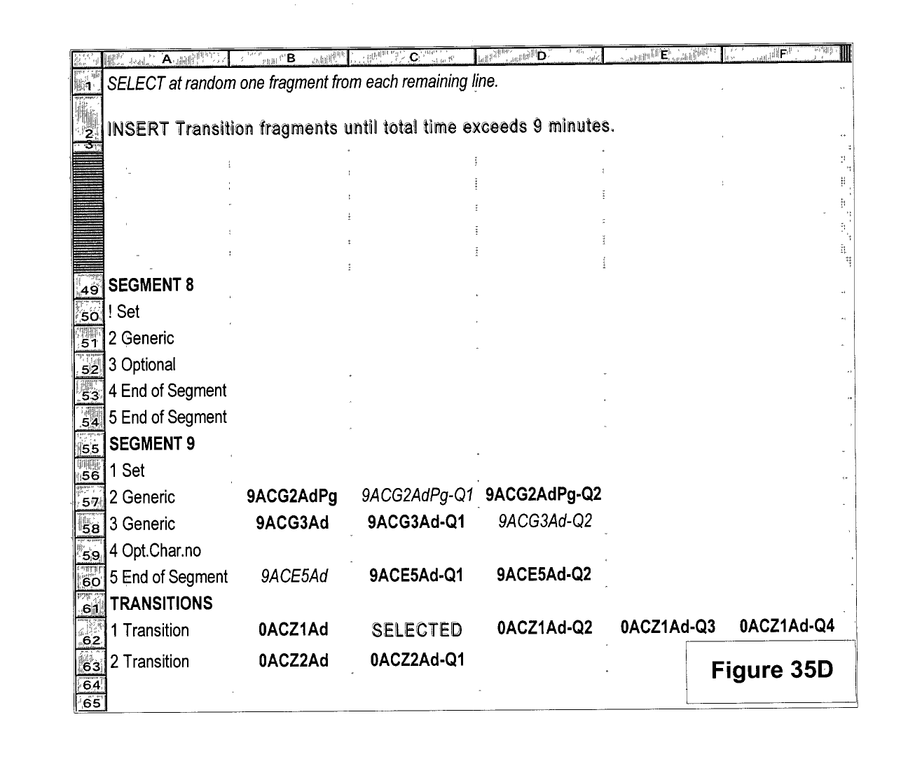

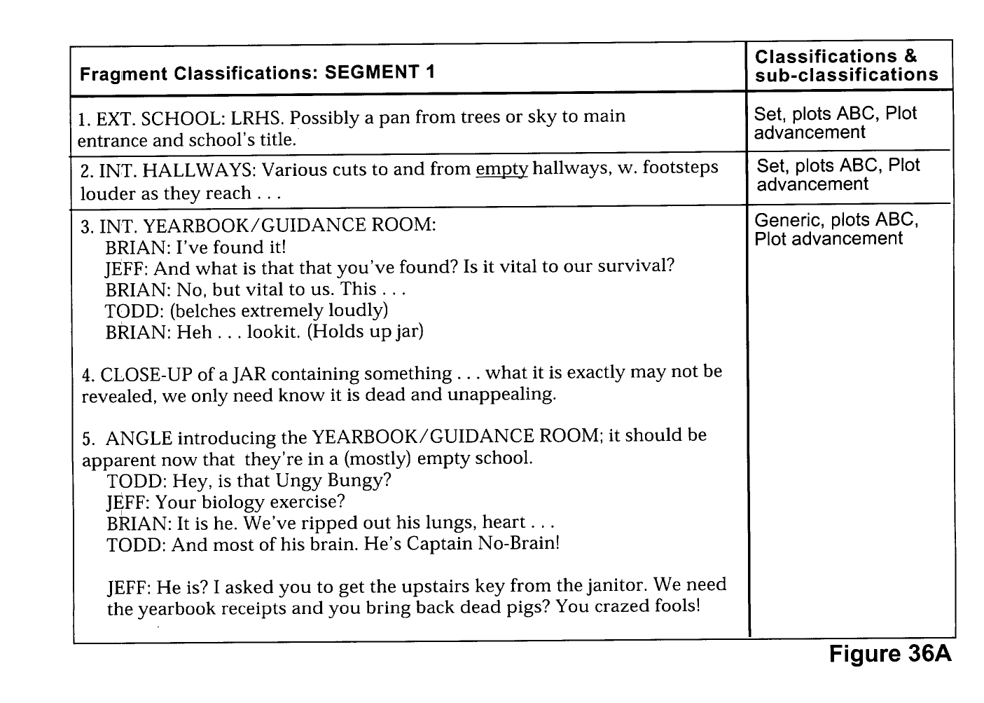

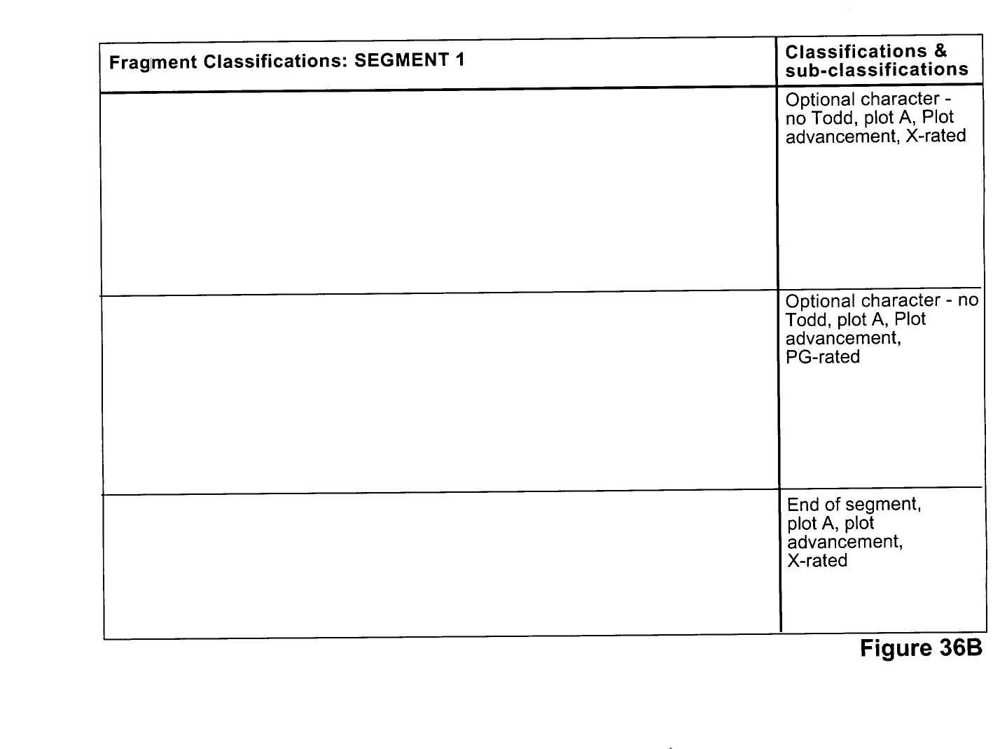

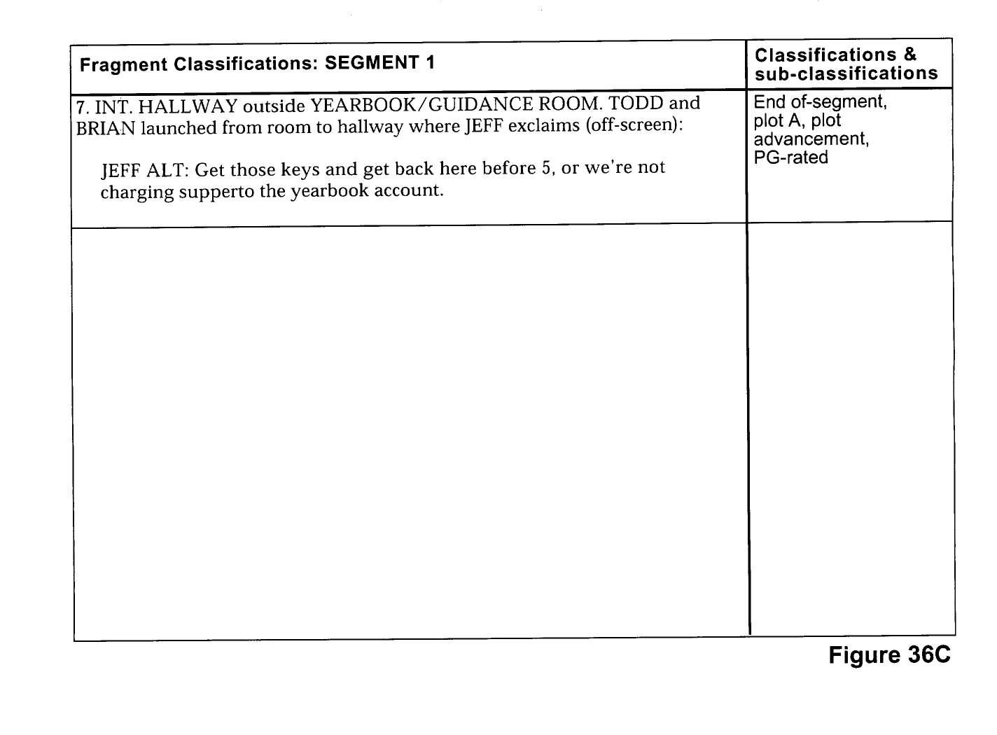

Step 10 is reflected in FIGS. 10A to 27B which show the classifications and names of the fragments 200 in each segment created in step 9. FIGS. 28A to 28D are the master spreadsheet of step 12. FIGS. 29 to 44C reflect a first example of an RDM movie iteration which can be customized from the PFD. FIG. 29 is a listing of four questions which could be found on an RDM GUI. In this example, a user selected option “a” for questions 1, 2 and 3, and option “b” for question 4. FIG. 30 is a flow diagram showing the algorithm created in step 14 for these selections. FIGS. 31A to 34D are spreadsheets showing the total PFD fragments which are created by the algorithm and these selections. FIGS. 35A to 35D show the genome of Example 1 for the PFD. FIGS. 36A to 44C are charts of each segment of the PFD containing the actual text which is created in Example 1.

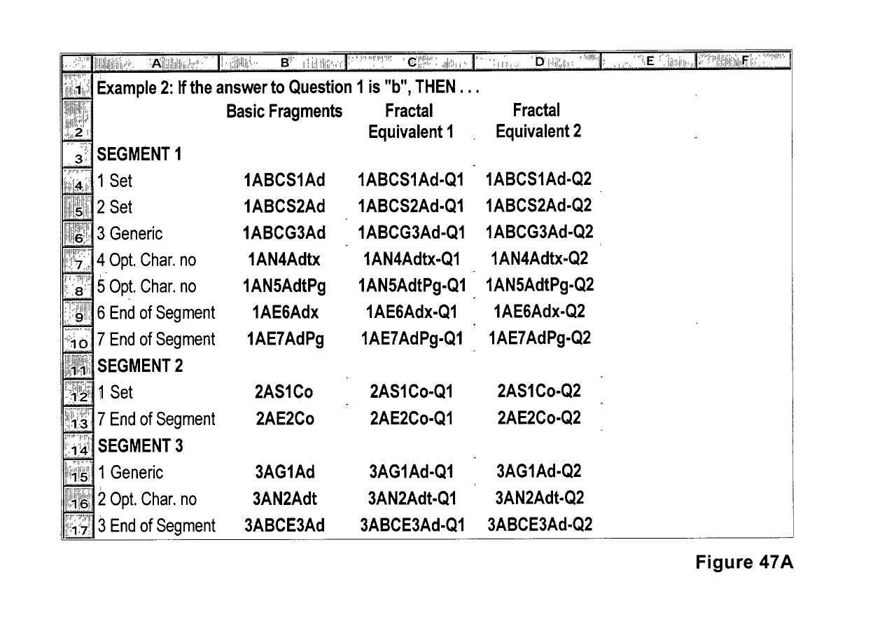

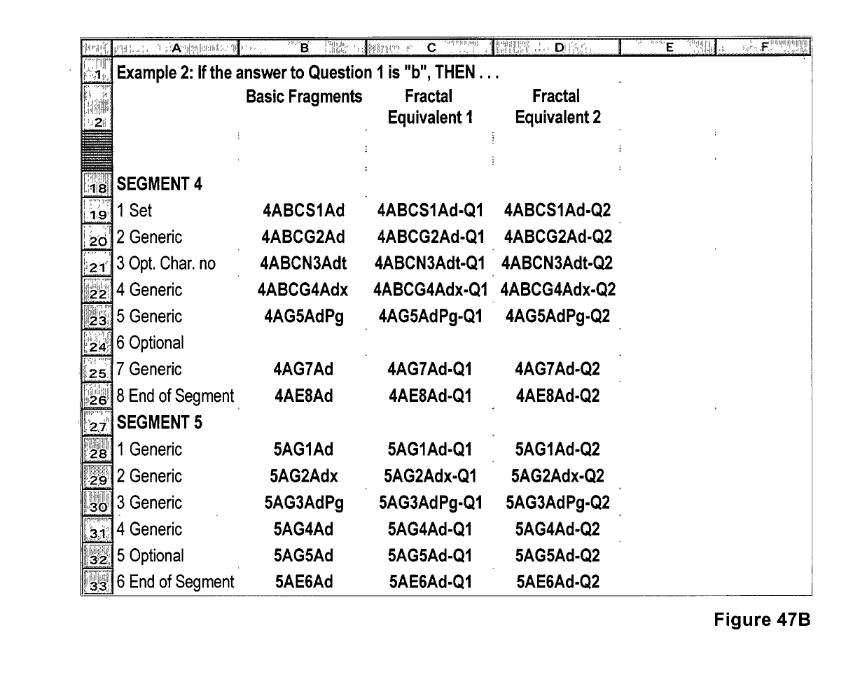

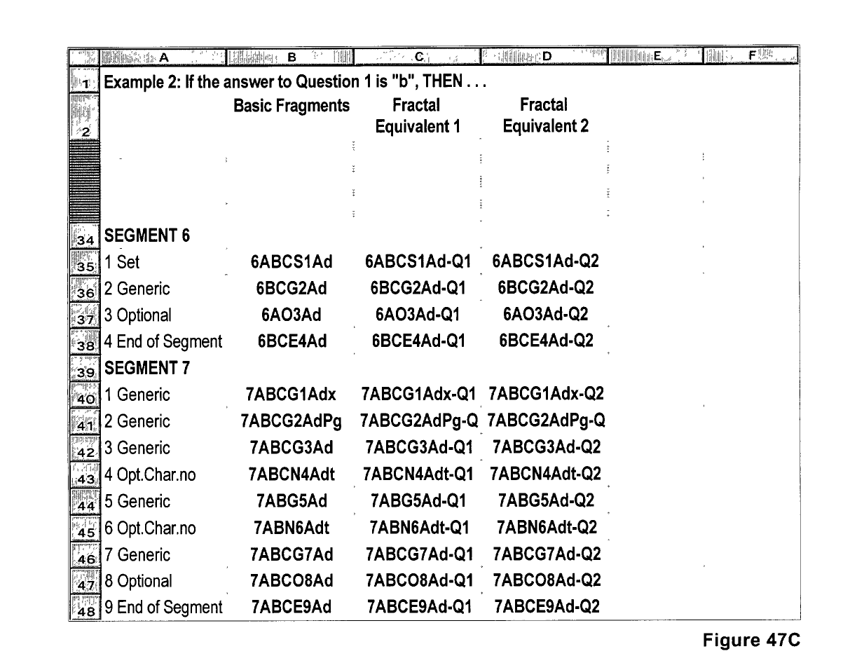

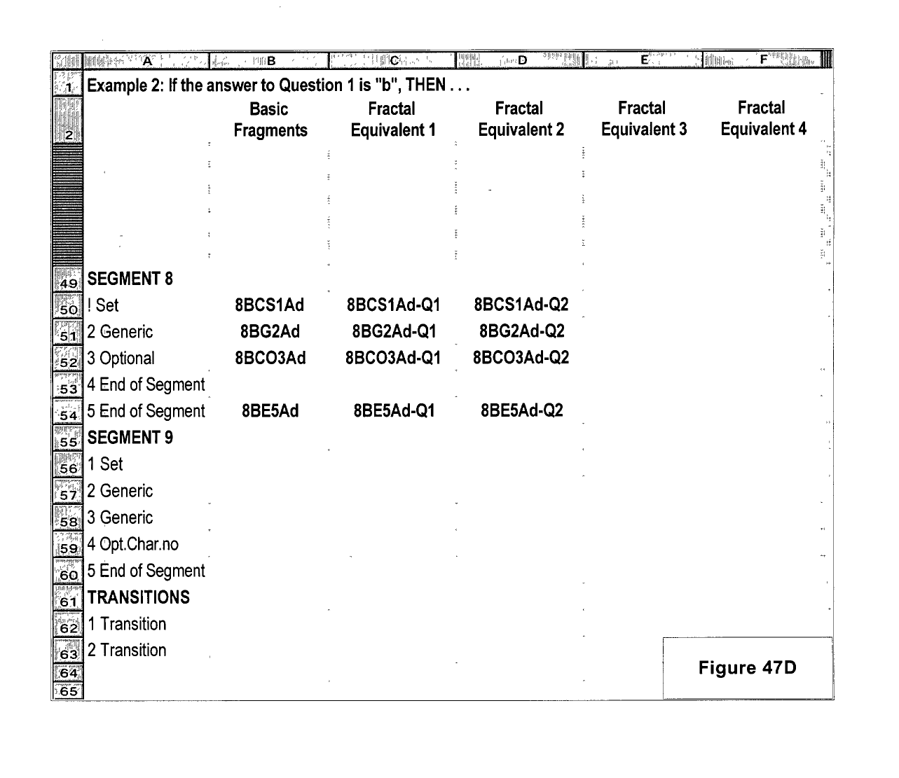

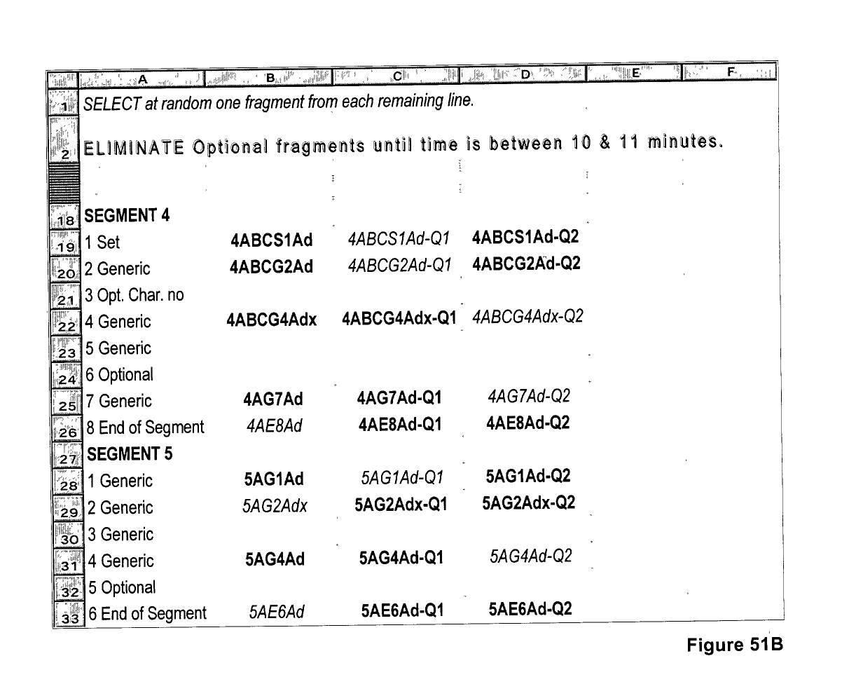

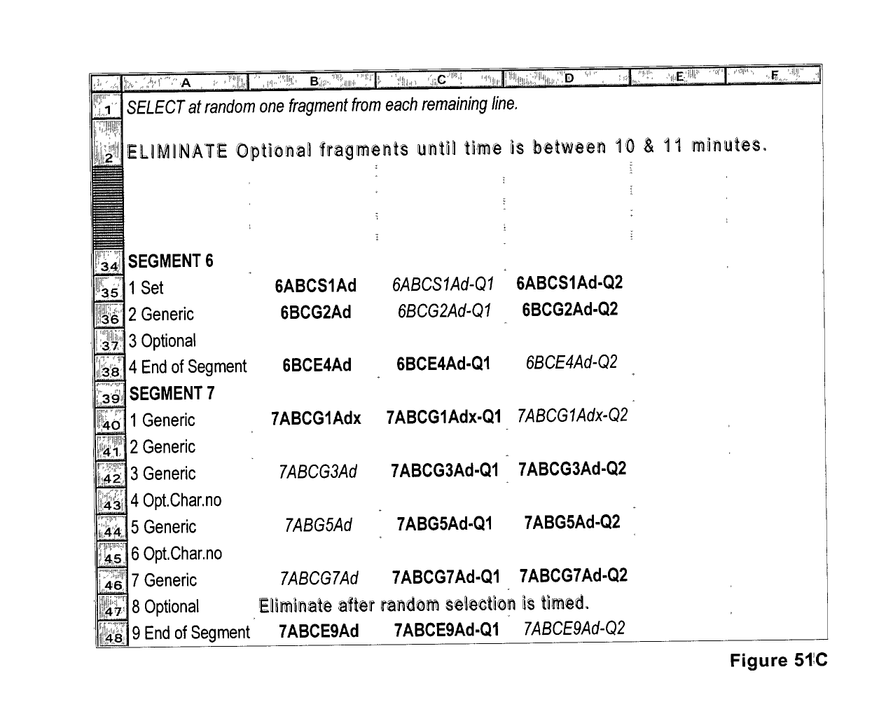

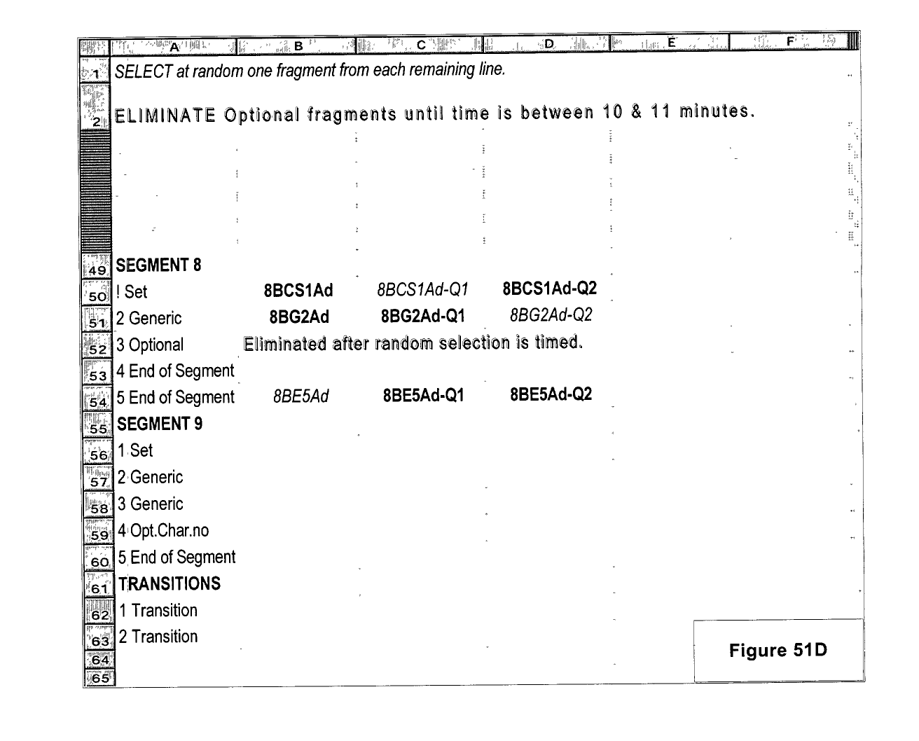

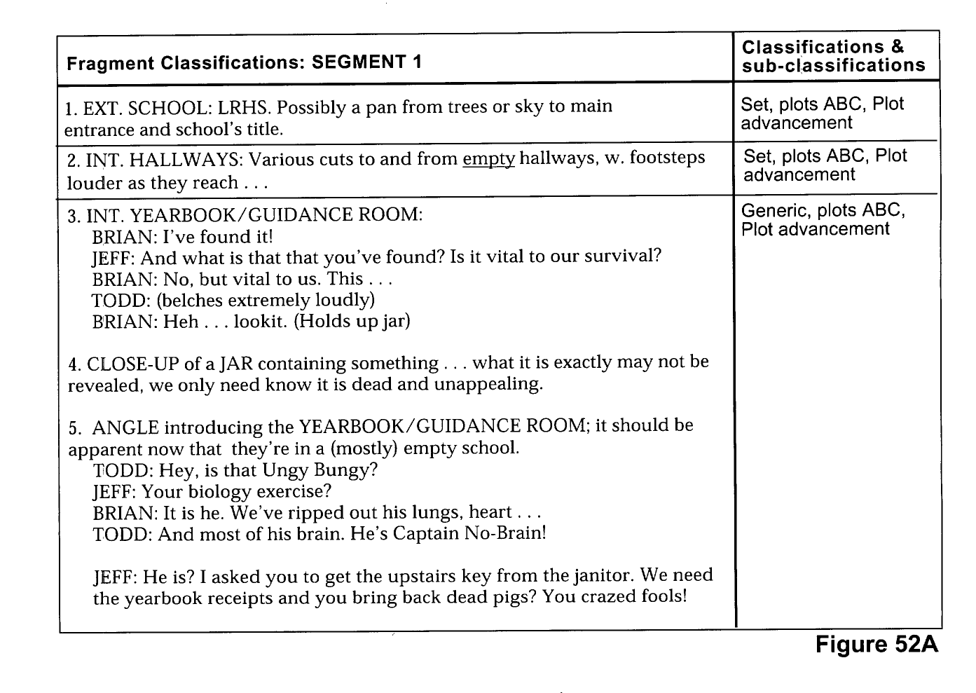

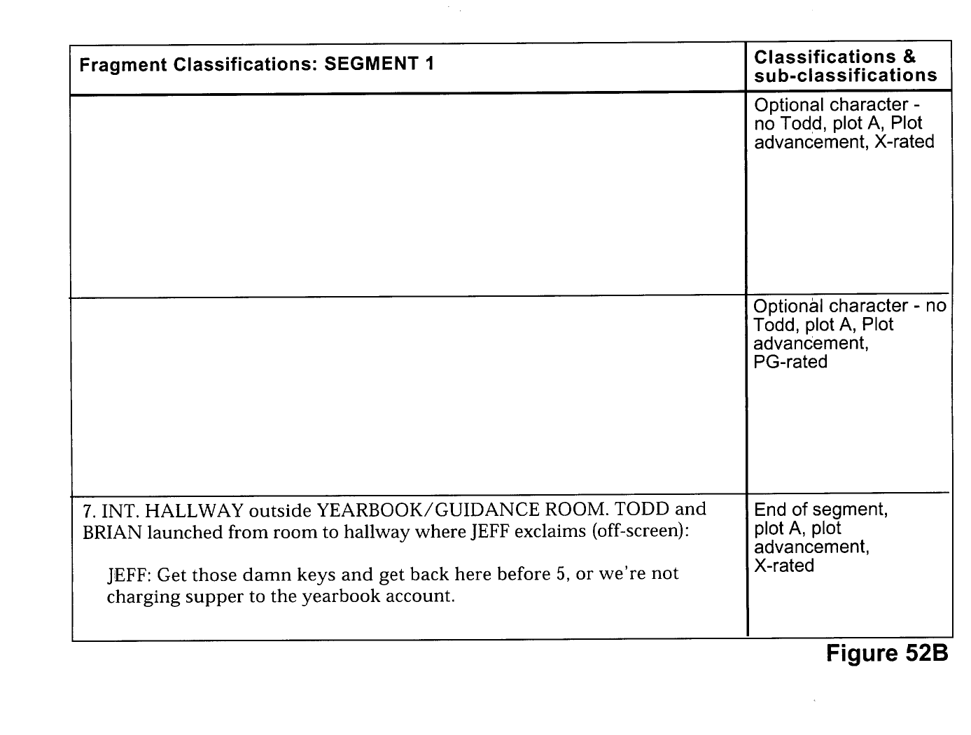

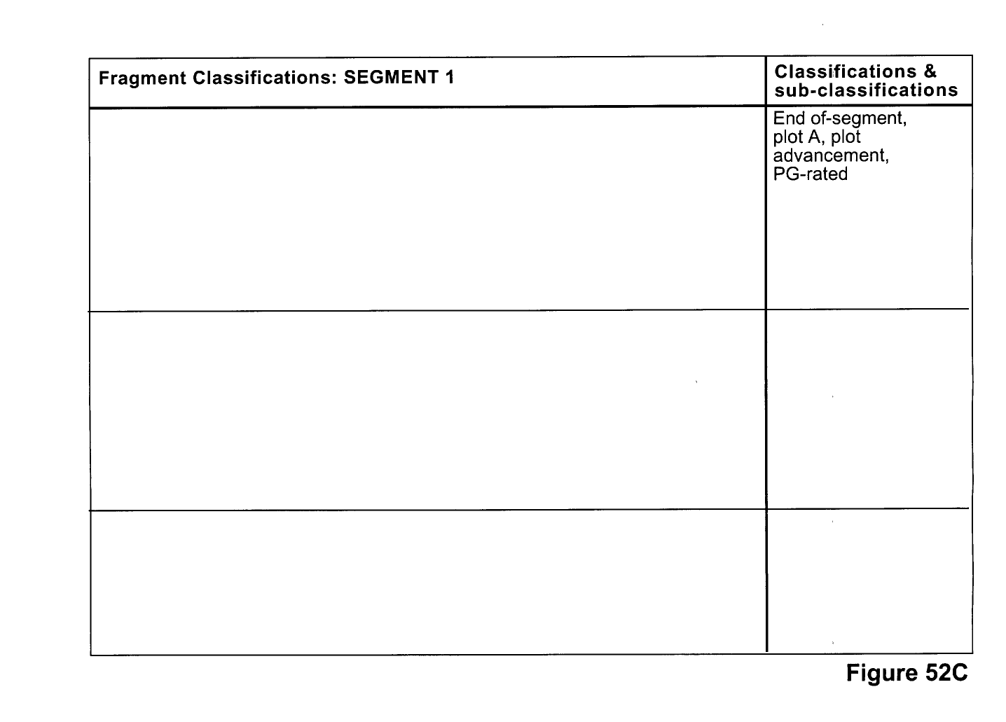

FIGS. 45 to 60C reflect a second example of an RDM movie iteration which can be customized from the PFD. FIG. 45 is a listing of four questions which could be found on an RDM GUI. In this example, a user selected option “a” for question 2, option “b” for questions 1 and 3, and option “c” for question 4. FIG. 46 is a flow diagram showing the algorithm created in step 14 for these selections. FIGS. 47A to 50D are spreadsheets showing the total PFD fragments 200 which are created by the algorithm and these selections. FIGS. 51A to 51D show the genome of Example 2 for the PFD. FIGS. 52A to 60C are charts of each segment 204 of the PFD containing the actual text which is created in Example 2.

Benefits of the Invention:

This invention has numerous benefits over known works of content regardless of the format in which these are presented. In particular, it allows individual users to customize works of content in such a way as to preserve a coherent narrative structure while more closely meeting their needs and desires than does the original work.

In addition to the above attribute, RDM content diminishes the level of risk to which content producers are exposed. The invention greatly broadens the appeal of a work for producers by allowing them to broaden the potential audience for the work.

RDM also reduces the risk of piracy. It is very difficult to pirate a content work which changes at the whim of each user and which may, for practical purposes, exist in an infinite number of iterations.

RDM greatly increases the level of productivity for content producers. It distributes the cost of production more evenly across the course of production (i.e., pre-production, production and post-production). It also allows all developed content which meets qualitative parameters set by the producer and/or director to be available for inclusion in any iteration of the work. The increase in productivity with RDM is attributed to a number of things, as noted below:

i) Much more of the material created can actually be used. Even with shooting digital video (which is much cheaper than film), every “foot” of film shot represents a large outlay in production costs, everything from the salaries of actors and crew, to travel and location expenses. Although it is not likely that a movie with a 25:1 shooting ratio would be able to use all of it to create an RDM work, just doubling the usable footage would increase the return on investment (ROI) exponentially.

ii) A lot of content can be “seeded” with digital fragments 200 that can form the basis for subsequent programs different from the originals. This means that a company has to have a strategic overview of where it wants to go with content production, but the ROI compounds over time, when program production costs drop because an increasing percentage of each new program is made from “recombined” fragments 200.

iii) As noted, many iterations are possible, greatly expanding the potential audience for any given production.

iv) With RDM content, the pre- and post-production phases are longer than they are for conventional content, but since theses phases are much less expensive relative to the production phase, the additional cost is not as significant in terms of an overall budget. In addition, each dollar spent in the pre-production phase of RDM potentially leads to a reduction in the downstream cost of subsequent productions, partly because RDM planning encourages a more strategic, systems-based approach to creating content.

NOTE: RDM can also be used to salvage a substantial amount of legacy content. This is especially true of non-fiction content and content that is produced in series, such as movies with sequels, and series television (i.e., soap operas, and any other dramatic series in which narrative threads continue from one show to the next). It would apply as well to printed content in digitalized form, such as a book trilogy or a series of articles. This capacity is an asset to traditional content owners.

Alternative Uses/Components to the Invention:

RDM is a cross-platform technology. So long as an individual content consumer has a way to communicate choices to a content provider, and a content provider has a way to deliver the consumer's choices to the consumer, it does not matter what technical routes the communication and delivery must follow.

A user's computing system also does not necessarily have to have an optical device. If the content provider frags and classifies for a purely audio version of a visual content work, a person could download that version and communication could take place via radio broadcast, CD playback, a Braille keyboard and/or voice recognition software or any other audio delivery. RDM may also be fragged for wireless and hand-held devices simply by classifying fragments 200 (such as close-up shots for visual content, which have less detail) as suitable for small-screen viewing.

RDM is a cross-cultural and cross-linguistic technology. A content producer may create RDM content in any language for any cultural and/or linguistic group. For example, A movie or television program in any language could be fragged and classified with subtitles and/or audio voice-overs in any other language.

RDM may also include advertisements. For example, in the PFD, transition fragments 200 were included. These are related to content, but could have alternatively been advertising fragments 200 and classified as such. Furthermore, advertisements could be composed of a series of RDM segments which make up an ongoing mini-story which continues throughout the main work of content. The behaviour of these segments 204 may be directed by the primary program algorithm activated by the GUI, and/or by a secondary algorithm launched from within the primary one.

The following illustrate alternative uses/components to RDM:

1. RDM's optimum use will be as content downloaded over the Internet in response to requests from individual users.

2. A user can customize content to exclude objectionable material (i.e., violence, profanity, pornography, etc.).

3. A user with particular time constraints can define a preferred length of a work within a given minimum and maximum. The maximum length may in practical terms be infinite.

4. A user who is familiar with a content work can customize it for any of a number of choices provided by the producer of the work. These choices could reflect the user's mood, personal tastes, current interests, physical disabilities, etc.

5. A content provider can customize a content work to suit a specified target audience.

6. A movie theatre owner could present a content work to an audience in “never-ending” form, so that the work would not, in practical terms, be repeated in an iteration identical to any other iteration. In this case, the theatre would operate like a parking lot, with viewers punching a ticket on entrance to the theatre, and paying on exit according to the amount of time spent in the theatre.

7. Content works can be presented by a variety of “hosts” or narrators targeted to specific audiences.

8. Students can personally choose a “teacher-host” to present educational programs.

9. Patients can personally choose a “therapist-host”, “doctor-host” or “nurse-host” to present therapy or health programs.

10. In the case of RDM electronic books, choices about which narrative threads to follow, and whether or not to include hyperlinks and/or which hyperlinks to include, so that the book could be accessed in a nonlinear way, would be made by the reader before starting the book.

11. Organization and reconfiguration of content which does not require coherent narrative structures or retention of narrative integrity of an original work, including certain types of databases and interactive content.

The system and method for recombinant media content in the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While specific embodiments of the present invention have been described, various modifications and substitutions may be made to such embodiments. Such modifications and substitutions are within the scope of the present invention, and are intended to be covered by the following claims.

What is claimed is:

1. A system for producing a customized version of a work, the system comprising:
a collection of fragments of a version of the work;
an output unit which outputs the customized version of the work based on user preferences.

2. The system claimed in claim 1, wherein the collection comprises one or more versions of one or more works.

3. The system claimed in claim 1, wherein the collection includes at least one fractal equivalent for at least one of the fragments.

4. The system claimed in claim 1, wherein the collection is stored in a database.

5. The system claimed in claim 1, wherein the fragments are categorized into classifications.

6. The system claimed in claim 5, wherein the classifications comprise at least one of plots, characters, subjects, references, themes, and descriptions.

7. The system claimed in claim 1, further comprising system rules defining boundaries for possible combinations of the fragments.

8. The system claimed in claim 1, wherein each customized version has a coherent narrative structure.

9. The system claimed in claim 1, further comprising a billing unit for charging a customer for the customized version.

10. A system for producing recombinant media content, the system comprising:
a collection of fragments of a work;
classifications of said fragments;
system rules defining boundaries for possible combinations of said fragments; and
an output unit which outputs customized versions of said work based on user preferences.

11. The system claimed in claim 10, wherein the collection includes at least one fractal equivalent for at least one of the fragments.

12. The system claimed in claim 10, wherein the classifications comprise at least one of plots, characters, subjects, references, themes, and descriptions.

13. A system for producing recombinant media content having a coherent narrative structure, the system comprising:
a collection of fragments of one or more works, the collection including at least one fractal equivalent for at least one of the fragments, the collection stored in a database, the collection comprising one or more versions of the one or more works;
classifications of said fragments comprising at least one of plots, character, subjects, references, themes, and descriptions;
system rules defining boundaries for possible combinations of said fragments;
an output unit which outputs customized versions of said work based on user preferences; and
a billing unit for charging a customer for the customized version.

14. A method for producing recombinant media content, the method comprising steps of:
parsing a work into fragments;
assigning classifications to said fragments;
determining system rules based on the complexity of said work and the number and nature of said classifications;
providing a user options to customize said work; and
organizing said fragments into a customized version of said work based on preferences of said user.

15. The method claimed in claim 14, wherein the step of parsing comprises steps of:
parsing the work into component parts; and
dividing the components parts into fragments.

16. The method claimed in claim 14, further comprising the step of providing the customized version to an end user.

17. The method claimed in claim 16, further comprising the step of billing the user for the customized version.

18. The method claimed in claim 14, further comprising the step of providing the recombinant content to an end user.

19. The method claimed in claim 18, further comprising the step of billing the user for the recombinant media content.

20. A computer data signal embodied in a carrier wave and representing sequences of instructions which, when executed by a processor, cause the processor to perform a method for producing recombinant digital media content, the method comprising steps of:
parsing a work into fragments;
assigning classifications to said fragments;
determining system rules based on the complexity of said work and the number and nature of said classifications;
providing a user options to customize said work; and
organizing said fragments into a customized version of said work based on preferences of said user.

21. Computer-readable media for storing instructions or statements for use in the execution in a computer of a method for producing recombinant digital media content, the method comprising steps of:
parsing a work into fragments;
assigning classifications to said fragments;
determining system rules based on the complexity of said work and the number and nature of said classifications;
providing a user options to customize said work; and
organizing said fragments into a customized version of said work based on preferences of said user.

22. A computer program product for use in the execution in a computer for a system for producing recombinant digital media content, the system comprising:
a collection of fragments of a work;
classifications of said fragments;
system rules defining boundaries for possible combinations of said fragments; and
an output unit which outputs customized versions of said work based on user preferences.
